(19) United States
(12) Patent Application Publication
(10) Pub. No.: US 2023/0273015 A1
(43) Pub. Date: Aug. 31, 2023

(54) THREE-DIMENSIONAL MEASUREMENT DEVICE, LIGHT SOURCE DEVICE, AND LIGHT RECEIVING AND EMITTING MODULE

(71) Applicant: HAMAMATSU PHOTONICS K.K., Hamamatsu-shi (JP)

(72) Inventors: Kazuyoshi HIROSE, Hamamatsu-shi (JP); Hiroki KAMEI, Hamamatsu-shi (JP); Takahiro SUGIYAMA, Hamamatsu-shi (JP); Akiyoshi WATANABE, Hamamatsu-shi (JP); Seiichiro MIZUNO, Hamamatsu-shi (JP)

(73) Assignee: HAMAMATSU PHOTONICS K.K., Hamamatsu-shi (JP)

(21) Appl. No.: 18/195,508

(22) Filed: May 10, 2023

Related U.S. Application Data
(63) Continuation-in-part of application No. 17/175,059, filed on Feb. 12, 2021.

(30) Foreign Application Priority Data
Feb. 21, 2020 (JP) 2020-028446
Aug. 26, 2020 (JP) 2020-142715
Nov. 30, 2020 (JP) 2020-198371
Sep. 5, 2022 (JP) 2022-140642

(51) Int. Cl. G01B 11/25

(52) U.S. Cl. CPC G01B 11/2513

(57) ABSTRACT

A three-dimensional measurement device includes a plurality of light source units configured to irradiate the object to be measured with measurement light having predetermined patterns, an image capture unit configured to capture an image of the object to be measured which is irradiated with the measurement light, and a measurement unit configured to measure a three-dimensional shape of the object to be measured based on results of image capture performed by the image capture unit. The predetermined patterns of the measurement light include stripe patterns, respectively. The stripe patterns radiated from the plurality of light source units have respective patterns different from each other. The plurality of light source units are arrayed in a direction parallel to stripes in the stripe patterns. The measurement unit measures the three-dimensional shape of the object to be measured based on a three-dimensional shape measurement method using the stripe pattern.

The present disclosure relates to a three-dimensional measurement device, a light source device, and a light receiving and emitting module. This application is based upon and claims the benefit of priorities from U.S. patent application Ser. No. 17/175,059, filed Feb. 12, 2021, Japanese Patent Application No. 2020-028446, filed Feb. 21, 2020, Japanese Patent Application No. 2020-142715, filed Aug. 26, 2020, and Japanese Patent Application No. 2020-198371, filed Nov. 30, 2020, the entire content of which are incorporated herein by reference. Additionally, this application is based upon and claims the benefit of priority from Japanese Patent Application No. 2022-140642, filed Sep. 5, 2022, the entire content of which is incorporated herein by reference.

### TECHNICAL FIELD

### Background

As a three-dimensional measurement method of the related art, there is, for example, a method disclosed in Specification of United States Patent Application Publication No. 2008/0240502 (Patent Literature 1). In this method of Patent Literature 1, an object to be measured is irradiated with random dot patterns, and images of dot patterns located at the same position are captured by two cameras. The three-dimensional measurement of the object to be measured is performed using the principle of triangulation on the basis of a disparity between the two dot patterns.

In addition, for example, a method disclosed in Japanese Unexamined Patent Publication No. 2011-242178 (Patent Literature 2) is a measurement method using a phase shift method. In this method of Patent Literature 2, a reference flat plate having a reference surface onto which a lattice pattern is projected is prepared, and the reference flat plate is moved by a stage in parallel to a normal direction. An image of the lattice pattern projected onto the reference surface and an image of the lattice pattern projected onto an object to be measured are captured, and the spatial coordinates of the object to be measured are calculated using a table in which the phases and spatial coordinates of the lattice pattern are associated with each other.

Jason Geng, “Structured-light 3D surface imaging: a tutorial,” Advances in Optics and Photonics 3, pp. 128-160 (2011) (Non-Patent Literature 1) discloses a three-dimensional shape measurement method using structured illumination.

### SUMMARY

An object of the present disclosure is to provide a three-dimensional measurement device, a light source device, and a light receiving and emitting module that make it possible to eliminate a deviation of an initial phase between a plurality of stripe patterns caused by a positional shift between a plurality of light source units in a measurement method using the plurality of stripe patterns.

According to an aspect of the present disclosure, there is provided a three-dimensional measurement device including: a plurality of light source units, each of the plurality of light source units being configured to irradiate an object to be measured with measurement light having each of a predetermined patterns; an image capture unit configured to capture an image of the object to be measured which is irradiated with the measurement light; and a measurement unit configured to measure a three-dimensional shape of the object to be measured based on results of image capture performed by the image capture unit. The predetermined patterns of the measurement light include respective stripe patterns, and the stripe patterns radiated from the plurality of light source units have respective patterns different from each other. The plurality of light source units are arrayed in a direction parallel to stripes in the stripe patterns. The measurement unit measures the three-dimensional shape of the object to be measured based on a three-dimensional shape measurement method using the stripe patterns.

A first light source device according to an aspect of the present disclosure is used in a three-dimensional measurement device configured to measure a three-dimensional shape of an object to be measured based on a three-dimensional shape measurement method using stripe patterns. The light source device includes a plurality of light source units. Each of the plurality of light source units is configured to irradiate an object to be measured with measurement light having each of a plurality of predetermined patterns. The predetermined patterns of the measurement light include the stripe patterns, respectively, and the stripe patterns radiated from the plurality of light source units have respective patterns different from each other. The plurality of light source units are arrayed in a direction parallel to stripes in the stripe patterns.

According to the three-dimensional measurement device and the first light source device, it is possible to eliminate a deviation of the initial phase in each of the plurality of stripe patterns caused by the positional shifts of the light source units.

Each of the plurality of light source units may comprise an S-iPMSEL oscillating at an M-point. A projector is used as a light source in the above-described method of Patent Literature 1, and an LED array is used as a light source in the method of Patent Literature 2. For that reason, there is a problem in that a three-dimensional measurement device becomes relatively large. As an image capturing device, for example, a subminiature camera having a size of 1 square mm or less has also been developed, and in order to reduce the size of the three-dimensional measurement device as a whole, it is important to reduce the size of the light source. In a case where the overall size of the three-dimensional measurement device can be reduced, it can be considered possible to apply the three-dimensional measurement device in applications such as, for example, mouth inspection, endoscopic inspection, inspection of narrow places such as the inside of a tube or a gap between walls, or inspection of household furniture, a device, or the like from below the floor, and to construct a handy-type three-dimensional measurement device. In addition, when the light source is applied to the three-dimensional measurement device, the light source is preferably a light source in which noise or distortion of light to be output is suppressed from the viewpoint of improving accuracy of measurement. The S-iPMSEL includes a phase modulation layer having a fundamental layer and a plurality of different refractive index regions that differ in refractive index from the fundamental layer, and the position of the center of gravity of each different refractive index region is shifted from the lattice point position of a virtual square lattice in accordance with an output light image. The S-iPMSEL is configured to have, for example, about the size of a needle tip, and can output a light image of a two-dimensional pattern in a direction perpendicular to or inclined with respect to the main surface of a substrate provided with the phase modulation layer. Therefore, by using the S-iPMSEL as a light source, it is possible to realize a reduction in the overall size of the three-dimensional measurement device, and to achieve the expansion of the application range of the device. In addition, by using the S-iPMSEL oscillating at an M-point, it is possible to eliminate an output of 0-order light (a diffracted wave component which is not phase-modulated) different from the light image of a desired two-dimensional pattern. Thereby, it is possible to irradiate the object to be measured with the measurement light having a pattern without noise or distortion caused by the 0-order light, and to achieve an improvement in the accuracy of measurement.

The predetermined patterns of the measurement light may be superimposed patterns, and each of the stripe patterns which are periodic and a random dot pattern are superimposed in each of the superimposed patterns. The measurement unit may measure the three-dimensional shape of the object to be measured based on a phase shift method using the superimposed patterns. The phase shift method suffers from discontinuity at a phase 2π. On the other hand, by using the random dot pattern, it is possible to improve the discontinuity at the phase 2π, and to realize high-accuracy three-dimensional measurement with a small number of patterns.

The stripe patterns which are radiated from the plurality of light source units may be gray code patterns, and the gray code patterns include respective gray codes different from each other, and the measurement unit may measure the three-dimensional shape of the object to be measured based on a triangulation method using the gray code patterns. Since the number of the gray code patterns may be relatively small with respect to the number of pixels of the image capture unit, the radiation of the measurement light having the gray code patterns can be realized by a small number of the light source units. In a case where the gray codes are used, the humming distance between adjacent pixels is 1, and even in a case where a bit error occurs when a bit string is restored, the error falls within 1. That is, the gray codes produce respective codes which are resistant to noise. In addition, the phase shift method suffers from discontinuity at a phase 2π. In contrast, by using the gray codes, it is possible to improve the discontinuity at the phase 2π, and to realize high-accuracy three-dimensional measurement with a small number of patterns.

The stripe patterns which are radiated from the plurality of light source units may be periodic stripe patterns, and the periodic stripe patterns have respective phase shifts different from each other. The measurement unit may measure the three-dimensional shape of the object to be measured based on a phase shift method using the stripe patterns.

The stripe patterns may be sinusoidal stripe patterns.

The number of phase shift of the stripe patterns may be N, and phases of the stripe patterns which are radiated from the plurality of light source units may be sequentially shifted by 2π/N.

A second light source device according to an aspect of the present disclosure is used for three-dimensional shape measurement. The second light source device includes a plurality of first light source units having optical axis directions coinciding with each other, and the plurality of first light source units are arranged side by side in a direction intersecting the optical axis directions. Each of the plurality of first light source units projects light onto a common projection region, the light including a first pattern having a plurality of bright lines that are lined up in a first direction intersecting an extending direction of the plurality of bright lines in the first pattern. The plurality of first light source units are lined up in a second direction orthogonal to the first direction.

In the second light source device, the plurality of first light source units are lined up in the second direction orthogonal to the first direction which is a line-up direction of the bright lines of the first pattern. In that case, even when the positions of the first light source units are shifted from each other by the amount of the array pitch, the direction of the shift is orthogonal to the line-up direction of the bright lines of the first pattern. Therefore, even when the positional shift of the first pattern occurs between the plurality of first light source units, the positional shift does not influence the calculation of the three-dimensional shape. Thus, it is possible to reduce a measurement error in three-dimensional shape measurement.

In the second light source device, intervals between the plurality of bright lines may be equal among the plurality of first light source units. Positions of the plurality of bright lines of the first pattern in the first direction with reference to the optical axis of each of the plurality of first light source units may be different among the plurality of first light source units. It is possible to suitably perform the three-dimensional shape measurement using the phase shift method by projecting such light including the first pattern onto the common projection region from the plurality of first light source units.

In the second light source device, the plurality of first light source units may be comprise S-iPMSELs oscillating at an M-point, respectively. In that case, it is possible to reduce the size of the light sources that output light including the first pattern, and to reduce the size of the light source device.

In the second light source device, the S-iPMSELs may be monolithically formed with each other. In that case, the S-iPMSELs can be formed in a single element to facilitate the assembly of the light source device. Additionally, it is possible to suppress an error due to positional deviation as compared with the case where individual elements are combined and mounted.

In the second light source device, the number of first light source units may be n, and a shift amount of the plurality of bright lines between the plurality of first light source units may be 1/n of an interval between the plurality of bright lines. In that case, it is possible to suitably perform the three-dimensional shape measurement using the phase shift method.

The second light source device may further include a plurality of second light source units having optical axis directions coinciding with each other. The plurality of second light source units may be arranged side by side in a direction intersecting the optical axis directions. Each of the plurality of second light source units projects light onto a common projection region. The light including a second pattern having a plurality of bright lines that are lined up in a third direction intersecting an extending direction of the plurality of bright lines in the second pattern. The plurality of second light source units are lined up in a fourth direction orthogonal to the third direction. In this case, even when the positions of the second light source units are shifted from each other by the amount of the array pitch, the direction of the shift is orthogonal to the line-up direction of the bright lines of the second pattern. Therefore, even when the positional shift of the second pattern occurs between the plurality of second light source units, the positional shift does not influence the calculation of the three-dimensional shape. Thus, it is possible to reduce a measurement error in three-dimensional shape measurement.

The plurality of second light source units may comprise S-iPMSELs oscillating at an M-point, respectively. By using the S-iPMSELs as light sources, it is possible to realize a reduction in the overall size of the three-dimensional measurement device, and to achieve the expansion of the application range of the device. In addition, by using the S-iPMSELs oscillating at the M-point, it is possible to eliminate an output of 0-order light (a diffracted wave component which is not phase-modulated) different from the light image of a desired two-dimensional pattern. Thereby, it is possible to irradiate the object to be measured with the measurement light having a pattern without noise or distortion caused by the 0-order light, and to achieve an improvement in the accuracy of measurement.

In the second light source device, intervals between the plurality of bright lines may be equal among the plurality of second light source units. Positions of the plurality of bright lines of the second pattern in the third direction with reference to the optical axis of each of the plurality of second light source units may be different among the plurality of second light source units. It is possible to suitably perform the three-dimensional shape measurement using the phase shift method by projecting such light including the second pattern onto the common projection region from the plurality of second light source units. That is, the three-dimensional shape measurement using the phase shift method can be performed at least twice with two light source groups, that is, a light source group composed of a plurality of first light source units and a light source group composed of a plurality of second light source units, thereby increasing the accuracy of measurement.

In the second light source device, an interval between the plurality of bright lines of the second pattern may be different from an interval between the plurality of bright lines of the first pattern. In that case, since the three-dimensional shape measurement using the phase shift method can be performed using two types of stripe patterns with intervals between bright lines different from each other, it is possible to further improve the accuracy of measurement.

In the second light source device, the third direction may intersect the first direction. In that case, since the three-dimensional shape measurement can be performed using two types of stripe patterns in which the line-up directions of the bright lines are different from each other, it is possible to further improve the accuracy of measurement.

A light receiving and emitting module according to an aspect of the present disclosure is used for three-dimensional shape measurement. The light receiving and emitting module includes the second light source device and an image capture element configured to capture an image of the first pattern projected onto the common projection region to generate image data. The light source device and the image capture element are provided on a common substrate. According to this light receiving and emitting module, by providing the second light source device, it is possible to reduce the size of the optical device and to reduce a measurement error in three-dimensional shape measurement.

### BRIEF DESCRIPTION OF THE DRAWINGS

FIG. 1 is a partial cross-sectional perspective view illustrating a configuration of an S-iPMSEL.

FIG. 2 is a cross-sectional view illustrating a laminated structure of the S-iPMSEL.

FIG. 3 is a plan view of a phase modulation layer.

FIG. 4 is an enlarged view illustrating a unit configuration region R.

FIG. 5 is a plan view illustrating an example in which a structure with an approximately periodic refractive index is applied within a specific region of the phase modulation layer.

FIG. 6 is a diagram illustrating a relationship between a light image obtained by imaging an output beam pattern of the S-iPMSEL and a rotation angle distribution in the phase modulation layer.

FIG. 7 is a diagram illustrating a coordinate transformation from spherical coordinates to coordinates in an XYZ orthogonal coordinate system.

FIG. 8 is a plan view illustrating a reciprocal lattice space related to the phase modulation layer of the S-iPMSEL of M-point oscillation.

FIG. 9 is a conceptual diagram illustrating a state in which a diffraction vector is added to an in-plane wavenumber vector.

FIG. 10 is a diagram schematically illustrating a peripheral structure of a light line.

FIG. 11 is a diagram conceptually illustrating an example of a rotation angle distribution φ2(x, y).

FIG. 12 is a conceptual diagram illustrating a state in which a diffraction vector is added to a vector obtained by excluding wavenumber spread from an in-plane wavenumber vector in a direction.

FIG. 13 is a plan view of a phase modulation layer according to a modification example.

FIG. 14 is a diagram illustrating a positional relationship between different refractive index regions in the phase modulation layer according to the modification example.

FIG. 15 is a schematic diagram illustrating a configuration of a three-dimensional measurement device according to a first embodiment.

FIG. 16 is a diagram illustrating an example of a periodic pattern which is used in the first embodiment.

FIG. 17A is a diagram illustrating an example of a far-field image of the periodic pattern.

FIG. 17B is a diagram illustrating an example of a far-field image of the periodic pattern.

FIG. 17C is a diagram illustrating an example of a far-field image of the periodic pattern.

FIG. 17D is a diagram illustrating an example of a far-field image of the periodic pattern.

FIG. 18 is a diagram illustrating an example of a random dot pattern which is used in the first embodiment.

FIG. 19 is a diagram illustrating an example of a pattern having a uniform density which is used in the first embodiment.

FIG. 20 is a diagram illustrating an example of an FFP of a pattern having a uniform density.

FIG. 21 is a schematic diagram illustrating a configuration of a three-dimensional measurement device according to a second embodiment.

FIG. 22 is a diagram illustrating an example of a gray code pattern which is used in the second embodiment.

FIG. 23 is a diagram illustrating an example of a sinusoidal stripe pattern which is used in the second embodiment.

FIG. 24 is a diagram illustrating an example of a sinusoidal matrix pattern which is used in the second embodiment.

FIG. 25 is a diagram illustrating a state of improved discontinuity in a phase 2π.

FIG. 26A is a diagram illustrating an example of a moire stripe pattern which is used in the second embodiment.

FIG. 26B is a diagram illustrating an example of a moire stripe pattern which is used in the second embodiment.

FIG. 27 is a diagram illustrating an example of a superimposition pattern which is used in the second embodiment.

FIG. 28 is a diagram illustrating another example of a superimposition pattern which is used in the second embodiment.

FIG. 29 is a schematic diagram illustrating a configuration of a three-dimensional measurement device according to a third embodiment.

FIG. 30 is a schematic perspective view illustrating an arrangement example of light source units and image capture units.

FIG. 31 is a schematic perspective view illustrating another arrangement example of the light source units and the image capture units.

FIG. 32 is a perspective view illustrating a formation example of the sinusoidal stripe pattern.

FIG. 33A is a schematic diagram illustrating an example of a laser beam of a multi-point pattern.

FIG. 33B is a schematic diagram illustrating an example of a stripe pattern using the multi-point pattern shown in FIG. 33A.

FIG. 34A is a schematic diagram illustrating another example of the laser beam of the multi-point pattern.

FIG. 34B is a schematic diagram illustrating an example of a stripe pattern using the multi-point pattern shown in FIG. 34A.

FIG. 35A is a schematic cross-sectional view illustrating an example of a configuration of a meta-lens structure.

FIG. 35B is a schematic cross-sectional view illustrating another example of the configuration of the meta-lens structure.

FIG. 36 is a configuration diagram of a light source device according to a fourth embodiment.

FIG. 37 is a plan view of the light source device shown in FIG. 36.

FIG. 38 is a schematic diagram illustrating a cross section of each S-iPMSEL along line XXXVIII-XXXVIII shown in FIG. 37.

FIG. 39 is a diagram illustrating a sinusoidal stripe pattern formed by a three-dimensional measurement device.

FIG. 40A is a diagram illustrating a first stripe element.

FIG. 40B is a diagram illustrating a second stripe element.

FIG. 41A is a diagram illustrating a third stripe element.

FIG. 41B is a diagram illustrating a fourth stripe element.

FIG. 42 is a diagram illustrating a stripe pattern generated by synthesizing the first to fourth stripe elements.

FIG. 43A is a diagram illustrating a first stripe pattern.

FIG. 43B is a diagram illustrating a second stripe pattern.

FIG. 44A is a diagram illustrating a third stripe pattern.

FIG. 44B is a diagram illustrating a fourth stripe pattern.

FIG. 45 is a partial cross-sectional view of a light source device according to a modification example.

FIG. 46 is a partial cross-sectional view of a light source device according to a modification example.

FIG. 47 is an exploded perspective view illustrating a configuration of a light source device according to a fifth embodiment of the present disclosure.

FIG. 48A is a diagram schematically illustrating a state in which light including each stripe element is projected onto a common projection region from each of four S-iPMSELs.

FIG. 48B is a diagram schematically illustrating a state in which light including each stripe element is projected onto a common projection region from each of the four S-iPMSELs.

FIG. 49A is a diagram schematically illustrating a state in which light including each stripe element is projected onto a common projection region from each of the four S-iPMSELs.

FIG. 49B is a diagram schematically illustrating a state in which light including each stripe element is projected onto a common projection region from each of the four S-iPMSELs.

FIG. 50A is a diagram schematically illustrating a state in which light including each stripe element is projected onto a common projection region from each of the four S-iPMSELs in a comparative example.

FIG. 50B is a diagram schematically illustrating a state in which light including each stripe element is projected onto a common projection region from each of the four S-iPMSELs in a comparative example.

FIG. 51A is a diagram schematically illustrating a state in which light including each stripe element is projected onto a common projection region from each of the four S-iPMSELs in a comparative example.

FIG. 51B is a diagram schematically illustrating a state in which light including each stripe element is projected onto a common projection region from each of the four S-iPMSELs in a comparative example.

FIG. 52 is a diagram illustrating a problem caused by a positional shift in an bright line in a comparative example.

FIG. 53 is a graph illustrating a relationship between distance and deviation of the central angle when the array pitch is set to 0.25 mm in Expression (41).

FIG. 54A is a diagram illustrating a modification example of the fifth embodiment.

FIG. 54B is a diagram illustrating a modification example of the fifth embodiment.

FIG. 55A is a diagram illustrating a modification example of the fifth embodiment.

FIG. 55B is a diagram illustrating a modification example of the fifth embodiment.

FIG. 56A is a diagram illustrating a comparative example of a modification example of the fifth embodiment.

FIG. 56B is a diagram illustrating a comparative example of a modification example of the fifth embodiment.

FIG. 57A is a diagram illustrating a comparative example of a modification example of the fifth embodiment.

FIG. 57B is a diagram illustrating a comparative example of a modification example of the fifth embodiment.

FIG. 58A is a diagram illustrating another modification example of the fifth embodiment.

FIG. 58B is a diagram illustrating another modification example of the fifth embodiment.

FIG. 59A is a diagram illustrating another modification example of the fifth embodiment.

FIG. 59B is a diagram illustrating another modification example of the fifth embodiment.

FIG. 60 is a diagram illustrating mutual conversion between a decimal number, a binary code which is another representation method of a binary number, and a gray code.

FIG. 61 is a perspective view illustrating a configuration of a light source device according to a sixth embodiment of the present disclosure.

FIG. 62 is a perspective view illustrating a configuration of a light source device according to a modification example of the sixth embodiment.

FIG. 63 is a perspective view illustrating a configuration of a light source device according to another modification example of the sixth embodiment.

FIG. 64 is a perspective view illustrating a configuration of a light receiving and emitting module according to a seventh embodiment of the present disclosure.

FIG. 65 is a perspective view illustrating a configuration of a light receiving and emitting module according to a modification example of the seventh embodiment.

FIG. 66 is a perspective view illustrating a configuration of a light receiving and emitting module according to another modification example of the seventh embodiment.

### DETAILED DESCRIPTION

Hereinafter, a preferred embodiment of a three-dimensional measurement device, a light source device, and a light receiving and emitting module according to an aspect of the present disclosure will be described in detail with reference to the accompanying drawings.

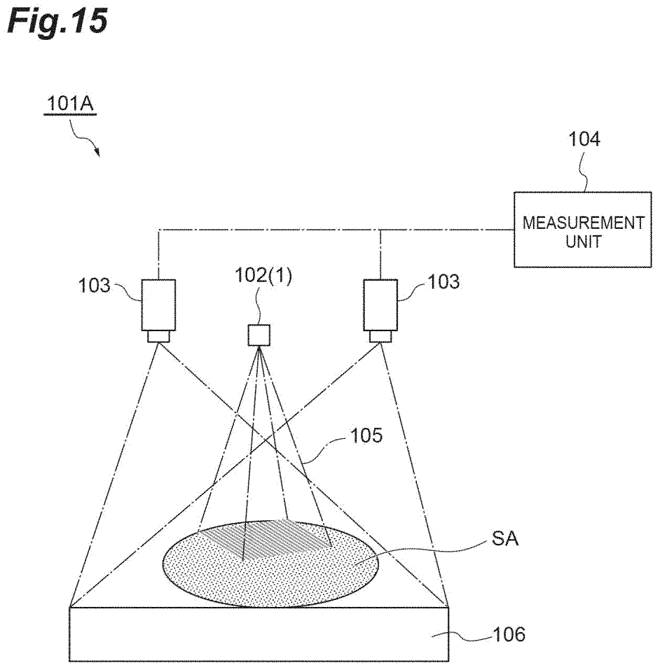

A three-dimensional measurement device 101 according to the present embodiment is configured to include one or a plurality of light source units 102 that irradiate an object to be measured SA with measurement light 105 having a predetermined pattern, one or a plurality of image capture units 103 that capture an image of the object to be measured SA which is irradiated with the measurement light 105, and a measurement unit 104 that measures a three-dimensional shape of the object to be measured SA on the basis of results of image capture performed by the image capture unit 103 (see FIG. 15 or the like). In addition, the light source unit 102 is constituted by a static-integrable phase modulating surface emitting laser (S-iPMSEL) 1 of M-point oscillation.

In the three-dimensional measurement device 101, the light source unit 102 is constituted using the S-iPMSEL 1 configured to have about the size of a needle tip, so that it is possible to reduce the size of the entire device, and to achieve the expansion of the application range of the device. In addition, in the three-dimensional measurement device 101, by using the S-iPMSEL 1 of M-point oscillation, it is possible to eliminate an output of 0-order light (a diffracted wave component which is not phase-modulated) different from the light image of a desired two-dimensional pattern. Thereby, it is possible to irradiate the object to be measured SA with the measurement light 105 having a pattern without noise or distortion caused by the 0-order light, and to achieve an improvement in the accuracy of measurement.

### [S-iPMSEL of M-Point Oscillation]

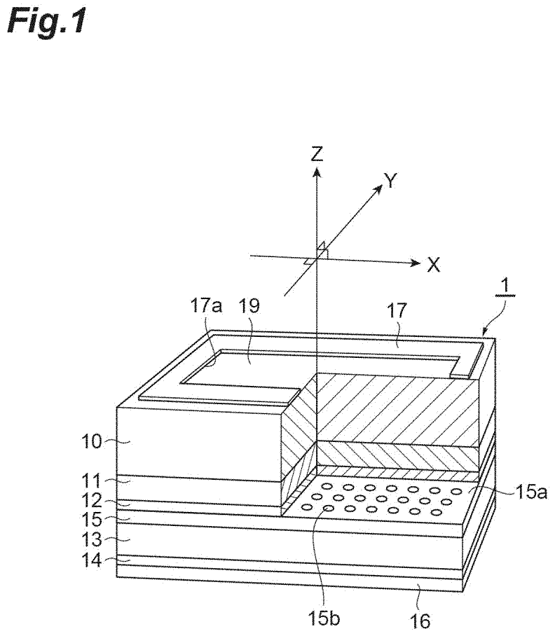

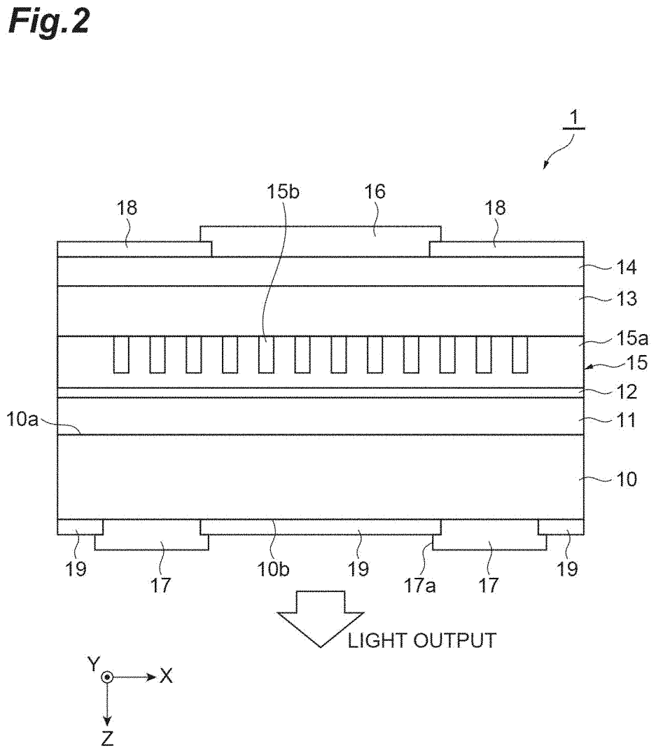

First, the S-iPMSEL 1 of M-point oscillation will be described. FIG. 1 is a partial cross-sectional perspective view illustrating a configuration of the S-iPMSEL. FIG. 2 is a cross-sectional view illustrating a laminated structure of the S-iPMSEL. In FIG. 1, an XYZ orthogonal coordinate system is defined with an axis extending in the thickness direction of the S-iPMSEL 1 as a Z axis at the center of the S-iPMSEL 1.

The S-iPMSEL 1 is a laser light source that forms standing waves in an XY in-plane direction and outputs phase-controlled plane waves in a Z-axis direction. The S-iPMSEL 1 outputs a light image having an arbitrary two-dimensional shape including a direction perpendicular to a main surface 10a of a semiconductor substrate 10 (that is, the Z-axis direction), a direction inclined with respect to the main surface, or both directions.

As shown in FIGS. 1 and 2, the S-iPMSEL 1 includes an active layer 12 as a light-emitting unit provided on the semiconductor substrate 10, a pair of cladding layers 11 and 13 interposing the active layer 12, and a contact layer 14 provided on the cladding layer 13. The semiconductor substrate 10, the cladding layers 11 and 13, and the contact layer 14 are constituted of compound semiconductors such as, for example, a GaAs-based semiconductor, an InP-based semiconductor, or a nitride-based semiconductor. The energy bandgap of the cladding layer 11 and the energy bandgap of the cladding layer 13 are larger than the energy bandgap of the active layer 12. The thickness direction of the semiconductor substrate 10 and each of the layers 11 to 14 coincides with the Z-axis direction.

The S-iPMSEL 1 further includes a phase modulation layer 15 which is the optically coupled to active layer 12. In the present embodiment, the phase modulation layer 15 is provided between the active layer 12 and the cladding layer 13. The thickness direction of the phase modulation layer 15 coincides with the Z-axis direction. The phase modulation layer 15 may be provided between the cladding layer 11 and the active layer 12. A light guide layer may be provided as necessary in at least one location between the active layer 12 and the cladding layer 13 or between the active layer 12 and the cladding layer 11. The light guide layer may include a carrier barrier layer for efficiently confining carriers in the active layer 12.

The phase modulation layer 15 is configured to include a fundamental layer 15a which is formed of a medium having a first refractive index and a plurality of different refractive index regions 15b which are formed of a medium having a second refractive index different from the refractive index of the medium having the first refractive index and are present within the fundamental layer 15a. The plurality of different refractive index regions 15b include an approximately periodic structure. In a case where the equivalent refractive index of a mode is set to n, a wavelength λ0 (=(√2)a×n; a is a lattice spacing) selected by the phase modulation layer 15 is included in the emission wavelength range of the active layer 12. The phase modulation layer 15 can be configured to select a band edge wavelength in the vicinity of the wavelength λ0 out of the emission wavelengths of the active layer 12 and to output it to the outside. A laser beam that enters the phase modulation layer 15 forms a predetermined mode according to the arrangement of the different refractive index regions 15b within the phase modulation layer 15, and is emitted from the surface of the S-iPMSEL 1 to the outside as a laser beam having a desired pattern.

The S-iPMSEL 1 further includes an electrode 16 provided on the contact layer 14 and an electrode 17 provided on a rear surface 10b of the semiconductor substrate 10. The electrode 16 is in ohmic contact with the contact layer 14, and the electrode 17 is in ohmic contact with the semiconductor substrate 10. The electrode 17 has an opening 17a. The electrode 16 is provided in the central region of the contact layer 14. Portions on the contact layer 14 other than the electrode 16 are covered with a protective film 18 (see FIG. 2). The contact layer 14 which is not in contact with the electrode 16 may be removed in order to limit a current range. Portions on the rear surface 10b of the semiconductor substrate 10 other than the electrode 17 are covered with an antireflection film 19 inclusive of the inside of the opening 17a. The antireflection film 19 present in regions other than the opening 17a may be removed.

In the S-iPMSEL 1, when a driving current is supplied between the electrode 16 and the electrode 17, the recombination of electrons and holes occurs within the active layer 12, and the active layer 12 emits light. The electrons, holes, and light generated in the active layer 12 which contribute to this light emission are efficiently trapped between the cladding layer 11 and the cladding layer 13.

The light emitted from the active layer 12 enters the phase modulation layer 15, and forms a predetermined mode according to a lattice structure inside the phase modulation layer 15. The laser beam emitted from the phase modulation layer 15 is directly output from the rear surface 10b through the opening 17a to the outside of the S-iPMSEL 1. Alternatively, the laser beam emitted from the phase modulation layer 15 is reflected from the electrode 16, and then is output from the rear surface 10b through the opening 17a to the outside of the S-iPMSEL 1. In this case, signal light (the measurement light 105) included in the laser beam is emitted in an arbitrary two-dimensional direction including a direction perpendicular to the main surface 10a or a direction inclined with respect to this direction. A desired light image is formed by this signal light. The signal light is mainly 1-order light and −1-order light of the laser beam. The 0-order light of the laser beam is not output from the phase modulation layer 15 of the present embodiment.

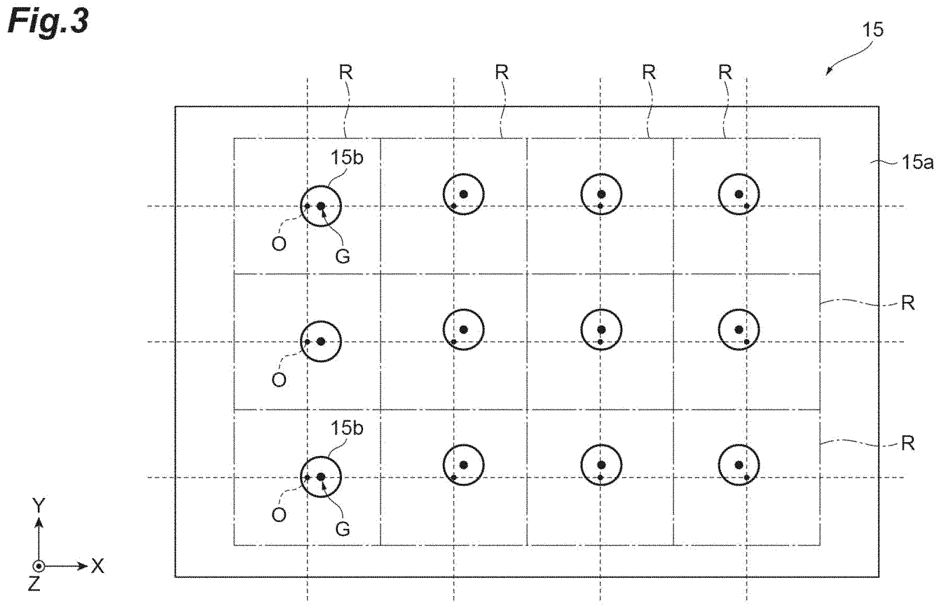

FIG. 3 is a plan view of the phase modulation layer 15. As shown in the drawing, the phase modulation layer 15 includes the fundamental layer 15a which is formed of the medium having the first refractive index and the plurality of different refractive index regions 15b which are formed of the medium having the second refractive index different from the refractive index of the medium having the first refractive index. In FIG. 3, a virtual square lattice in an XY plane is set with respect to the phase modulation layer 15. One side of the square lattice is parallel to the X axis, and the other side is parallel to the Y axis. Square-shaped unit configuration regions R centering on a lattice point O of the square lattice are set two-dimensionally over multiple rows along the X axis and multiple columns along the Y axis. In a case where the XY coordinates of each unit configuration region R are defined as the position of the center of gravity of the unit configuration region R, the position of the center of gravity coincides with the lattice point O of the virtual square lattice. The plurality of different refractive index regions 15b are provided, for example, one by one within each unit configuration region R. The planar shapes of the different refractive index regions 15b are, for example, circular. The lattice point O may be located outside the different refractive index regions 15b, or may be located inside the different refractive index regions 15b.

The ratio of an area S of the different refractive index region 15b to one unit configuration region R is referred to as a filling factor (FF). In a case where the lattice spacing of the square lattice is set to a, the filling factor FF of the different refractive index region 15b is given as S/a². S is the area of the different refractive index region 15b in the XY plane. For example, in a case where the shape of the different refractive index region 15b is perfectly circular, the filling factor FF is given as S=π(d/2)2 using the diameter d of a perfect circle. In a case where the shape of the different refractive index region 15b is square, the filling factor FF is given as S=LA2 using the length LA of one side having a square shape.

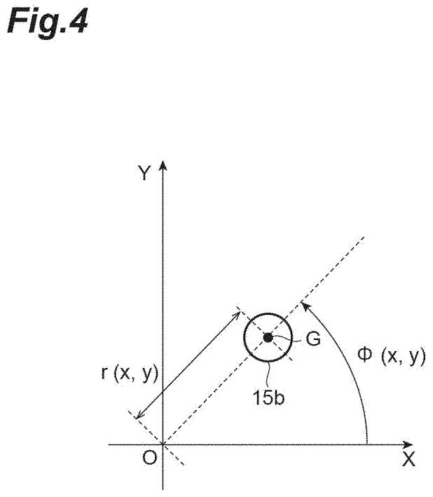

FIG. 4 is an enlarged view illustrating the unit configuration region R. As shown in the drawing, each of the different refractive index regions 15b has the center of gravity G. Here, an angle between a vector toward the center of gravity G from the lattice point O and the X axis is referred to as φ(x, y). Here, x represents the position of an x-th lattice point on the X axis, and y represents the position of a y-th lattice point on the Y axis. In a case where the rotation angle φ is 0°, the direction of the vector that links the lattice point O to the center of gravity G coincides with the forward direction of the X axis. In addition, the length of the vector that links the lattice point O to the center of gravity G is referred to as r(x, y). In an example, r(x, y) is constant over the entire phase modulation layer 15 regardless of x and y.

As shown in FIG. 3, the direction of the vector that links the lattice point O to the center of gravity G, that is, the rotation angle φ around the lattice point O of the center of gravity G of the different refractive index region 15b, is individually set for each lattice point O in accordance with a phase pattern corresponding to a desired light image. The phase pattern, that is, the rotation angle distribution φ(x, y), has a specific value for each position which is determined by the values of x and y, but is not necessarily represented by a specific function. The rotation angle distribution φ(x, y) is determined from a phase distribution extracted in a complex amplitude distribution obtained by performing a Fourier transform on a desired light image. When the complex amplitude distribution is obtained from the desired light image, the reproducibility of a beam pattern can be improved by applying an iterative algorithm such as a Gerchberg-Saxton (GS) method which is generally used during the calculation of hologram generation.

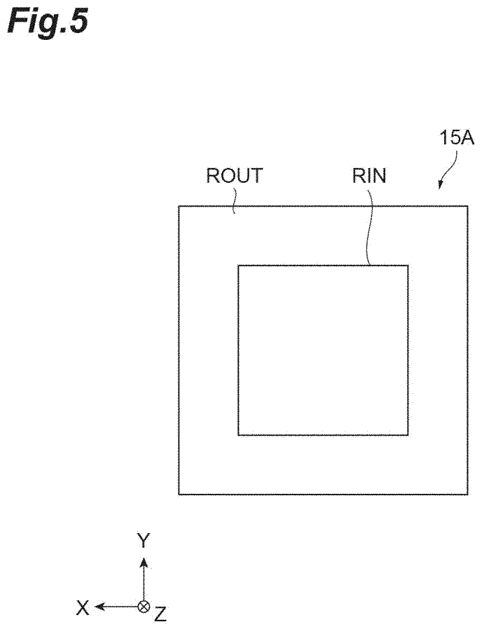

FIG. 5 is a plan view illustrating an example in which a structure with an approximately periodic refractive index is applied within a specific region of the phase modulation layer. In the example shown in FIG. 5, an approximately periodic structure (for example, a structure shown in FIG. 3) for emitting an objective beam pattern is formed inside an inside region RIN having a square shape. On the other hand, in an outside region ROUT surrounding the inside region RIN, a perfectly circular different refractive index region having the same position of the center of gravity is disposed at the lattice point position of the square lattice. The filling factor FF in the outside region ROUT is set, for example, to 12%. In the inside of the inside region RIN and the outside region ROUT, the lattice spacings between the square lattices which are virtually set are the same (=a) as each other. In the case of such a structure, since light is also distributed in the outside region ROUT, it is possible to suppress the generation of high-frequency noise (so-called window function noise) occurring due to a drastic change in light intensity in the peripheral portion of the inside region RIN. In addition, it is possible to suppress light leakage in an in-plane direction, and to expect a reduction in a threshold current.

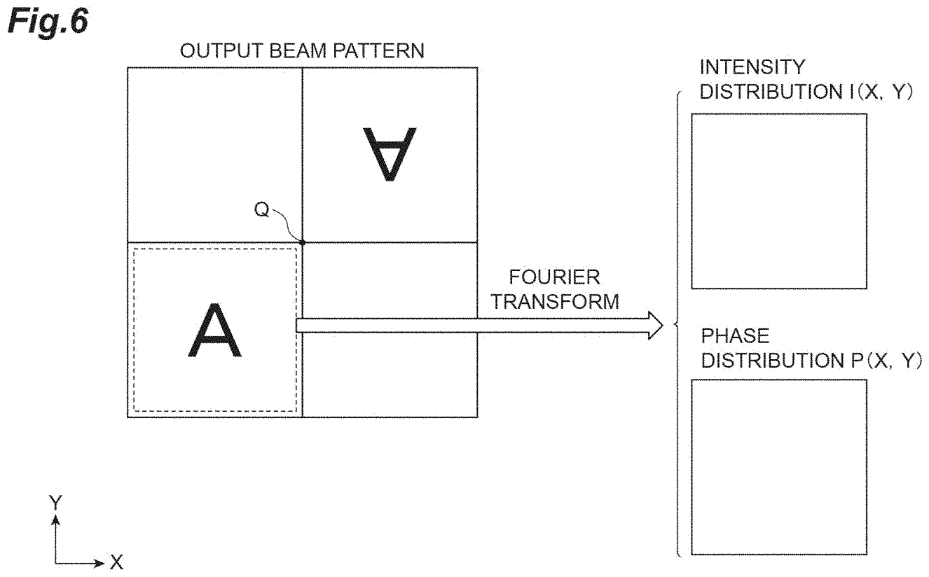

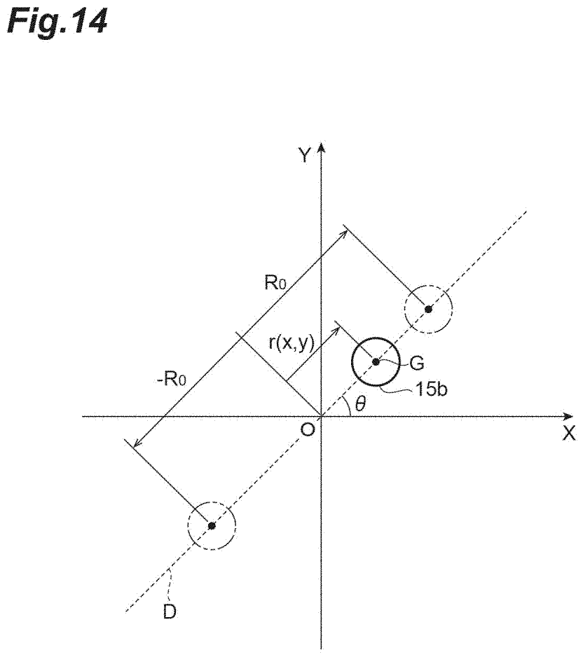

FIG. 6 is a diagram illustrating a relationship between a light image obtained by imaging an output beam pattern of the S-iPMSEL 1 and the rotation angle distribution φ(x, y) in the phase modulation layer 15. The center Q of the output beam pattern is not necessarily located on an axis perpendicular to the main surface 10a of the semiconductor substrate 10, but it can also be disposed on the axis perpendicular thereto. In FIG. 6, for convenience of description, the center Q is assumed to be located on the axis perpendicular to the main surface 10a. FIG. 6 shows four quadrants with the center Q as the origin. In the example of FIG. 6, the letter “A” appears in the third quadrant, and the letter “A” rotated 180 degrees appears in the first quadrant. In a case where output beam patterns are a rotationally symmetric light image (such as, for example, a cross, a circle, or a double circle), they overlap each other and are observed as one light image. In a case where the center of gravity G of the different refractive index region 15b in the S-iPMSEL 1 is shifted in a circumferential direction around the lattice point O as shown in FIG. 4, there is no intensity difference between the output beam pattern of the first quadrant and the output beam pattern of the third quadrant as shown in FIG. 6. However, in a case where the center of gravity G of the different refractive index region 15b in the S-iPMSEL 1 is shifted onto a straight line through the lattice point O as shown in FIG. 14 to be described later, it is possible to allow an intensity difference between the output beam pattern of the first quadrant and the output beam pattern of the third quadrant.

The light image of the output beam pattern of the S-iPMSEL 1 includes at least one of a spot, a dot, a straight line, a cross, a line drawing, a lattice pattern, a photograph, a stripe-like pattern, computer graphics (CG), and text. In order to obtain a desired light image, the rotation angle distribution φ(x, y) of the different refractive index region 15b in the phase modulation layer 15 is determined by the following procedure.

As a first precondition, in the XYZ orthogonal coordinate system defined by the Z axis coinciding with a normal direction and the X-Y plane coinciding with one surface of the phase modulation layer 15 including the plurality of different refractive index regions 15b, the virtual square lattice constituted by M1 (an integer equal to or greater than 1)×N1 (an integer equal to or greater than 1) unit configuration regions R having a square shape is set on the X-Y plane.

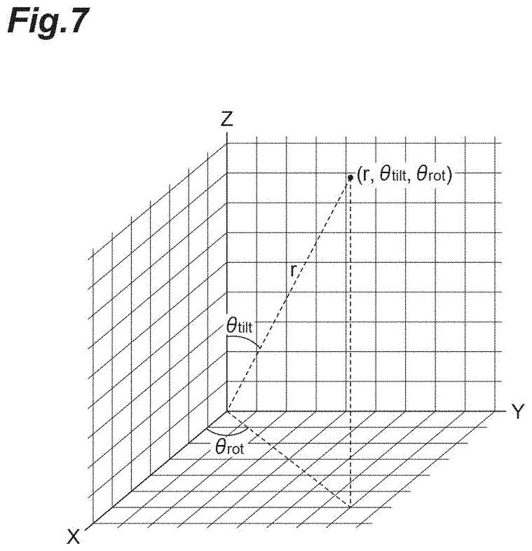

As a second precondition, as shown in FIG. 7, coordinates (ξ, η, ζ) in the XYZ orthogonal coordinate system are assumed to satisfy relations shown in the following Expressions (1) to (3) with respect to spherical coordinates (r, θrot, θtilt) defined by a radial length r, an inclination angle θtilt from the Z axis, and a rotation angle θrot from the X axis specified on the X-Y plane. FIG. 7 is a diagram illustrating a coordinate transformation from the spherical coordinates (r, θrot, θtilt) to the coordinates (ξ, η, ζ) in the XYZ orthogonal coordinate system, and a light image according to a design on a predetermined plane which is set in the XYZ orthogonal coordinate system that is a real space is represented by the coordinates (ξ, η, ζ).

When a beam pattern equivalent to a light image which is output from the S-iPMSEL 1 is defined as a set of bright spots toward a direction specified by the angles θtilt and θrot, the angles θtilt and θrot are assumed to be converted into a coordinate value kx on a Kx axis corresponding to the X axis which is a normalized wavenumber defined in the following Expression (4) and a coordinate value ky on a Ky axis corresponding to the Y axis and orthogonal to the Kx axis which is a normalized wavenumber defined in the following Expression (5). The normalized wavenumber is a wavenumber in which a wavenumber 2π/a equivalent to the lattice spacing of the virtual square lattice is standardized as 1.0. In this case, in a wavenumber space which is defined by the Kx axis and the Ky axis, specific wavenumber ranges including a beam pattern equivalent to a light image are each constituted by M2 (an integer equal to or greater than 1)×N2 (an integer equal to or greater than 1) image regions FR having a square shape. The integer M2 does not have to coincide with the integer M1. Similarly, the integer N2 does not have to coincide with the integer N1. Expressions (4) and (5) are disclosed in, for example, Y. Kurosaka et al., “Effects of non-lasing band in two-dimensional photonic-crystal lasers clarified using omnidirectional band structure,” Opt. Express 20, 21773-21783 (2012).

$$ξ = r sin {θ}_{tilt} cos {θ}_{rot} \qquad ( 1 )$$

$$η = r sin {θ}_{tilt} sin {θ}_{rot} \qquad ( 2 )$$

$$ζ = r cos {θ}_{tilt} \qquad ( 3 )$$

$${k}_{x} = \frac{a}{λ} sin {θ}_{tilt} cos {θ}_{rot} \qquad ( 4 )$$

$${k}_{y} = \frac{a}{λ} sin {θ}_{tilt} sin {θ}_{rot} \qquad ( 5 )$$

a: the lattice constant of the virtual square lattice

λ: the oscillation wavelength of the S-iPMSEL 1

As a third precondition, in the wavenumber space, a complex amplitude F(x, y) obtained by performing a two-dimensional inverse discrete Fourier transform on each image region FR(kx, ky) specified by a coordinate component kx (an integer between 0 and M2-1) in a Kx-axis direction and a coordinate component ky (an integer between 0 and N2-1) in a Ky-axis direction into the unit configuration region R(x, y) on the X-Y plane specified by a coordinate component x (an integer between 0 and M1-1) in an X-axis direction and a coordinate component y (an integer between 0 and N1-1) in a Y-axis direction is given by the following Expression (6) with j as an imaginary unit. The complex amplitude F(x, y) is defined by the following Expression (7) when the amplitude term is A(x, y) and the phase term is P(x, y). As a fourth precondition, the unit configuration region R(x, y) is defined by an s axis and a t axis which are parallel to the X axis and the Y axis, respectively, and are orthogonal to each other at the lattice point O(x, y) that is the center of the unit configuration region R(x, y).

$$F ( x , y ) = {\sum }_{{k}_{x} = 0}^{M 2 - 1} {\sum }_{{k}_{y} = 0}^{N 2 - 1} FR ( {k}_{x} , {k}_{y} ) exp [ j 2 π ( \frac{{k}_{x}}{M 2} x + \frac{{k}_{y}}{N 2} y ) ] \qquad ( 6 )$$

$$F ( x , y ) = A ( x , y ) \times exp [ jP ( x , y ) ] \qquad ( 7 )$$

Under the first to fourth preconditions, the phase modulation layer 15 is configured to satisfy the following fifth condition and sixth condition. That is, the fifth condition is satisfied by the center of gravity G being disposed away from the lattice point O(x, y) within the unit configuration region R(x, y). The sixth condition is satisfied by a corresponding different refractive index region 15b being disposed within the unit configuration region R(x, y) so that an angle φ(x, y) between the s axis and a segment that links the lattice point O(x, y) to the center of gravity G corresponding thereto satisfies the following relation in a state where a segment length r2(x, y) from the lattice point O(x, y) to the center of gravity G corresponding thereto is set to a common value in each of M1×N1 unit configuration regions R.

φ(x,y)=C x P(x,y)+B

C: a proportionality constant, for example, 180°/π

B: an arbitrary constant, for example, 0

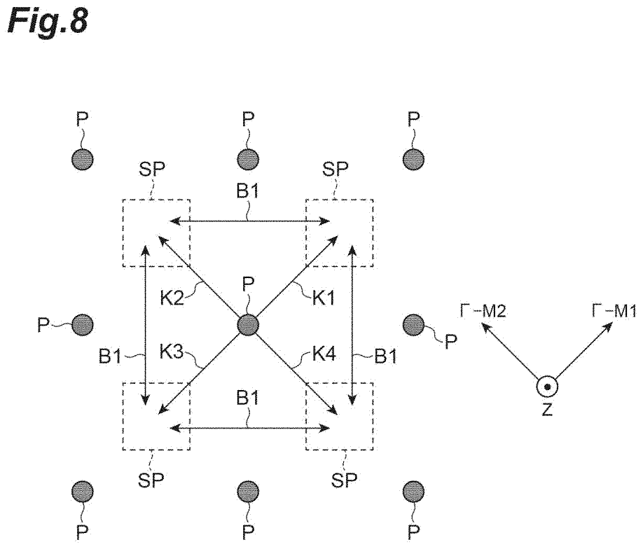

Next, the M-point oscillation of the S-iPMSEL 1 will be described. For the M-point oscillation of the S-iPMSEL 1, it is only required that the lattice spacing a of the virtual square lattice, the emission wavelength λ of the active layer 12, and the equivalent refractive index n of a mode satisfy the condition of λ=(√2)n×a. FIG. 8 is a plan view illustrating a reciprocal lattice space related to the phase modulation layer of the S-iPMSEL of M-point oscillation. Points P in the drawing represent reciprocal lattice points. Arrows B1 in the drawing represent fundamental reciprocal lattice vectors, and arrows K1, K2, K3, and K4 represent four in-plane wavenumber vectors. The in-plane wavenumber vectors K1 to K4 have wavenumber spread SP according to the rotation angle distribution φ(x, y).

The shape and magnitude of the wavenumber spread SP are the same as those in the case of the above-described F-point oscillation. In the S-iPMSEL 1 of M-point oscillation, the magnitude of the in-plane wavenumber vectors K1 to K4 (that is, the magnitude of standing waves in an in-plane direction) is smaller than the magnitude of the fundamental reciprocal lattice vector B1. Therefore, since the vector sum of the in-plane wavenumber vectors K1 to K4 and the fundamental reciprocal lattice vector B1 is not set to 0 and the wavenumber in an in-plane direction cannot be set to 0 due to diffraction, diffraction in a direction perpendicular to the plane (the Z-axis direction) does not occur. As it is, in the S-iPMSEL 1 of M-point oscillation, 0-order light in the direction perpendicular to the plane (the Z-axis direction), and 1-order light and −1-order light in a direction inclined with respect to the Z-axis direction are not output.

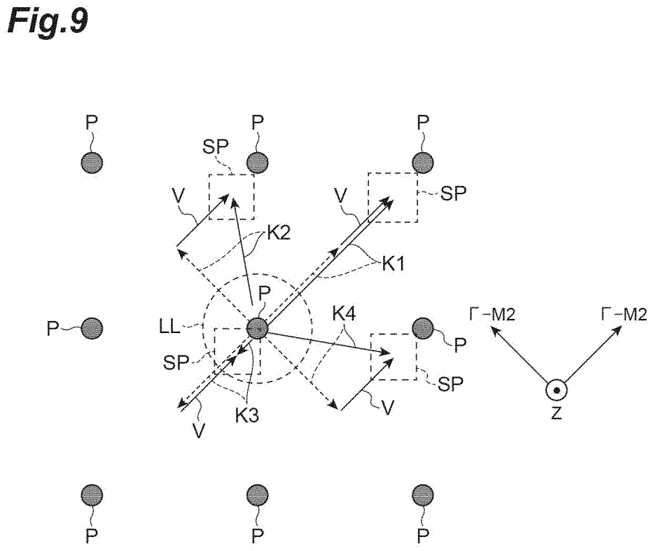

In the present embodiment, the following scheme is performed on the phase modulation layer 15 in the S-iPMSEL 1 of M-point oscillation, and thus some of the 1-order light and the −1-order light can be output without outputting the 0-order light. Specifically, as shown in FIG. 9, a diffraction vector V having a certain magnitude and direction is added to the in-plane wavenumber vectors K1 to K4, and thus the magnitude of at least one of the in-plane wavenumber vectors K1 to K4 (the in-plane wavenumber vector K3 in the drawing) is made smaller than 2π/λ. In other words, at least one of the in-plane wavenumber vectors K1 to K4 (the in-plane wavenumber vector K3) after the diffraction vector V is added is caused to fall within a circular region (light line) LL having a radius of 2π/λ.

The in-plane wavenumber vectors K1 to K4 shown by broken lines in FIG. 9 represent vectors before the addition of the diffraction vector V, and the in-plane wavenumber vectors K1 to K4 shown by solid lines represent vectors after the addition of the diffraction vector V. The light line LL corresponds to a total reflection condition, and the wavenumber vector having a magnitude which falls within the light line LL has a component in the direction perpendicular to the plane (the Z-axis direction). In an example, the direction of the diffraction vector V is along a Γ-M1 axis or a Γ-M2 axis. The magnitude of the diffraction vector V is in the range of 2π/(√2)a−2π/λ to 2π/(√2)a+2π/λ. As an example, the magnitude of the diffraction vector V is 2π/(√2)a.

Subsequently, the magnitude and direction of the diffraction vector V for causing at least one of the in-plane wavenumber vectors K1 to K4 to fall within the light line LL will be examined. The following Expressions (8) to (11) represent the in-plane wavenumber vectors K1 to K4 before the diffraction vector V is added.

$$K 1 = ( \frac{π}{a} + Δ kx , \frac{π}{a} + Δ ky ) \qquad ( 8 )$$

$$K 2 = ( - \frac{π}{a} + Δ kx , \frac{π}{a} + Δ ky ) \qquad ( 9 )$$

$$K 3 = ( - \frac{π}{a} + Δ kx , - \frac{π}{a} + Δ ky ) \qquad ( 10 )$$

$$K 4 = ( \frac{π}{a} + Δ kx , - \frac{π}{a} + Δ ky ) \qquad ( 11 )$$

The spreads Δkx and Δky of the wavenumber vector satisfy the following Expressions (12) and (13), respectively. The maximum value Δkxmax of spread of the in-plane wavenumber vector in the x-axis direction and the maximum value Δkymax of spread thereof in the y-axis direction are defined by the angle spread of the light image of a design.

−Δkxₘₐₓ≤Δkx≤Δkxₘₐₓ (12)

−Δkyₘₐₓ≤Δky≤Δkyₘₐₓ (13)

When the diffraction vector V is represented as in the following Expression (14), the in-plane wavenumber vectors K1 to K4 after the diffraction vector V is added become the following Expressions (15) to (18).

$$V = ( Vx , Vy ) \qquad ( 14 )$$

$$K 1 = ( \frac{π}{a} + Δ kx + Vx , \frac{π}{a} + Δ ky + Vy ) \qquad ( 15 )$$

$$K 2 = ( - \frac{π}{a} + Δ kx + Vx , \frac{π}{a} + Δ ky + Vy ) \qquad ( 16 )$$

$$K 3 = ( - \frac{π}{a} + Δ kx + Vx , - \frac{π}{a} + Δ ky + Vy ) \qquad ( 17 )$$

$$K 4 = ( \frac{π}{a} + Δ kx + Vx , - \frac{π}{a} + Δ ky + Vy ) \qquad ( 18 )$$

Considering that any of the wavenumber vectors K1 to K4 falls within the light line LL in Expressions (15) to (18), the relation of the following Expression (19) is established.

$${( \pm \frac{π}{a} + Δ kx + Vx )}^{2} + {( \pm \frac{π}{a} + Δ ky + Vy )}^{2} < {( \frac{2 π}{λ} )}^{2} \qquad ( 19 )$$

That is, any of the wavenumber vectors K1 to K4 falls within the light line LL when the diffraction vector V satisfying Expression (19) is added, and some of the 1-order light and the −1-order light is output.

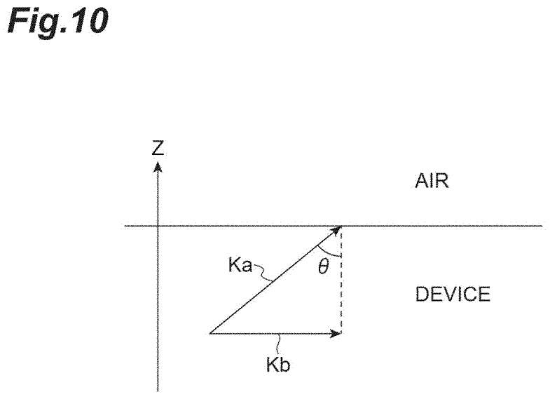

The magnitude (radius) of the light line LL is set to 2π/λ for the following reason. FIG. 10 is a diagram schematically illustrating a peripheral structure of the light line LL. The drawing shows a boundary between the device and the air viewed from a direction perpendicular to the Z-axis direction. The magnitude of the wavenumber vector of light in a vacuum is 2π/λ, but when light propagates through a device medium as shown in FIG. 10, the magnitude of a wavenumber vector Ka in the medium having a refractive index n is 2πn/λ. In this case, in order for light to propagate through the boundary between the device and the air, a wavenumber component parallel to the boundary is required to be continuous (wavenumber conservation law).

In FIG. 10, in a case where the wavenumber vector Ka and the Z axis form an angle θ, the length of a wavenumber vector (that is, an in-plane wavenumber vector) Kb projected into the plane is (2πn/λ)sin θ. On the other hand, generally, from the relation of the refractive index n of a medium >1, the wavenumber conservation law is not established at an angle where the in-plane wavenumber vector Kb in the medium is larger than 2π/λ. In this case, the light is totally reflected, and cannot be taken out to the air side. The magnitude of a wavenumber vector corresponding to this total reflection condition is the magnitude of the light line LL, that is, 2π/λ.

As an example of a specific method of adding the diffraction vector V to the in-plane wavenumber vectors K1 to K4, a method of superimposing a rotation angle distribution φ2(x, y) (second phase distribution) irrelevant to the light image on a rotation angle distribution φ1(x, y) (first phase distribution) which is a phase distribution according to the light image can be considered. In this case, the rotation angle distribution φ(x, y) of the phase modulation layer 15 is represented as φ(x, y)=φ1(x, y)+φ2(x, y). Here, φ1(x, y) is equivalent to the phase of a complex amplitude when a Fourier transform is performed on the light image as described above. In addition, φ2(x, y) is a rotation angle distribution for adding the diffraction vector V satisfying Expression (19) stated above.

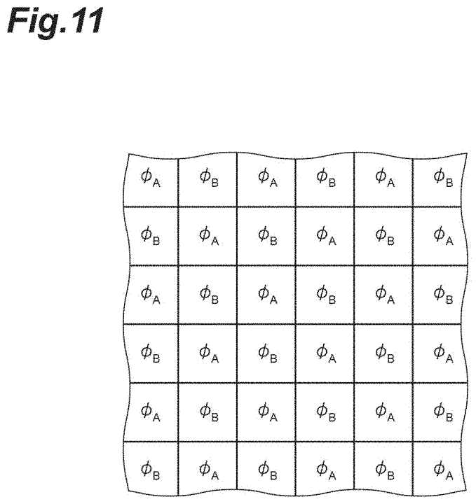

FIG. 11 is a diagram conceptually illustrating an example of the rotation angle distribution φ2(x, y). In the example of the drawing, a first phase value φA and a second phase value φB which is a value different from the first phase value φA are arrayed in a checkered pattern. In an example, the phase value φA is 0(rad), and the phase value φB is π(rad). In this case, the first phase value φA and the second phase value φB change by π. With such an array of the phase values, it is possible to suitably realize the diffraction vector V along the Γ-M1 axis or the Γ-M2 axis. In the case of a checkered array, the relation of V=(±π/a, ±π/a) is established, and the diffraction vector V and the wavenumber vectors K1 to K4 in FIG. 8 are just offset. The angle distribution θ2(x, y) of the diffraction vector V is represented by an inner product of the diffraction vector V(Vx, Vy) and a position vector r(x, y). That is, the angle distribution θ2(x, y) of the diffraction vector V is represented by θ2(x, y)=V·r=Vxx+Vyy.

In the above embodiment, in a case where the wavenumber spread based on the angle spread of the light image is included in a circle with a radius Δk centering on a certain point in the wavenumber space, the following can also be considered simply. The diffraction vector V is added to the in-plane wavenumber vectors K1 to K4 in four directions, and thus the magnitude of at least one of the in-plane wavenumber vectors K1 to K4 in four directions is made smaller than 2π/λ (the light line LL). This may mean that by adding the diffraction vector V to vectors obtained by excluding the wavenumber spread Δk from the in-plane wavenumber vectors K1 to K4 in four directions, the magnitude of at least one of the in-plane wavenumber vectors K1 to K4 in four directions is made smaller than a value {(2π/λ)−Δk} obtained by subtracting the wavenumber spread Δk from 2π/λ.

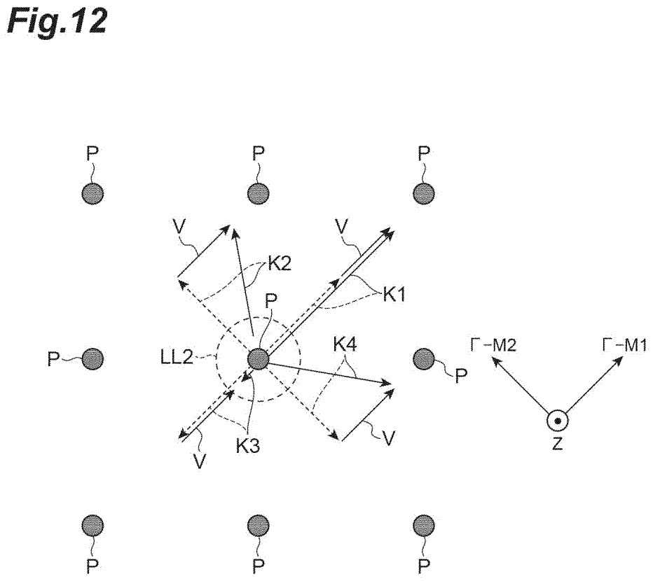

FIG. 12 is a diagram conceptually illustrating the above state. As shown in the drawing, when the diffraction vector V is added to the in-plane wavenumber vectors K1 to K4 excluding the wavenumber spread Δk, the magnitude of at least one of the in-plane wavenumber vectors K1 to K4 becomes smaller than {(2π/λ)−Δk}. In FIG. 12, a region LL2 is a circular region having a radius of {(2π/λ)−Δk}. In FIG. 12, the in-plane wavenumber vectors K1 to K4 shown by broken lines represent vectors before the addition of the diffraction vector V, and the in-plane wavenumber vectors K1 to K4 shown by solid lines represent vectors after the addition of the diffraction vector V. The region LL2 corresponds to a total reflection condition considering the wavenumber spread Δk, and the wavenumber vector having a magnitude which falls within the region LL2 also propagates in the direction perpendicular to the plane (the Z-axis direction).

In the present embodiment, the magnitude and direction of the diffraction vector V for causing at least one of the in-plane wavenumber vectors K1 to K4 to fall within the region LL2 will be described. The following Expressions (20) to (23) represent the in-plane wavenumber vectors K1 to K4 before the diffraction vector V is added.

$$K 1 = ( \frac{π}{a} , \frac{π}{a} ) \qquad ( 20 )$$

$$K 2 = ( - \frac{π}{a} , \frac{π}{a} ) \qquad ( 21 )$$

$$K 3 = ( - \frac{π}{a} , - \frac{π}{a} ) \qquad ( 22 )$$

$$K 4 = ( \frac{π}{a} , - \frac{π}{a} ) \qquad ( 23 )$$

Here, when the diffraction vector V is represented as in Expression (14) stated above, the in-plane wavenumber vectors K1 to K4 after the diffraction vector V is added become the following Expressions (24) to (27).

$$K 1 = ( \frac{π}{a} + Vx , \frac{π}{a} + Vy ) \qquad ( 24 )$$

$$K 2 = ( - \frac{π}{a} + Vx , \frac{π}{a} + Vy ) \qquad ( 25 )$$

$$K 3 = ( - \frac{π}{a} + Vx , - \frac{π}{a} + Vy ) \qquad ( 26 )$$

$$K 4 = ( \frac{π}{a} + Vx , - \frac{π}{a} + Vy ) \qquad ( 27 )$$

Considering that any of the in-plane wavenumber vectors K1 to K4 falls within the region LL2 in Expressions (24) to (27), the relation of the following Expression (28) is established. That is, any of the in-plane wavenumber vectors K1 to K4 excluding the wavenumber spread Δk falls within the region LL2 by adding the diffraction vector V satisfying Expression (28). Even in such a case, some of the 1-order light and the −1-order light can be output without outputting the 0-order light.

$${( \pm \frac{π}{a} + Vx )}^{2} + {( \pm \frac{π}{a} + Vy )}^{2} < {( \frac{2 π}{λ} - Δ k )}^{2} \qquad ( 28 )$$

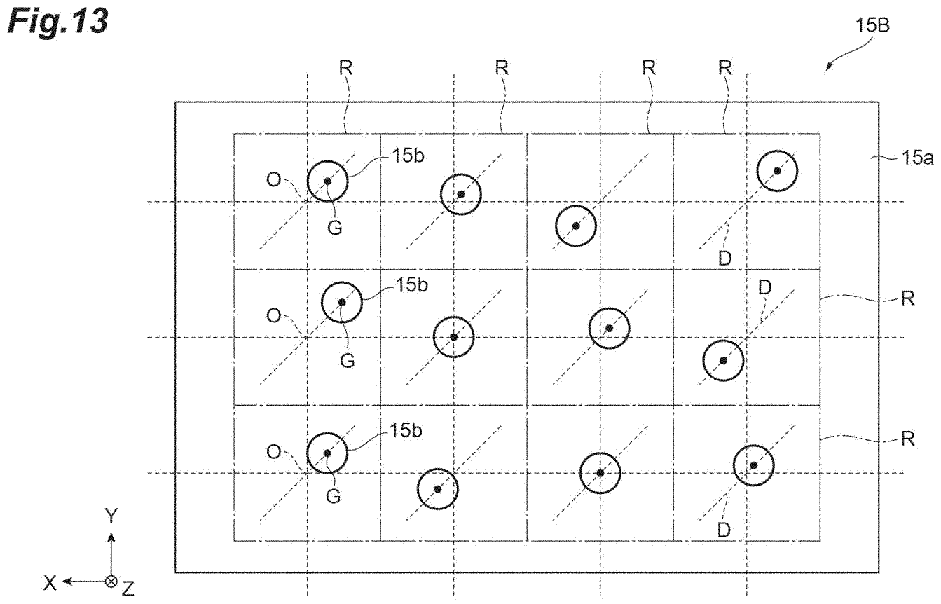

FIG. 13 is a plan view of a phase modulation layer according to a modification example. FIG. 14 is a diagram illustrating a positional relationship between different refractive index regions in the phase modulation layer according to the modification example. As shown in FIGS. 13 and 14, the center of gravity G of each the different refractive index region 15b of the phase modulation layer 15 according to the modification example is disposed on a straight line D. The straight line D is a straight line that passes through the lattice point O corresponding to each unit configuration region R and is inclined with respect to each side of the square lattice. That is, the straight line D is a straight line which is inclined with respect to both the X axis and the Y axis. The angle of inclination of the straight line D with respect to one side (X axis) of the square lattice is θ.

The angle of inclination θ is constant within the phase modulation layer 15B. The angle of inclination θ satisfies 0°<θ<90°, and the relation of θ=45° is established in an example. Alternatively, the angle of inclination θ satisfies 180°<θ<270°, and the relation of θ=225° is established in an example. In a case where the angle of inclination θ satisfies 0°<θ<90° or 180°<θ<270°, the straight line D extends from the first quadrant of the coordinate plane defined by the X axis and the Y axis to the third quadrant thereof. The angle of inclination θ satisfies 90°<θ<180°, and the relation of θ=135° is established in an example. Alternatively, the angle of inclination θ satisfies 270°<θ<360°, and the relation of θ=315° is established in an example. In a case where the angle of inclination θ satisfies 90°<θ<180° or 270°<θ<360°, the straight line D extends from the second quadrant of the coordinate plane defined by the X axis and the Y axis to the fourth quadrant thereof. In this manner, the angle of inclination θ is an angle excluding 0°, 90°, 180° and 270°.

Here, a distance between the lattice point O and the center of gravity G is defined as r(x, y). Here, x is the position of an x-th lattice point on the X axis, and y is the position of a y-th lattice point on the Y axis. In a case where the distance r(x, y) is a positive value, the center of gravity G is located at the first quadrant (or the second quadrant). In a case where the distance r(x, y) is a negative value, the center of gravity G is located at the third quadrant (or the fourth quadrant). In a case where the distance r(x, y) is 0, the lattice point O and the center of gravity G coincide with each other. The angle of inclination is preferably 45°, 135°, 225°, or 275°. At these angles of inclination, since only two of four wavenumber vectors (for example, in-plane wavenumber vectors (±π/a, ±π/a)) forming M-point standing waves are phase-modulated, and the other two are not phase-modulated, stable standing waves can be formed.

The distance r(x, y) between the center of gravity G of each different refractive index region and the lattice point O corresponding to each unit configuration region R is individually set for each different refractive index region 15b in accordance with a phase pattern corresponding to a desired light image. The phase pattern, that is, the distribution of the distances r(x, y) has a specific value for each position which is determined by the values of x and y, but is not necessarily represented by a specific function. The distribution of the distances r(x, y) is determined from a phase distribution extracted in a complex amplitude distribution obtained by performing an inverse Fourier transform on a desired light image.

As shown in FIG. 14, in a case where the phase P(x, y) at certain coordinates (x, y) is P₀, the distance r(x, y) is set to 0. In a case where the phase P(x, y) is π+P₀, the distance r(x, y) is set to a maximum value R₀. In a case where the phase P(x, y) is −π+P₀, the distance r(x, y) is set to a minimum value −R₀. For the intermediate phase P(x, y), the distance r(x, y) is set so that the relation of r(x, y)={P(x, y)−P₀}×R₀/π is established. The initial phase P₀ can be arbitrarily set.

When the lattice spacing of the virtual square lattice is set to a, the maximum value R₀ of r(x, y) is set to be, for example, in the range of the following Expression (29). When the complex amplitude distribution is obtained from the desired light image, the reproducibility of a beam pattern can be improved by applying an iterative algorithm such as a Gerchberg-Saxton (GS) method which is generally used during the calculation of hologram generation.

$$0 \leq {R}_{0} \leq \frac{a}{\sqrt{2}} \qquad ( 29 )$$

In the present embodiment, a desired light image can be obtained by determining the distribution of the distance r(x, y) between the different refractive index regions 15b of the phase modulation layer 15. Under the same first to fourth preconditions as in the above-described embodiment, the phase modulation layer 15 is configured to satisfy the following conditions. That is, a corresponding different refractive index region 15b is disposed within the unit configuration region R(x, y) so that the distance r(x, y) from the lattice point O(x, y) to the center of gravity G of the corresponding different refractive index region 15b satisfies the following relation.

r(x,y)=C×(P(x,y)−P₀)

C: a proportionality constant, for example, R₀/π

P₀: an arbitrary constant, for example, 0

The distance r(x, y) is set to 0 in a case where the phase P(x, y) at certain coordinates (x, y) is P₀. The distance r(x, y) is set to the maximum value R₀ in a case where the phase P(x, y) is π+P₀. The distance r(x, y) is set to the minimum value −R₀ in a case where the phase P(x, y) is −π+P₀. In order to obtain a desired light image, it is only required that an inverse Fourier transform is performed on the light image, and that the distribution of the distance r(x, y) according to the phase P(x, y) of its complex amplitude is given to the plurality of different refractive index regions 15b. The phase P(x, y) and the distance r(x, y) may be proportional to each other.

In the present embodiment, similarly to the above-described embodiment, the lattice spacing a of the virtual square lattice and the emission wavelength λ of the active layer 12 also satisfy the conditions of M-point oscillation. In considering a reciprocal lattice space in the phase modulation layer 15, the magnitude of at least one of in-plane wavenumber vectors in four directions including wavenumber spread according to the distribution of the distances r(x, y) can be made smaller than 2π/λ (the light line).

In the present embodiment, the following scheme is performed on the phase modulation layer 15 in the S-iPMSEL 1 of M-point oscillation, and thus some of the 1-order light and the −1-order light are output without outputting the 0-order light into the light line. Specifically, as shown in FIG. 9, the diffraction vector V having a certain magnitude and direction is added to the in-plane wavenumber vectors K1 to K4, and thus the magnitude of at least one of the in-plane wavenumber vectors K1 to K4 is made smaller than 2π/λ. That is, at least one of the in-plane wavenumber vectors K1 to K4 after the diffraction vector V is added is caused to fall within the circular region (light line) LL having a radius of 2π/λ. Any of the in-plane wavenumber vectors K1 to K4 falls within the light line LL by adding the diffraction vector V satisfying Expression (19) stated above, and some of the 1-order light and the −1-order light are output.

As shown in FIG. 12, the diffraction vector V is added to vectors obtained by excluding the wavenumber spread Δk from the in-plane wavenumber vectors K1 to K4 in four directions (that is, in-plane wavenumber vectors in four directions in the square lattice PCSEL of M-point oscillation), and thus the magnitude of at least one of the in-plane wavenumber vectors K1 to K4 in four directions may be made smaller than a value {(2π/λ)−Δk} obtained by subtracting the wavenumber spread Δk from 2π/λ. That is, any of the in-plane wavenumber vectors K1 to K4 falls within the region LL2 by adding the diffraction vector V satisfying Expression (28) stated above, and some of the 1-order light and the −1-order light are output.

As an example of a specific method of adding the diffraction vector V to the in-plane wavenumber vectors K1 to K4, a method of superimposing a distance distribution r2(x, y) (second phase distribution) irrelevant to the light image on a distance distribution r1(x, y) (first phase distribution) which is a phase distribution according to the light image can be considered. In this case, the distance distribution r(x, y) of the phase modulation layer 15 is represented as follows.

r(x,y)=r1(x,y)+r2(x,y)

Here, r1(x, y) is equivalent to the phase of a complex amplitude when a Fourier transform is performed on the light image as described above. In addition, r2(x, y) is a distance distribution for adding the diffraction vector V satisfying Expression (19) or (28) stated above. A specific example of the distance distribution r2(x, y) is the same as that in FIG. 11.

### First Embodiment of Three-Dimensional Measurement Device

FIG. 15 is a schematic diagram illustrating a configuration of a three-dimensional measurement device 101A according to a first embodiment. As shown in the drawing, the three-dimensional measurement device 101A is configured to include a single light source unit 102, a plurality of (a pair of) image capture units 103, and a measurement unit 104. The light source unit 102 is constituted by the S-iPMSEL 1 of M-point oscillation described above. The measurement light 105 which is emitted from the light source unit 102 is radiated to a fixed region on the surface of the object to be measured SA placed on a stage 106. The stage 106 may be a scanning stage capable of scanning in a two-dimensional direction or a three-dimensional direction. In a case where the range of irradiation with the measurement light 105 is sufficiently wide relative to the range of measurement of the object to be measured SA, the disposition of the stage 106 may be omitted.

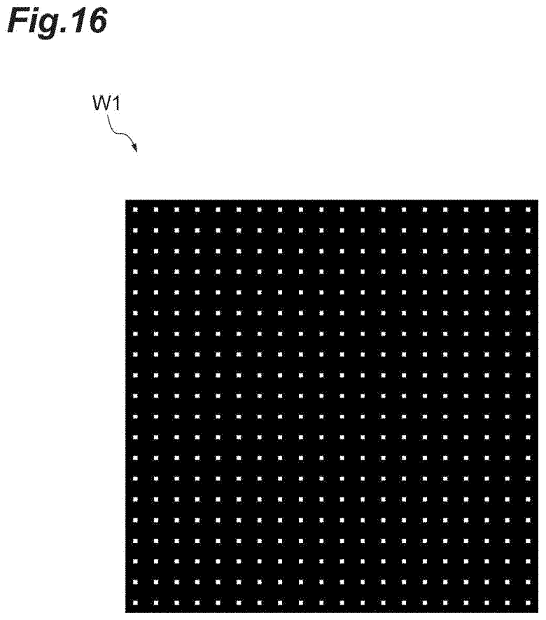

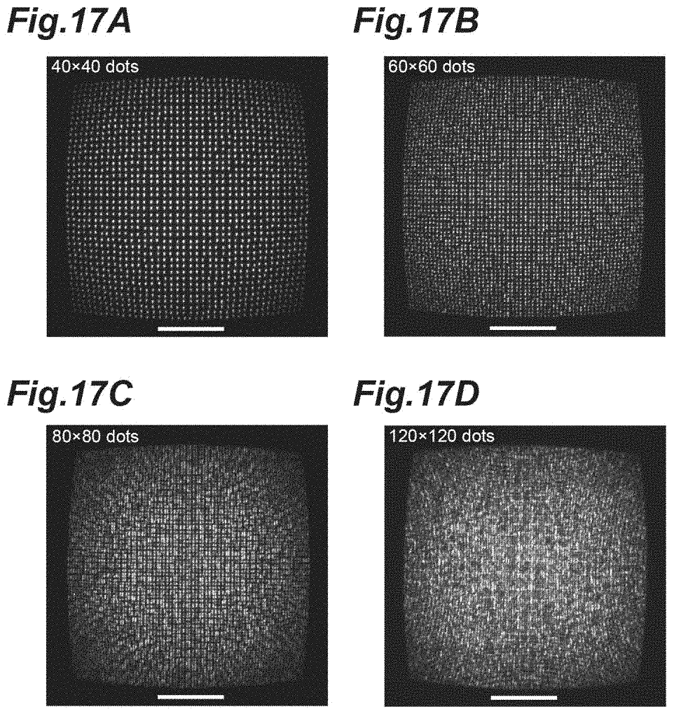

In the present embodiment, a predetermined pattern of the measurement light 105 is a periodic pattern W1 consisting of any of a dot pattern, a stripe pattern, and a lattice pattern. In the example of FIG. 16, the periodic pattern W1 of the measurement light 105 is a periodic dot pattern shown in an image region of 100×100 pixels. In this dot pattern, dots are arrayed in a matrix, and the dot period is a period of five pixels in both vertical and horizontal directions. FIGS. 17A to 17D are diagrams illustrating examples of far-field images of the periodic pattern. FIG. 17A is a far-field image of 4040 dots, FIG. 17B is a far-field image of 60×60 dots, FIG. 17C is a far-field image of 80×80 dots, and FIG. 17D is afar-field image of 120×120 dots. The driving conditions of the light source unit 102 are a current of 0.5 A, a pulse width of 50 ns, a pulse interval of 5 μs, and a temperature of 25° C. The center in each drawing is the center of the measurement light 105 in the direction perpendicular to the plane, and the scale bar in each drawing corresponds to 15°. The far-field image shown in each of these drawings is designed so that dots are arrayed in a matrix on a plane screen, and the distortion of array of portions away from the center is caused by the optical system of a measurement system.

The image capture unit 103 is constituted by a device sensitive to the measurement light 105 which is emitted from the light source unit 102. Examples of the image capture unit 103 capable of being used include a charge coupled device (CCD) camera, a complementary MOS (CMOS) camera, other two-dimensional image sensors, and the like. The image capture unit 103 captures an image of the object to be measured SA in a state of being irradiated with the measurement light 105, and outputs an output signal indicating results of image capture to the measurement unit 104.

The measurement unit 104 is constituted by, for example, a computer system configured to include a processor, a memory, and the like. The measurement unit 104 executes various control functions using the processor. Examples of the computer system include a personal computer, a microcomputer, a cloud server, a smart device (such as a smartphone or a tablet terminal), and the like. The measurement unit 104 may be constituted by a programmable logic controller (PLC), or may be constituted by an integrated circuit such as a field-programmable gate array (FPGA).

The measurement unit 104 is communicably connected to the image capture unit 103, and performs the three-dimensional shape measurement of the object to be measured SA on the basis of an output signal which is input from the image capture unit 103. In the present embodiment, the measurement unit 104 measures the three-dimensional shape of the object to be measured SA on the basis of an active stereo method using the periodic pattern W1. Here, as an example, a three-dimensional shape measurement method based on the principle of parallel coordinate stereo is shown. In a case where a disparity arising from a pair of image capture units 103 and 103 is set to D, a distance between the pair of image capture units 103 and 103 is set to b, a focal length of the pair of image capture units 103 and 103 is set to f, and a distance from the pair of image capture units 103 and 103 to the object to be measured SA is set to Z, the disparity D is given by D=(f/Z)b. Since the distance b between the image capture units 103 and 103 and the focal length of image capture units 103 and 103 are both unique values, the distance Z to the object to be measured SA can be obtained by obtaining the disparity D.

In the present embodiment, the object to be measured SA is irradiated with the measurement light 105 having the periodic pattern W1. In this case, the same point of the periodic pattern W1 of which an image is captured by each of the image capture units 103 and 103 can be discriminated by the measurement unit 104. In addition, it is possible to perform three-dimensional measurement using an image having little texture and three-dimensional measurement in a dark portion which are a problem in a passive stereo method. By using the periodic pattern W1 represented by periodic dots, it is possible to suppress a bias in the pattern density of the measurement light 105, and to suppress non-uniformity of the accuracy of measurement caused by the position of illumination with the measurement light 105.

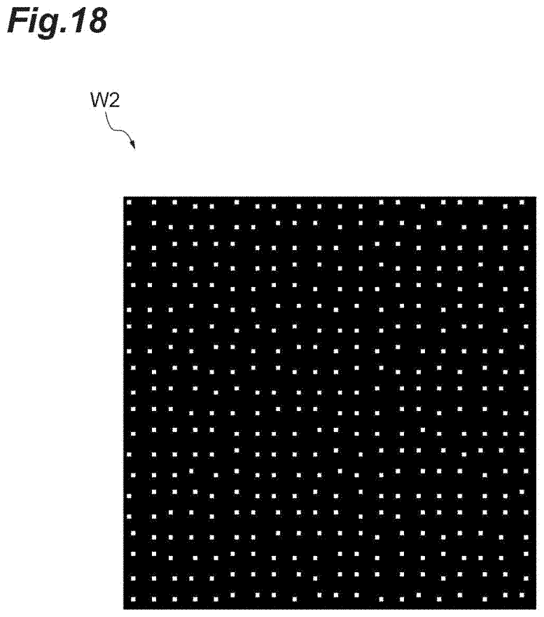

In the present embodiment, for example, a random dot pattern W2 as shown in FIG. 18 may be used instead of the periodic pattern W1. The random dot pattern W2 is a pattern obtained by randomly shifting each dot of the dot pattern shown in FIG. 16 two-dimensionally in the range of a fundamental period region (a rectangular region surrounded by segments perpendicular to the midpoint between adjacent lattice points) from the position of the lattice point. As an example, a random number φ(ix, iy) may be allocated to each dot located at the lattice point, and each dot may be shifted from the position of the lattice point on the basis of the random number φ.

In this case, since the random dot pattern W2 has a pseudo periodicity, it is possible to suppress a bias in the pattern density of the measurement light 105, and to suppress non-uniformity of the accuracy of measurement caused by the position of illumination with the measurement light 105. In addition, by using the random dot pattern W2 instead of a periodic dot pattern, it is possible to suppress misrecognition when the same point of the dot pattern is imaged by a different image capture unit 103. Therefore, it is possible to improve the accuracy of measurement of the disparity D, and to improve the accuracy of three-dimensional shape measurement.

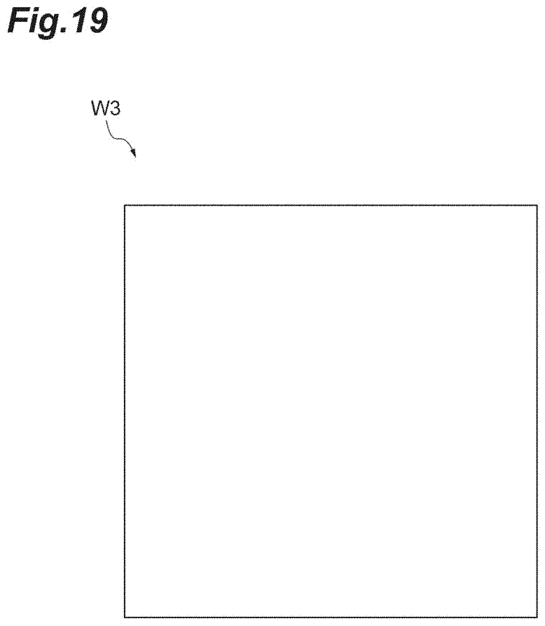

In the present embodiment, a pattern W3 having a uniform density as shown in FIG. 19 may be used instead of the periodic pattern W1. Since light emitted from the S-iPMSEL 1 is a laser beam, speckles can occur in scattered light. In addition, in phase calculation, unintentional mixing of speckle-like noise may occur. Therefore, even in a case where the pattern W3 having a uniform density is used, the random dot pattern is formed in the pattern of the measurement light 105. By using this random dot pattern, it is possible to suppress misrecognition when the same point of the dot pattern is imaged by a different image capture unit 103.

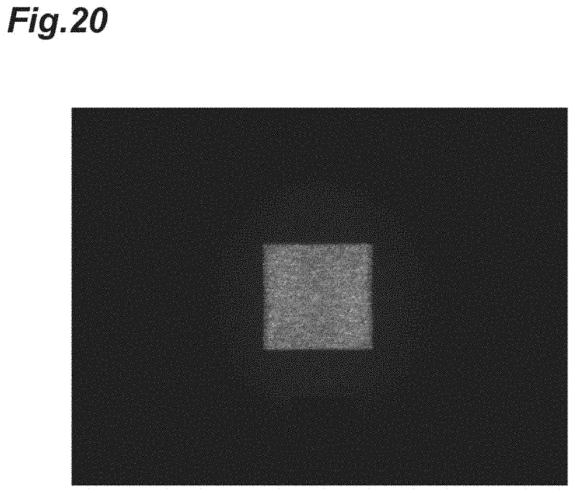

FIG. 20 is a diagram illustrating an example of a far field pattern (FFP) of the pattern W3 having a uniform density. In the example of the drawing, the FFP is observed at room temperature with the pulse width of the measurement light 105 set to 50 ns and a repetition interval set to 5 μs. In addition, color tone correction with a brightness of +40% and a contrast of −40% is added. In the drawing, even in a case where the pattern W3 having a uniform density is used, it can be confirmed that the random dot pattern is formed in the pattern of the measurement light 105.

In the example of FIG. 15, the three-dimensional measurement device 101A includes the single light source unit 102, but the three-dimensional measurement device 101A may include a plurality of light source units 102. In this case, a different region of the object to be measured SA is irradiated with the measurement light 105 from each of the light source units 102, and thus a measurement region can be enlarged without scanning the stage 106. In a case where such a configuration is adopted, the disposition of the stage 106 may be omitted.

### Second Embodiment of Three-Dimensional Measurement Device

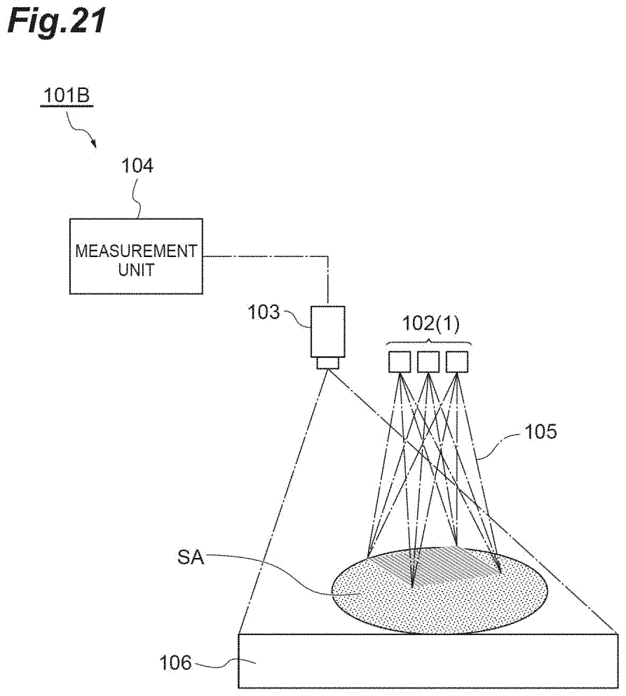

FIG. 21 is a schematic diagram illustrating a configuration of a three-dimensional measurement device according to a second embodiment. As shown in the drawing, a three-dimensional measurement device 101B according to the second embodiment is configured to include a plurality of light source units 102, a single image capture unit 103, and a measurement unit 104. The configurations of the image capture unit 103, the light source unit 102, and the measurement unit 104 are the same as those in the first embodiment. In the present embodiment, the predetermined pattern of the measurement light 105 is a gray code pattern, and the measurement unit 104 measures the three-dimensional shape of the object to be measured SA on the basis of a triangulation method using the gray code pattern.

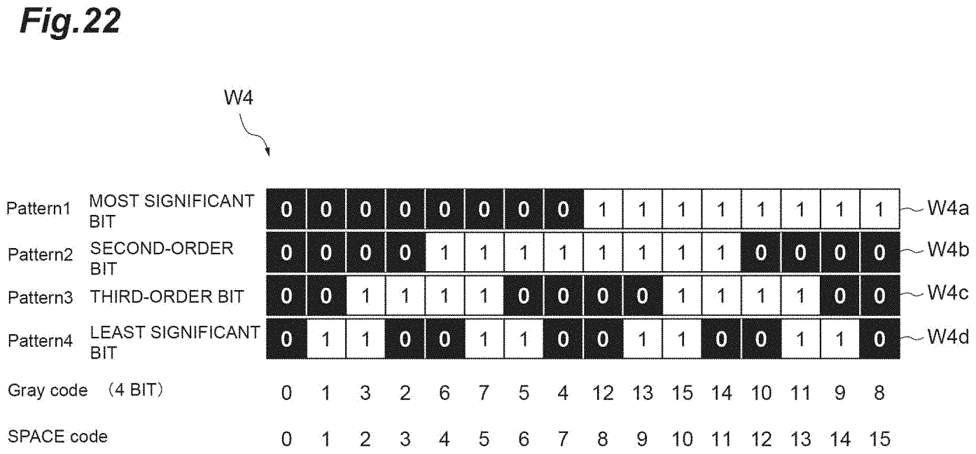

FIG. 22 is a diagram illustrating an example of a gray code pattern. In the example of the drawing, the number of pixels of the image capture unit 103 is Nx×Ny shown in the X direction. In a case where a pixel position n in the X direction (n is an integer of 0 to Nx−1) is set to an Mx-digit binary number, a gray code pattern W4 is represented by an exclusive logical sum of a binary representation of the number of objects and a number obtained by shifting the binary representation of the number of objects to the right of 1 bit and adding 0 to its head. That is, in a case where the number of objects is set to n, the gray code pattern W4 is given by a logical expression with n\hat{ }(n>>1). In the example of FIG. 22, gray code patterns W4a to W4d in the case of 4 bits (four patterns) are shown. For example, OpenCV or the like can be used for the generation of the gray code pattern W4.

In the gray code, a Hamming distance between adjacent pixels is set to 1. The term “Hamming distance” refers to the number of digits having different values located at corresponding positions when two values having the same number of digits are compared with each other. Therefore, in the gray code having a Hamming distance of 1, an error falls within 1 even in a case where a bit error occurs when a bit string is restored. In a simple binary code, an error in a position in a case where an error occurs in a high-order bit becomes larger, but in the gray code, a code resistant to noise is obtained.

In a case where the gray code is used, it is only required that the number of light source units 102 arranged is the number of patterns corresponding to each digit of the binary number. That is, the gray code patterns W4a to W4d are constituted by a plurality of stripe-like patterns in which 0 and 1 of each pixel of each digit from the most significant bit to the least significant bit are set to be different from each other. In a case where the image capture unit 103 performs image capture while sequentially switching each pattern from the gray code pattern W4a of the most significant bit to the gray code pattern W4d of the least significant bit in the light source unit 102, a value X is obtained by image capture Mx times. It can be understood that the position of an X-th pixel is measured on the basis of this value X. Similarly, in the Y direction, a value Y is obtained by image capture My times by the image capture unit 103 performing image capture while sequentially switching the gray code patterns W4a to W4d. It can be understood that the position of a Y-th pixel is measured on the basis of this value Y.

In order to avoid misrecognition due to the color of the surface of the object to be measured SA, the gray code patterns W4a to W4d shown in FIG. 22 may be used in combination with gray code patterns in which black and white are reversed. In this case, the number of the light source units 102 arranged is preferably set to 2Mx+2My.

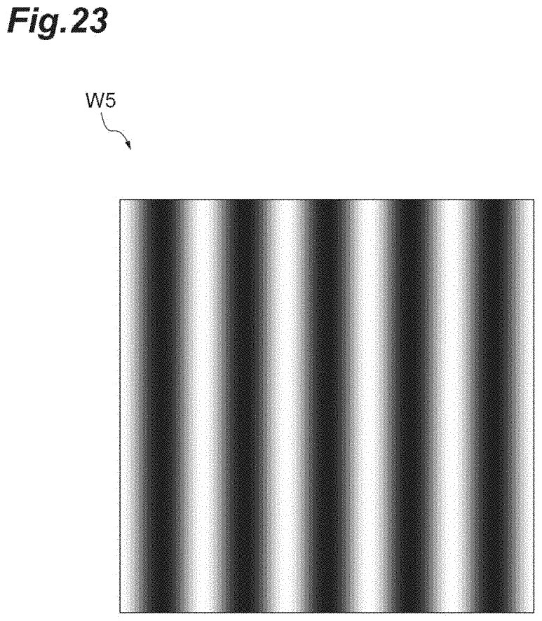

In the present embodiment, for example, as shown in FIG. 23, a sinusoidal stripe pattern W5 may be used instead of the gray code pattern W4. The sinusoidal stripe pattern W5 shown in FIG. 23 is a periodic stripe pattern shown in an image region of 100×100 pixels. The period of the sinusoidal stripe pattern W5 is a period of 20 pixels. The measurement unit 104 measures the three-dimensional shape of the object to be measured SA on the basis of a phase shift method using the sinusoidal stripe pattern W5. In such a form, for example, a plurality of the sinusoidal stripe patterns W5 to which a phase shift (positional shift) obtained by equally dividing one period with respect to a lattice pitch is given are used. As for the pattern of a phase shift, it is only required that a pattern of which the phase is shifted by 2π/N (N is an integer) is prepared.

Here, a case where four sinusoidal stripe patterns W5 having different phase shifts are used will be illustrated. In a case where the light intensities of the measurement light 105 having four sinusoidal stripe patterns W5 are set to 10 to 13, respectively, and the pixels of the image capture unit 103 are set to (x, y), the light intensities 10 to 13 on the surface of the object to be measured SA are represented by the following Expressions (30) to (33). Ia(x, y) is the amplitude of a lattice pattern, Ib(x, y) is a background intensity, and θ(x, y) is an initial phase.

I0=Ia(x,y)cos{θ(x,y)}+Ib(x,y) (30)

I1=Ia(x,y)cos{θ(x,y)+π/2}+Ib(x,y) (31)

I2=Ia(x,y)cos{θ(x,y)+π}+Ib(x,y) (32)

I3=Ia(x,y)cos{θ(x,y)+3π/2}+Ib(x,y) (33)

The initial phase θ can be obtained by tan θ=−(I3−I1)/(I2−I0). In a case where the phase shift number of the sinusoidal stripe pattern W5 is N, the initial phase θ can be obtained by the following Expression (34).

$$tan θ = - {\sum }_{n = 0}^{N - 1} \frac{In sin ( n \frac{2 π}{N} )}{In cos ( n \frac{2 π}{N} )} \qquad ( 34 )$$

In a case where such a phase shift method is used, the measured phase is converted into height, so that it is possible to measure the height of the object to be measured SA at an interval smaller than the pitch of the sinusoidal stripe pattern W5. In the configuration of the three-dimensional measurement device 101B, the light source units 102 may be arrayed in a direction parallel to the stripe in the sinusoidal stripe pattern W5. In this case, it is possible to eliminate a phase shift caused by the positional shift of the light source unit 102, and to eliminate a shift of the initial phase in each of the plurality of the sinusoidal stripe patterns W5.

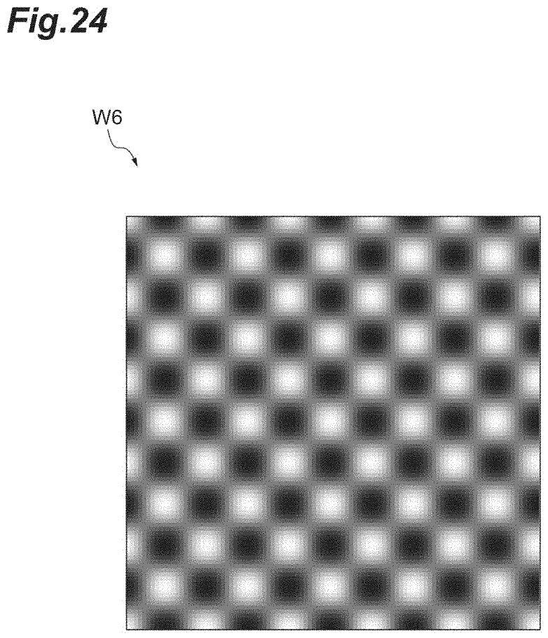

In the present embodiment, the light source units 102 may be arrayed in biaxial directions orthogonal to each other. In this case, by switching on/off of the measurement light 105 for each axis, the height profile of the object to be measured SA can be acquired on two axes. For example, as shown in FIG. 24, a matrix pattern W6 that changes in a sinusoidal manner in biaxial directions orthogonal to each other may be used instead of the sinusoidal stripe pattern W5. In a case where such a matrix pattern W6 is used, the height profile of the object to be measured SA can be simultaneously measured in biaxial directions.

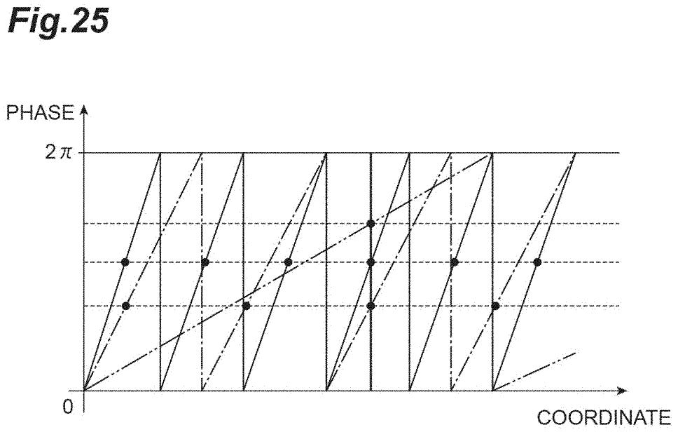

In the present embodiment, the plurality of light source units 102 may output the sinusoidal stripe patterns W5 having different periods from each other. In the above-described phase shift method, the discontinuity in a phase of 2π has arisen as a problem. On the other hand, in a case where the sinusoidal stripe patterns W5 having different periods from each other are used, for example, as shown in FIG. 25, by selecting matching coordinates at all frequencies, it is possible to improve the discontinuity in a phase of 2π, and to realize high-accuracy three-dimensional measurement using a small number of patterns. By improving the discontinuity in a phase of 2π, it is possible to realize the expansion of the measurement range of three-dimensional shape measurement and the high-accuracy measurement of the object to be measured SA with remarkable unevenness.

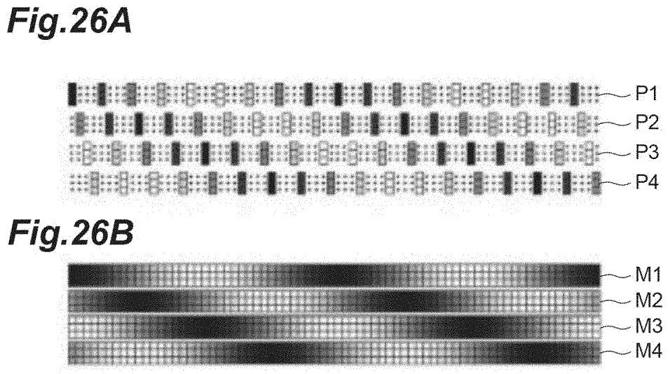

In the present embodiment, the measurement unit 104 may measure the three-dimensional shape of the object to be measured SA on the basis of a sampling moire method using the sinusoidal stripe pattern W5. The sampling moire method uses the deformation of the lattice of the sinusoidal stripe pattern W5 projected onto the surface of the object to be measured SA in accordance with the height of the object to be measured SA. Here, in an image captured by the image capture unit 103, the stripe interval of one sinusoidal pattern of the phase shift number N at the height of the reference surface is adjusted in advance so as to correspond to N pixels of a camera. Here, the phase shift number N is set to 4. Irradiation with one sinusoidal pattern is performed, and the pixels of the image capture unit 103 are sampled for every N=4 pixels, so that four patterns P1 to P4 imaged for every four pixels (with three pixels between imaging pixels thinned out) are obtained as shown in FIG. 26A. The imaging pixels are shifted one by one between these patterns P1 to P4, and the luminance value of the imaging pixels is linearly complemented, so that moire stripe patterns M1 to M4 of which the phases are shifted from each other are obtained as shown in FIG. 26B. By applying the above-described phase shift method using these moire stripe patterns M1 to M4, it is possible to measure the height of the object to be measured SA at an interval smaller than the pitch of the sinusoidal stripe pattern W5. According to such a method, it is possible to make the number of sinusoidal patterns to be radiated smaller and to make the light source unit 102 compacter than in the above-described phase shift method.

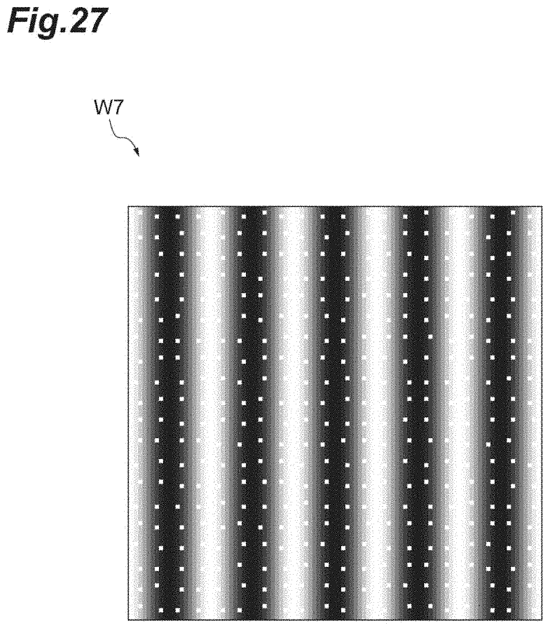

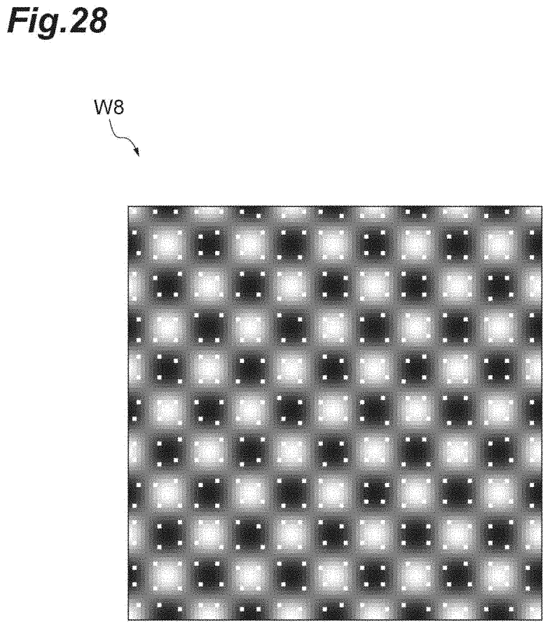

In the present embodiment, for example, as shown in FIG. 27, a superimposition pattern W7 obtained by superimposing the sinusoidal stripe pattern W5 on the random dot pattern W2 may be used instead of the sinusoidal stripe pattern W5. By using such a superimposition pattern W7, it is possible to measure the height of the object to be measured SA at an interval smaller than the pitch of the sinusoidal stripe pattern W5. In addition, by also using the random dot pattern, it is possible to improve the discontinuity in a phase of 2π, and to realize high-accuracy three-dimensional measurement using a small number of patterns. As shown in FIG. 28, the superimposition pattern may be a superimposition pattern W8 obtained by superimposing the matrix pattern W6 that changes in a sinusoidal manner on the random dot pattern W2. In this case, the height profile of the object to be measured SA can be simultaneously measured in biaxial directions in addition to the above-described effect.

In the present embodiment, both the sinusoidal stripe pattern W5 and the gray code pattern W4 may be used. In this case, the measurement unit 104 measures the three-dimensional shape of the object to be measured SA on the basis of a phase shift method using the sinusoidal stripe pattern W5 and a triangulation method using the gray code pattern W4. In this case, a pixel level can be measured by the triangulation method using the gray code pattern W4, and a sub-pixel level can be measured by the phase shift method using the sinusoidal stripe pattern W5. In addition, by using the gray code, it is possible to improve the discontinuity in a phase of 2π, and to realize high-accuracy three-dimensional measurement using a small number of patterns.

### Third Embodiment of Three-Dimensional Measurement Device

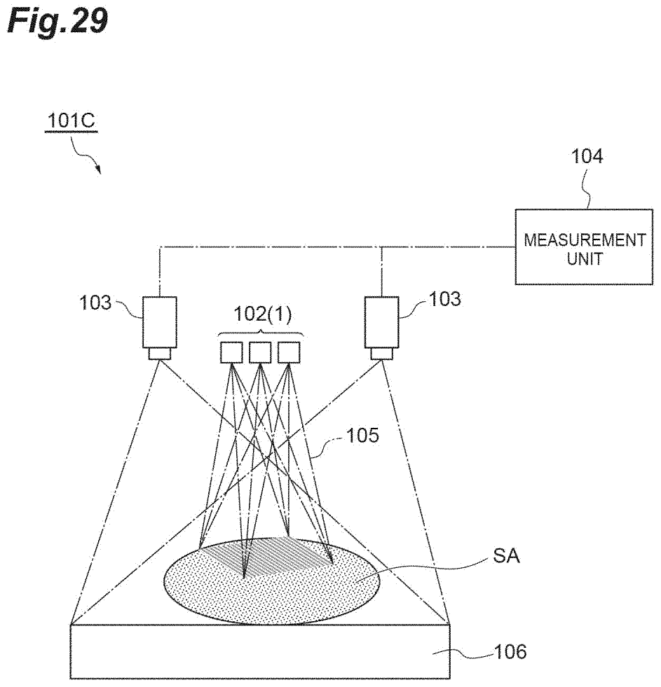

FIG. 29 is a schematic diagram illustrating a configuration of a three-dimensional measurement device according to a third embodiment. As shown in the drawing, a three-dimensional measurement device 101C according to the third embodiment is configured to include a plurality of light source units 102, a plurality of (a pair of) image capture units 103, and a measurement unit 104. The configurations of the image capture unit 103, the light source unit 102, and the measurement unit 104 are the same as those in the first embodiment. In the present embodiment, the predetermined pattern of the measurement light 105 is the sinusoidal stripe pattern W5, and the measurement unit 104 measures the three-dimensional shape of the object to be measured SA on the basis of the phase shift method and active stereo method using the sinusoidal stripe pattern W5.

In the present embodiment, the measured phase is converted into height, so that it is possible to measure the height of the object to be measured SA at an interval smaller than the pitch of the sinusoidal stripe pattern W5. In addition, by also using an active stereo method using the plurality of image capture units 103, it is possible to improve the discontinuity in a phase of 2π, and to realize high-accuracy three-dimensional measurement using a small number of patterns. In a case where the active stereo method is used, the method may be used while switching the above-described dot patterns.

### [Phase Shift of Sinusoidal Stripe Pattern by S-iPMSEL]

In the S-iPMSEL 1, the −1-order light symmetric with respect to the normal line of a light emission surface is output in addition to the designed 1-order light (see FIG. 6). Therefore, in a case where the phase shift of the sinusoidal stripe pattern W5 is performed, considering sinusoidal waves in which beams of the +1-order light overlap each other, a direction in which the stripe is shifted between the 1-order light and the −1-order light is reversed, and thus there is a concern of the pattern deviating from a design. For the purpose of simplifying the description, considering a shift of the stripe in the X-axis direction, the complex amplitude of the 1-order light is represented by the following Expression (35). The complex amplitude of the −1-order light is emitted to a position symmetric to the 1-order light with respect to the surface normal line, and is represented by the following Expression (36). In the expression, k(=kx, ky, kz) is a wavenumber vector (magnitude 2π/λ), λ is a wavelength, w is each frequency of light, Δθ is a phase shift, a1 is a 1-order light amplitude (a component caused by a phase distribution of actual hole arrangement with respect to an ideal phase distribution), K is the wavenumber of the stripe of a sine wave (=2π/Λ (Λ is the period of a sine wave)), θ is the phase shift amount of a sine wave, and (x, y, z) is the coordinates of a projection beam.

A₁=a₁ cos(Kx+θ)exp{j(ωt−k,x−k_{y},y−k_{z}z)} (35)

A₋₁=a₋₁ cos(Kx+θ)exp{j(ωt+kₓx+k_{y}y−k_{z}z)} (36)

In this case, a composite amplitude A can be obtained by the following Expression (37) on the basis of the amplitudes of the 1-order light and the −1-order light.

A=cos(Kx+θ){a₁ exp[j{ωt−k_{z}z−(kₓx+k_{y}y)}]+a₋₁ exp[j{ωt−k_{z}z+(kₓx+k_{y}y)}]} (37)

Since the actual light intensity is proportional to the square of the composite amplitude A, it can be obtained by the following Expression (38).

I=A̅A̅=cos²(Kx+θ){a₁²+a₋₁²+2a₁a₋₁ cos(kₓx+k_{y}y)} (38)

The period of a fundamental light wave is sufficiently smaller than the period of the sine wave (λ<<Λ). Therefore, the wavenumber k of the fundamental light wave is sufficiently larger than the wavenumber K of the stripe of the sine wave (k>>K). Therefore, in Expression (38), it can be considered that terms corresponding to a change in k may be averaged. In this case, the intensity I of light obtained by superimposing the ±1-order light can be approximated by the following Expression (39).

$$I ≅ ( {a}_{1}^{2} + {a}_{- 1}^{2} ) \frac{cos \{ 2 ( Kx + θ ) \} + 1}{2} \qquad ( 39 )$$

From these expressions, in a case where the phase shift of the sinusoidal stripe pattern W5 is performed, it can be understood that the stripe can be shifted with the sine wave shape maintained even when beams of the ±1-order light overlap each other. In addition, in a sinusoidal pattern in which beams of the 1-order light overlap each other, it can be understood that an interval between the stripes having light intensity (square of the sum of the amplitudes of the ±1-order light) actually obtained with respect to a design pattern (1-order light amplitude) is halved, and that the phase shift amount is doubled for one period. Therefore, in a case where a phase shift of π/2 is realized, for example, in light intensity obtained finally, the design value of the phase shift amount of the 1-order light amplitude is preferably set to π/4. The same is true of the sinusoidal matrix pattern W6 having a period in biaxial directions.

As shown in FIG. 4, in a case where the center of gravity G of the different refractive index region 15b in the S-iPMSEL 1 is formed by shifting the center in a circumferential direction around the lattice point O, the amplitudes a of the 1-order light and the −1-order light have values equal to each other. On the other hand, as shown in FIG. 14, in a case where the center of gravity G of the different refractive index region 15b in the S-iPMSEL 1 is formed by shifting the center onto the straight line D that passes through the lattice point O and is inclined with respect to each side of the square lattice, the amplitudes a of the 1-order light and the −1-order light have values different from each other. In either case, it is possible to use a sinusoidal pattern in which beams of the ±1-order light overlap each other.

In a case where the 1-order light and the −1-order light are asymmetric patterns, there is a problem in that a designed pattern is not obtained when the 1-order light and the −1-order light overlap each other. An example of such a problem is that the structure of the 1-order light per bright spot has asymmetric spread and a design pattern becomes unclear. In this case, it is only required that the emission region of the 1-order light is limited to a region in which a solid angle is n. For example, in a case where the emission region of the 1-order light is limited to the first quadrant and the second quadrant, the emission region of the −1-order light becomes the fourth quadrant and the third quadrant, and thus it is possible to avoid the 1-order light and the −1-order light overlapping each other. This makes it possible to suppress the spread of the bright spot due to overlap of the 1-order light and −1-order light. In a case where the lattice pattern is shifted by the phase shift method, the shift direction of the −1-order light is reversed to the shift direction of the 1-order light. Therefore, it is preferable to reverse a phase obtained by a phase shift calculation in accordance with each emission region of the 1-order light and the −1-order light. On the other hand, in a case where an image having little noise is obtained without superimposing the 1-order light and the −1-order light even when the above problem not occur, each of the projection regions of the +1-order light may be used without superimposition thereof.

### [Arrangement Example of Light Source Units and Image Capture Units]

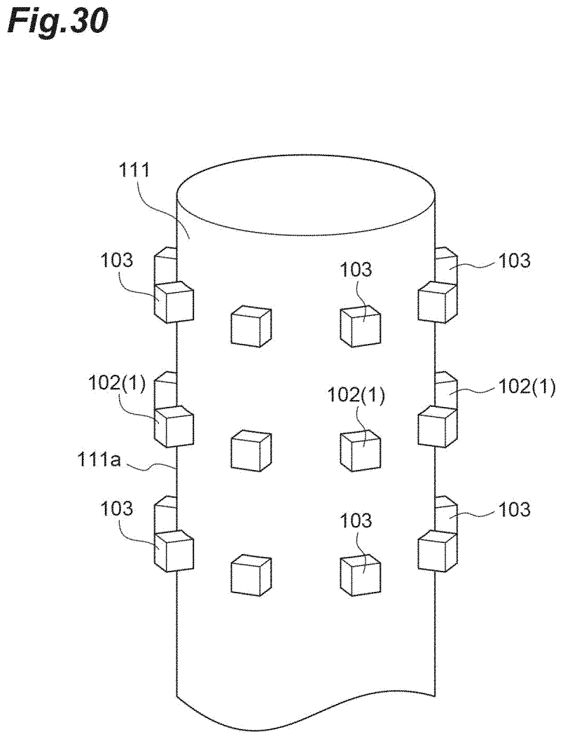

FIG. 30 is a schematic perspective view illustrating an arrangement example of light source units and image capture units. As shown in FIG. 30, in constituting the three-dimensional measurement device 101, the light source units 102 and the image capture units 103 may be arranged on the surface of a three-dimensional object 111. The three-dimensional object 111 constitutes a portion equivalent to probes of the three-dimensional measurement devices 101A to 101C. The three-dimensional object 111 is formed of, for example, a metal or a resin in a cylindrical shape. The three-dimensional object 111 may have rigidity, or may have flexibility. The three-dimensional object 111 may have an internal space.

The light source units 102 and the image capture units 103 are arranged at regular intervals (here, a phase angle of 45°) in a circumferential direction on a circumferential surface 111a of the cylindrical three-dimensional object 111. In the example of FIG. 30, a group of the image capture units 103 on one side, a group of the light source units 102, and a group of the image capture units 103 on the other side are arranged at regular intervals from the tip side of the three-dimensional object 111 to the base end side thereof. When the three-dimensional object 111 is viewed in a longitudinal direction, one image capture unit 103, the light source unit 102, and the other image capture unit 103 are lined up in a row, and the set thereof constitutes one measurement region for the object to be measured SA. In a case where the three-dimensional object 111 has an internal space, wiring or the like for the light source unit 102 and the image capture unit 103 may be received in the internal space. The arrangement intervals of the light source unit 102 and the image capture unit 103 may not necessarily be equally spaced intervals. In a case where the range of measurement for the object to be measured SA is covered, the single light source unit 102 and the single image capture unit 103 may be disposed on the three-dimensional object 111.

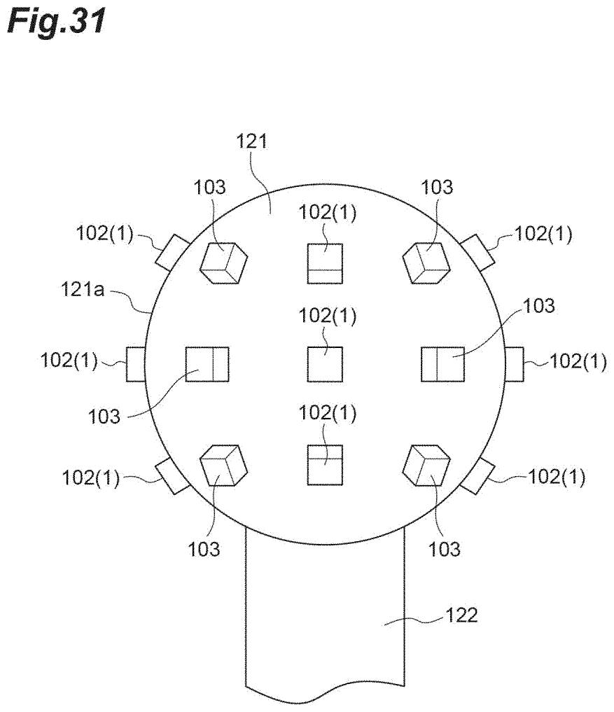

FIG. 31 is a schematic perspective view illustrating another arrangement example of the light source units and the image capture units. In the example of FIG. 31, a three-dimensional object 121 is formed in a spherical shape, and is provided at, for example, the tip portion of a cylindrical support 122. The light source units 102 and the image capture units 103 are arranged at regular intervals (here, a phase angle of 45°) in a longitude direction on a spherical surface 121a of the spherical three-dimensional object 121. A group of the image capture units 103 on one side, a group of the light source units 102, and a group of the image capture units 103 on the other side are arranged at regular intervals in the latitude direction of the three-dimensional object 121. A set of one the image capture unit 103, the light source unit 102, and the other image capture unit 103 lined up in the longitude direction of the three-dimensional object 121 constitutes one measurement region for the object to be measured SA. In a case where the three-dimensional object 121 has an internal space, wiring or the like for the light source unit 102 and the image capture unit 103 may be received in the internal space. Similarly to the case of FIG. 30, the arrangement intervals of the light source unit 102 and the image capture unit 103 may not necessarily be equally spaced intervals. In a case where the range of measurement for the object to be measured SA is covered, the single light source unit 102 and the single image capture unit 103 may be disposed on the three-dimensional object 121.

According to such a configuration, the three-dimensional objects 111 and 121 on which the light source unit 102 and the image capture unit 103 are disposed can be constituted as a probe of the three-dimensional measurement device 101. By using such three-dimensional objects 111 and 121, the sets of the light source units 102 and the image capture units 103 can be directed in different directions from each other, and thus it is possible to perform the three-dimensional shape measurement of the object to be measured SA at a wide solid angle. In addition, it is easy to apply the three-dimensional measurement device in applications such as, for example, mouth inspection, endoscopic inspection, inspection of narrow places such as the inside of a tube or a gap between walls, or inspection of household furniture, a device, or the like from below the floor, and to construct a handy-type three-dimensional measurement device.

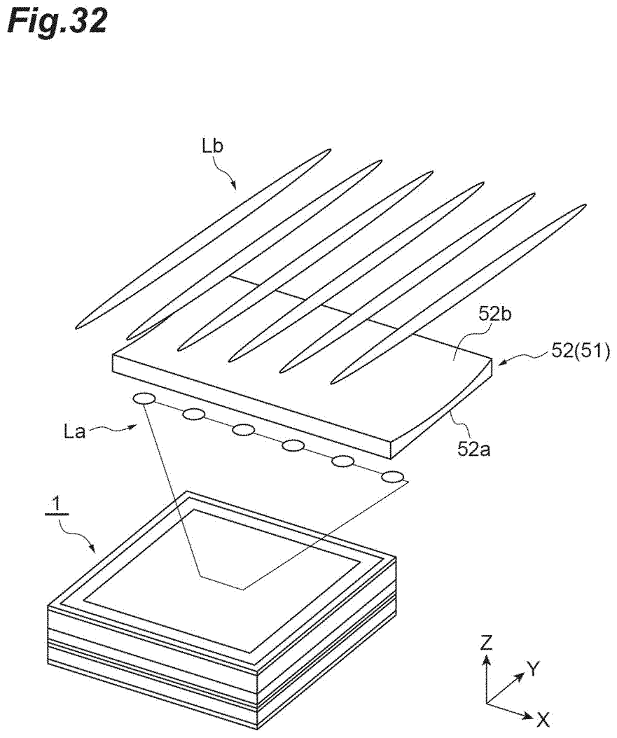

The sinusoidal stripe pattern W5 is shown in FIG. 23, and it is important to reduce noise (luminance fluctuation) between adjacent patterns in forming such a stripe pattern. The noise between adjacent patterns can be considered to cause a fluctuation in position, for example, when the phase shift method is applied, and to influence the accuracy of measurement. Consequently, in realizing the formation of a stripe pattern in consideration of the reduction of noise between adjacent patterns, for example, as shown in FIG. 32, a configuration in which the S-iPMSEL 1 that emits a one-dimensional multi-point pattern and a one-dimensional lens 51 are combined can be adopted.

In the example of FIG. 32, the one-dimensional lens 51 is a one-dimensional concave lens 52. The medium of the one-dimensional concave lens 52 is, for example, glass. One surface 52a of the one-dimensional concave lens 52 is a flat surface, and the other surface 52b is a concave surface. The one-dimensional concave lens 52 is disposed on the surface of the S-iPMSEL 1 (the light emission surface of a laser beam) with the one surface 52a directed to the S-iPMSEL 1. The one-dimensional concave lens 52 may be coupled to the surface of the S-iPMSEL 1, and be integrated with the S-iPMSEL 1. The lens phase of the one-dimensional concave lens 52 is obtained by the following Expression (40). In the following Expression (40), φ is a lens phase, λ is the wavelength of a laser beam in a lens medium, and f is a focal length.

$$ϕ ( y ) = \frac{2 π}{λ} ( \sqrt{{y}^{2} + {f}^{2}} - f ) \qquad ( 40 )$$

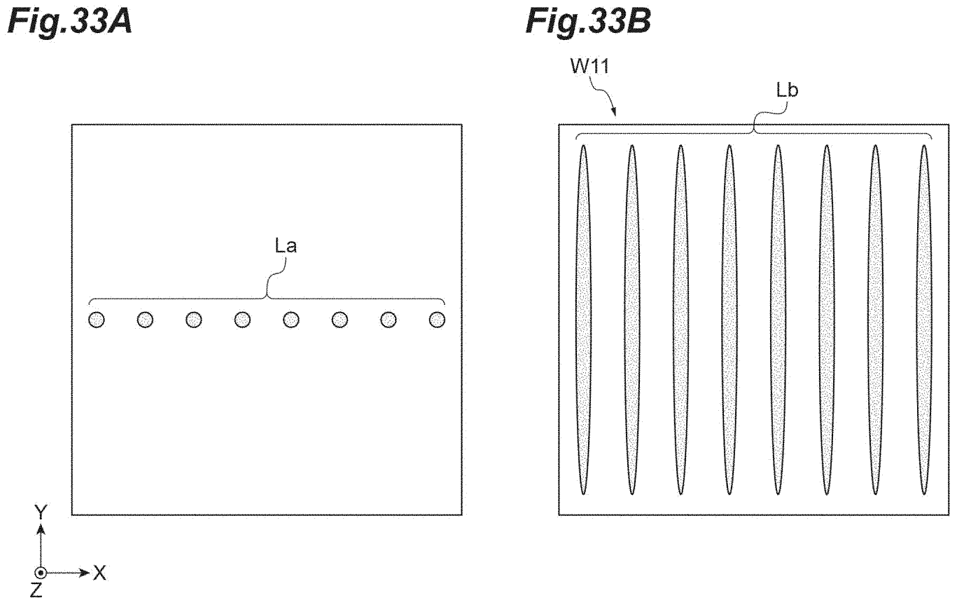

In the examples of FIGS. 32 and 33A, laser beams La of a multi-point pattern from the S-iPMSEL 1 are arrayed at predetermined intervals in the X direction. In the example of FIG. 32, the one-dimensional concave lens 52 is disposed so that its concave surface extends in the X-axis direction. The laser beams La of a multi-point pattern passing through the one-dimensional concave lens 52 do not change in the X-axis direction, and extend only in the Y-axis direction. Therefore, by passing the laser beams La of a multi-point pattern through the one-dimensional concave lens 52, a stripe pattern W11 in which linear laser beams Lb extending in the Y direction are lined up in the X-axis direction is obtained as shown in FIG. 33B.

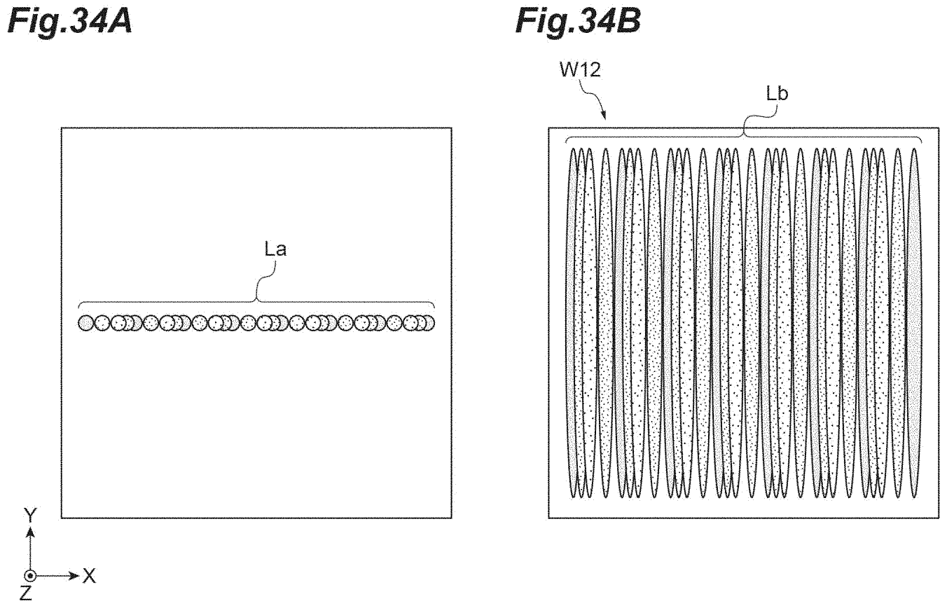

In a case where the stripe pattern is brought closer to a sinusoidal shape, for example, as shown in FIG. 34A, laser beams La of a multi-point pattern are formed, and the luminance of each laser beam is controlled to be sinusoidal in the X-axis direction. By passing such laser beams La of a multi-point pattern through the one-dimensional concave lens 52, in a stripe pattern W12 shown in FIG. 34B, the linear laser beams Lb extending in the Y direction are lined up in the X-axis direction, and the luminance of each of the laser beams Lb changes in a sinusoidal manner in the X-axis direction.

In FIGS. 33A and 34A, the laser beams La of a multi-point pattern are linearly lined up in the X-axis direction, but the laser beams La may not necessarily be linearly lined up, and may be shifted periodically or randomly in the Y-axis direction. The one-dimensional lens 51 is not limited to the one-dimensional concave lens 52 insofar as the laser beams La of a multi-point pattern can be extended in a one-dimensional direction, and may be a Powell lens or a Lineman lens that functions as a line generator. The one-dimensional lens 51 may be a flat lens such as, for example, a Fresnel lens, a microlens, or a meta-lens.

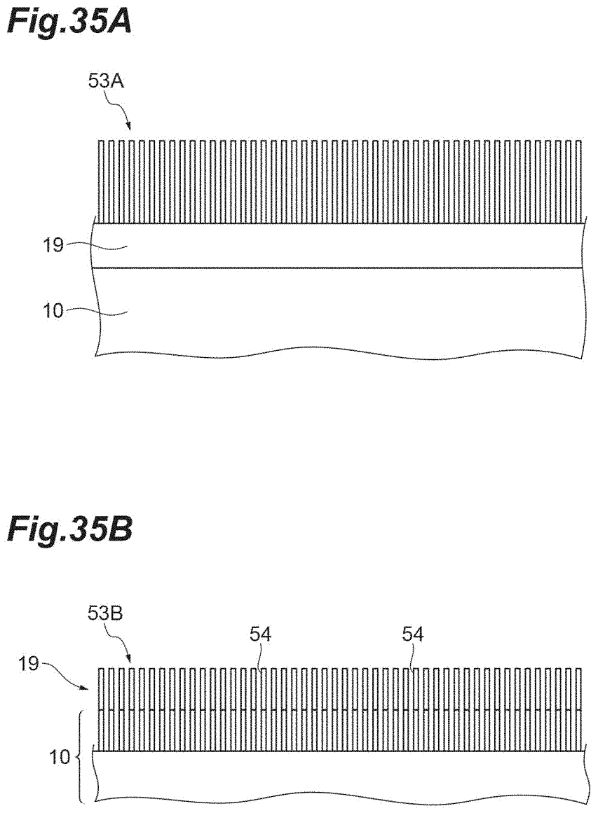

In a case where a meta-lens is used, a resonant-type meta-lens structure 53A, for example, as shown in FIG. 35A may be adopted, or a refractive index modulation-type meta-lens structure 53B, for example, as shown in FIG. 35B may be adopted. As shown in FIG. 35A, in a case where the resonant-type meta-lens structure 53A is adopted, the configuration material of the meta-lens structure 53A is a material having a higher refractive index than an underlying layer. For example, in a case where the underlying layer (for example, the antireflection film 19) is SiN, amorphous silicon can be used as the configuration material of the meta-lens structure 53A. The height and diameter of a unit lattice constituting the meta-lens structure 53A is set on the basis of the lens phase obtained in Expression (40) above.

As shown in FIG. 35B, in a case where the refractive index modulation-type meta-lens structure 53B is adopted, the meta-lens structure 53B can be formed by etching the surface of the S-iPMSEL 1. For example, the refractive index modulation-type meta-lens structure 53B can be formed on the surface of the S-iPMSEL 1 by forming hole portions 54 extending from the outermost layer (for example, the antireflection film 19) to the middle of the lower layer (for example, the semiconductor substrate 10) through etching. The depth and diameter of each of the hole portions 54 constituting the meta-lens structure 53B is set on the basis of the lens phase obtained in Expression (40) above.

### Fourth Embodiment

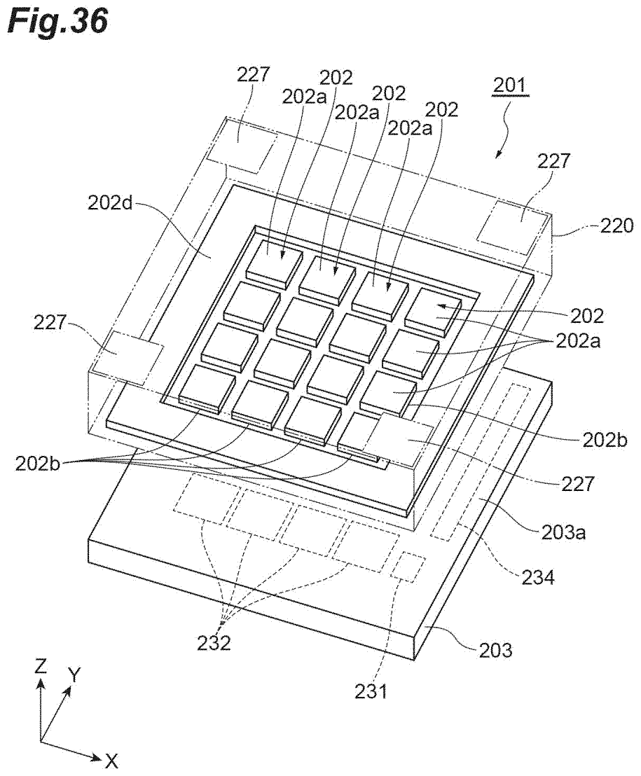

FIG. 36 is a configuration diagram of a light source device 201 according to a fourth embodiment. The three-dimensional measurement device 101B shown in FIG. 21 may include the light source device 201 of the present embodiment instead of a light source device 150. As shown in FIG. 36, the light source device 201 includes a plurality of S-iPMSELs 202 and a driving circuit 203. Each of the plurality of S-iPMSELs 202 has a first surface 202a and a second surface 202b opposite to (facing) the first surface 202a. The driving circuit 203 has a surface 203a facing the second surface 202b. In addition, the driving circuit 203 includes a current source circuit 231, a plurality of current mirror circuits 232, and a switch operation unit 234. Each of the plurality of current mirror circuits 232 is electrically connected to one of the plurality of S-iPMSELs 202. The switch operation unit 234 is electrically connected to the plurality of S-iPMSELs 202. For example, electrical contacts corresponding to the plurality of current mirror circuits 232 and the switch operation unit 234 are formed on the surface 203a, and the plurality of current mirror circuits 232 and the switch operation unit 234 are connected to the plurality of S-iPMSELs 202 by bump bonding through the electrical contacts. The light source device 201 further includes a semiconductor region 202d and a semiconductor substrate 220. The semiconductor region 202d surrounds the plurality of S-iPMSELs 202 in an annular shape. The plurality of S-iPMSELs 202 are formed on the semiconductor substrate 220, and the semiconductor substrate 220 is made of a semiconductor such as, for example, GaAs. The planar shape of the semiconductor substrate 220 is square or rectangular, and a first electrode 227 that makes ohmic contact with the rear surface of the semiconductor substrate 220 and defines a reference potential is formed at each of four corners on the rear surface of the semiconductor substrate 220. In this manner, the plurality of S-iPMSELs 202 are formed on the common semiconductor substrate 220. In other words, the plurality of S-iPMSELs 202 are monolithically formed. Adjacent S-iPMSELs 202 are formed at regular intervals. Each of the plurality of S-iPMSELs 202 outputs a laser beam including a desired light image from the first surface 202a. The driving circuit 203 supplies a driving current for causing each of the plurality of S-iPMSELs 202 to emit light. The semiconductor region 202d distributes a load applied to each S-iPMSEL 202 when the S-iPMSEL 202 is mounted on the driving circuit 203 to improve flatness. In the following description, the direction perpendicular to the first surface 202a is defined as a Z-axis direction, one direction parallel to the first surface 202a is defined as an X-axis direction, and the direction perpendicular to both the Z-axis direction and the X-axis direction is defined as a Y-axis direction.

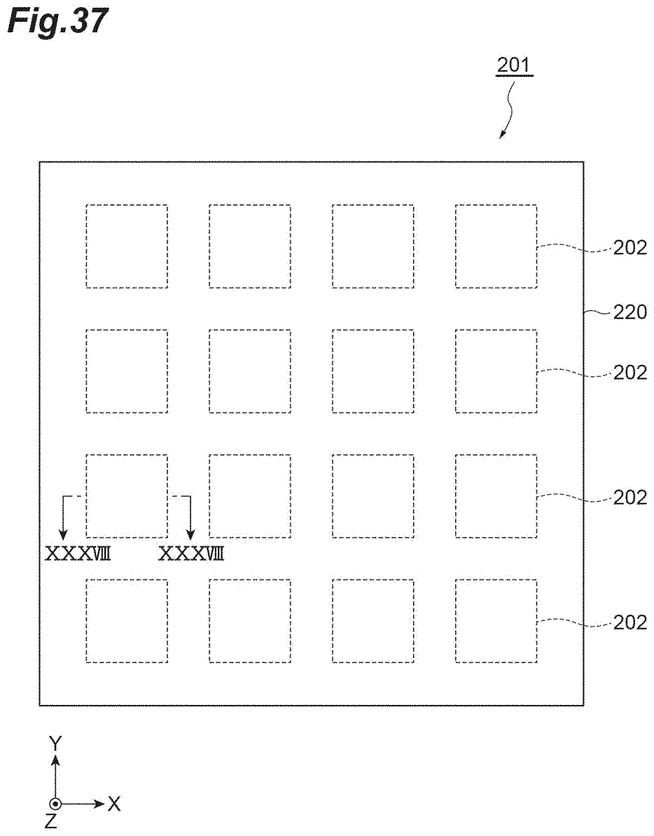

FIG. 37 is a plan view of the light source device 201 shown in FIG. 36. In FIG. 37, the semiconductor region 202d is not shown. The plurality of S-iPMSELs 202 are arranged in a two-dimensional matrix with the X-axis direction and the Y-axis direction as a row direction and a column direction, respectively. In the present embodiment, a total of sixteen S-iPMSELs 202, four in the X-axis direction (row direction) and four in the Y-axis direction (column direction), are arranged.

### [Configuration of S-iPMSEL]

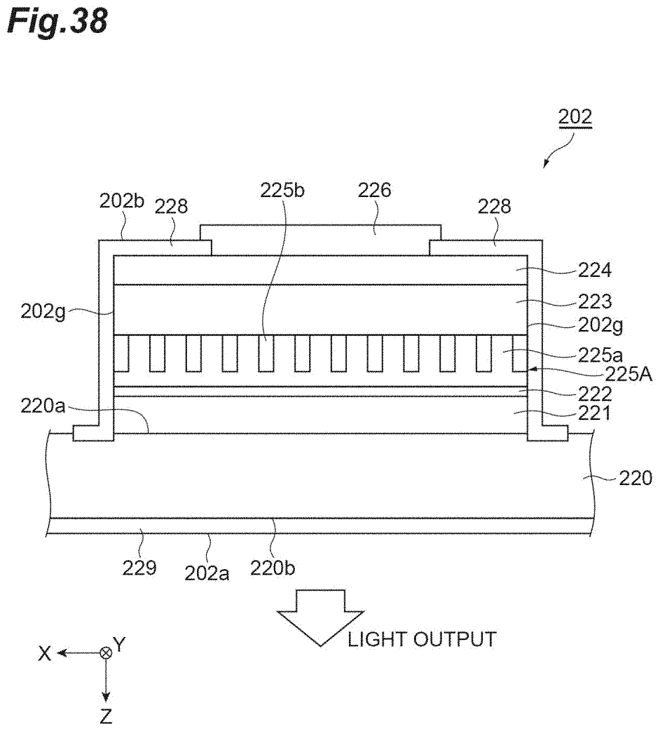

FIG. 38 is a schematic diagram illustrating a cross section of each S-iPMSEL 202 along line XXXVIII-XXXVIII shown in FIG. 37. Each S-iPMSEL 202 forms a standing wave in an in-plane direction parallel to a virtual plane formed in the X-axis direction and the Y-axis direction, and outputs a phase-controlled plane wave in the Z-axis direction. Light that forms a light image having an arbitrary two-dimensional shape is output in the normal direction of a main surface 220a of the semiconductor substrate 220 (that is, the Z-axis direction), an inclined direction intersecting the normal direction, or both the normal direction and the inclined direction.

Each S-iPMSEL 202 has the same cross-sectional structure as the S-iPMSEL 1 described above. Specifically, each S-iPMSEL 202 includes an active layer 222 serving as a light-emitting unit provided on the semiconductor substrate 220, a phase modulation layer 225A which is optically coupled to the active layer 222, a first cladding layer 221 located on the first surface 202a side with respect to the active layer 222 and the phase modulation layer 225A, a second cladding layer 223 located on the second surface 202b side with respect to the active layer 222 and the phase modulation layer 225A, and a contact layer 224 provided on the second cladding layer 223. The semiconductor substrate 220, the first cladding layer 221, the active layer 222, the second cladding layer 223, and the contact layer 224 are constituted of a compound semiconductor such as, for example, a GaAs-based semiconductor, an InP-based semiconductor, or a nitride-based semiconductor. Each energy bandgap of the first cladding layer 221 and the second cladding layer 223 is larger than the energy bandgap of the active layer 222. The thickness direction of the semiconductor substrate 220, the first cladding layer 221, the active layer 222, the second cladding layer 223, and the contact layer 224 coincides with the Z-axis direction.

In the present embodiment, the phase modulation layer 225A is provided between the active layer 222 and the second cladding layer 223. The phase modulation layer 225A may be provided between the first cladding layer 221 and the active layer 222. A light guide layer may be provided as necessary in at least one location between the active layer 222 and the second cladding layer 223 or between the active layer 222 and the first cladding layer 221. The thickness direction of the phase modulation layer 225A coincides with the Z-axis direction. Meanwhile, the light guide layer may include a carrier barrier layer for efficiently confining carriers in the active layer 222.

A separation region 202g is formed between adjacent S-iPMSELs 202. The separation region 202g is a slit (void) formed by either dry etching or wet etching, and an insulating film 228 such as SiN is formed on the sidewall of the slit to achieve insulation, which leads to suppression of current leakage due to solder during assembly. Meanwhile, the separation region 202g can also be formed by achieving insulation using any of a semiconductor layer modified by high-intensity light (electric field), impurity diffusion, and an ion implantation method.

The phase modulation layer 225A includes a fundamental layer 225a and a plurality of different refractive index regions 225b. The configuration of the phase modulation layer 225A is the same as that of the phase modulation layer 15 described above. The configuration of the fundamental layer 225a is the same as that of the fundamental layer 15a described above, and the configuration of the plurality of different refractive index regions 225b is the same as that of the plurality of different refractive index regions 15b described above. The laser beam incident on the phase modulation layer 225A forms a predetermined mode corresponding to the arrangement of the different refractive index regions 225b in the phase modulation layer 225A, and is emitted from the first surface 202a to the outside as a laser beam having a desired pattern.

Each S-iPMSEL 202 further includes a second electrode 226 provided on the contact layer 224 and the first electrode 227 (see FIG. 36) provided on a rear surface 220b of the semiconductor substrate 220. The second electrode 226 is located on the second surface 202b side with respect to the second cladding layer 223 and makes ohmic contact with the contact layer 224. The first electrode 227 is located on the first surface 202a side with respect to the first cladding layer 221 and makes ohmic contact with the semiconductor substrate 220. The second electrode 226 is provided in the central region of the contact layer 224. A portion of the contact layer 224 other than the second electrode 226 is covered with the insulating film 228. Meanwhile, the contact layer 224 which is not in contact with the second electrode 226 may be removed. A portion of the rear surface 220b of the semiconductor substrate 220 other than the first electrode 227 is covered with an antireflection film 229.

When a driving current is supplied between the second electrode 226 and the first electrode 227, the recombination of electrons and holes occurs within the active layer 222, and light is emitted into the active layer 222. The electrons and holes that contribute to light emission within the active layer 222 and the generated light are efficiently trapped between the first cladding layer 221 and the second cladding layer 223.

The light output from the active layer 222 enters the phase modulation layer 225A, and forms a predetermined mode corresponding to a lattice structure inside the phase modulation layer 225A. The laser beam output from the phase modulation layer 225A is directly output from the rear surface 220b to the outside of each S-iPMSEL 202, or is reflected at the second electrode 226 and then output from the rear surface 220b to the outside of each S-iPMSEL 202. In this case, signal light included in the laser beam is output in the normal direction of the main surface 220a, the inclined direction intersecting the normal direction, or both directions. It is the signal light that forms a desired light image in the output light. The signal light is mainly 1-order light and −1-order light.

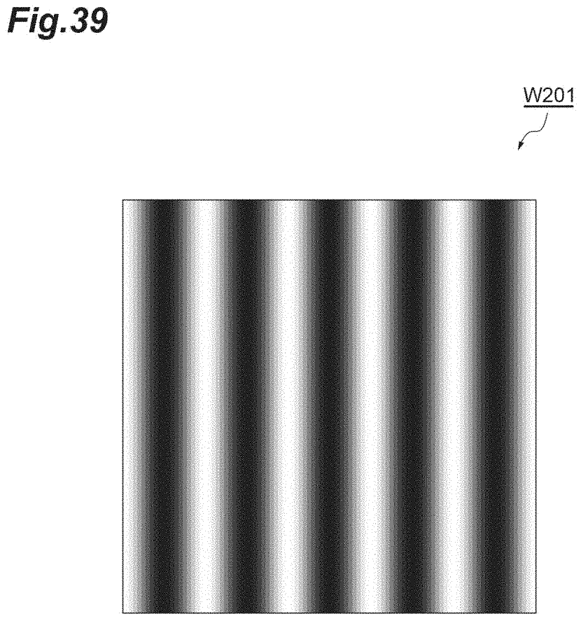

The measurement light 105 forms, for example, a sinusoidal stripe pattern W201 as shown in FIG. 39. In FIG. 39, the light intensity in the stripe pattern W201 is represented by color gradation, with darker (closer to black) portions having higher light intensity and lighter (closer to white) portions having lower light intensity. The stripe pattern W201 is, for example, a periodic stripe pattern indicated by an image region of 100×100 pixels. The period of the stripe pattern W201 is, for example, a period of 20 pixels. The brightness of the stripe pattern W201 changes depending on the intensity of the measurement light 105. The bright portions (black portions) of the stripe pattern W201 are portions where the intensity of the measurement light 105 is high, and the dark portions (white portions) of the stripe pattern W201 are portions where the intensity of the measurement light 105 is low.

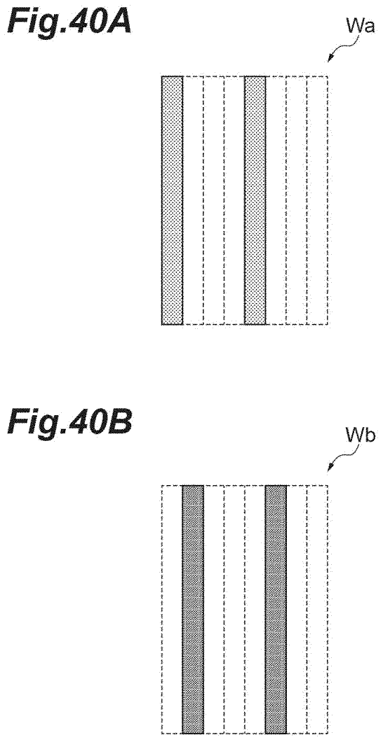

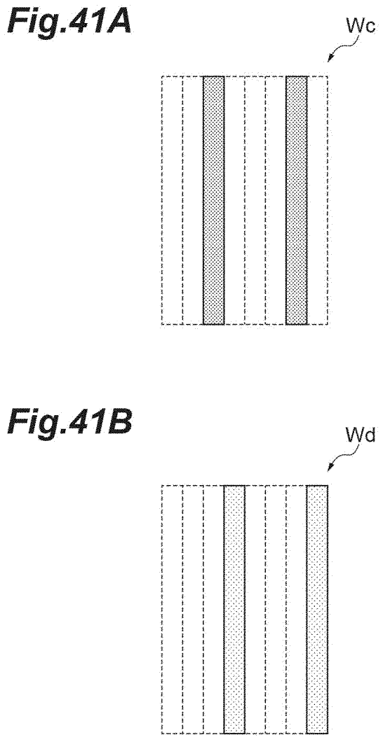

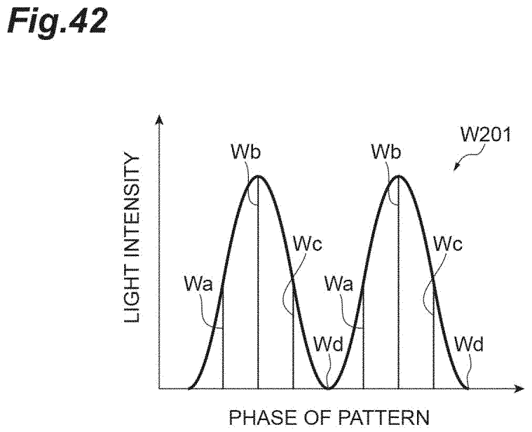

The stripe pattern W201 is formed by mutually synthesizing a plurality of stripe elements formed by light output by the plurality of S-iPMSELs 202. Here, for the purpose of simplifying the description, a case where the stripe pattern W201 having a period of 4 pixels is formed using four S-iPMSELs 202 will be described as an example. FIG. 40A is a diagram illustrating a first stripe element Wa which is formed by light output by a certain S-iPMSEL 202 (hereinafter referred to as a first S-iPMSEL). FIG. 40A shows only a pattern output by the first S-iPMSEL. A portion where the pattern is formed is indicated by halftone dots, and the light intensity increases as the density of the halftone dots becomes higher. FIG. 40B is a diagram illustrating a second stripe element Wb which is formed by light output by another S-iPMSEL 202 (hereinafter referred to as a second S-iPMSEL). FIG. 40B shows only a pattern output by the second S-iPMSEL. FIG. 41A is a diagram illustrating a third stripe element We which is formed by light output by still another S-iPMSEL 202 (hereinafter referred to as a third S-iPMSEL). FIG. 41A shows only a pattern output by the third S-iPMSEL. FIG. 41B is a diagram illustrating a fourth stripe element Wd which is formed by light output by still another S-iPMSEL 202 (hereinafter referred to as a fourth S-iPMSEL). FIG. 41B shows only a pattern output by the fourth S-iPMSEL. The light output by these S-iPMSELs 202 is included in the measurement light 105. Comparing FIG. 40B with FIG. 40A, the phase of the second stripe element Wb is shifted from the phase of the first stripe element Wa by π/2 (rad), that is, ¼ period. Additionally, in this example, the light intensity of the second stripe element Wb is higher than the light intensity of the first stripe element Wa. Comparing FIG. 41A with FIG. 40B, the phase of the third stripe element We is shifted from the phase of the second stripe element Wb by π/2 (rad), that is, ¼ period. Additionally, in this example, the light intensity of the third stripe element We is lower than the light intensity of the second stripe element Wb. Comparing FIG. 41B with FIG. 41A, the phase of the fourth stripe element Wd is shifted from the phase of the third stripe element We by π/2, that is, ¼ period. Additionally, in this example, the light intensity of the fourth stripe element Wd is lower than the light intensity of the third stripe element Wc. FIG. 42 is a graph illustrating the light intensity distribution of the stripe pattern W201 generated by synthesizing the first stripe element Wa to the fourth stripe element Wd. In FIG. 42, the horizontal axis represents the position in a direction intersecting the stripe (periodic direction of a sinusoidal wave), in other words, the phase of the stripe pattern W201, and the vertical axis represents the light intensity. As shown in FIG. 42, in the stripe pattern W201, the light intensities of the first stripe element Wa to the fourth stripe element Wd are appropriately adjusted, and thus a pattern having a sinusoidal light intensity distribution is realized. As the number of S-iPMSELs 202 becomes greater, that is, the number of stripe elements becomes greater, the graph becomes closer to an exact sinusoidal wave. FIG. 42 shows a sinusoidal wave for two waves included in the stripe pattern W201.

When the stripe pattern W201 having a period of 4 pixels is generated, within the exposure period of one frame of the image capture unit 103, the first S-iPMSEL, the second S-iPMSEL, the third S-iPMSEL, and the fourth S-iPMSEL are supplied with a driving current in this order. Thereby, the first stripe element Wa, the second stripe element Wb, the third stripe element Wc, and the fourth stripe element Wd which are output from the first S-iPMSEL, the second S-iPMSEL, the third S-iPMSEL, and the fourth S-iPMSEL, respectively, are synthesized in one frame of image capture in the image capture unit 103 and recognized as the stripe pattern W201 in the image capture unit 103.

The measurement unit 104 measures the three-dimensional shape of the object to be measured SA based on the phase shift method using the stripe pattern W201. In such a form, for example, a plurality of the sinusoidal stripe pattern W201 to which a phase shift (positional shift) obtained by equally dividing one period with respect to a lattice pitch are used. As for the pattern of a phase shift, a pattern of which the phase is shifted by 2π/N needs to be prepared. Here, N is the phase shift number of the stripe pattern W201.

Here, a case where four sinusoidal stripe patterns W201 having different phase shifts are used will be illustrated. In a case where the light intensities of four beams of measurement light 105 each having four sinusoidal stripe patterns W201 are set to 10 to 13, respectively, and the pixels of the image capture unit 103 are set to (x, y), the light intensities 10 to 13 on the surface of the object to be measured SA are represented by Expressions (30) to (33) described above. The initial phase θ can be obtained by tan θ=−(I3−I1)/(I2−I0). The initial phase θ can be obtained by Expression (34) described above.

In a case where such a phase shift method is used, the measured phase is converted into height, so that it is possible to measure the height of the object to be measured SA at an interval smaller than the pitch of the sinusoidal stripe pattern W201. In the configuration of the three-dimensional measurement device 101B, the plurality of S-iPMSELs 202 may be arrayed in a direction parallel to the stripe in the sinusoidal stripe pattern W201. In this case, it is possible to eliminate a phase shift caused by the positional shift of the plurality of S-iPMSELs 202, and to eliminate a shift of the initial phase in each of the plurality of the sinusoidal stripe pattern W201.

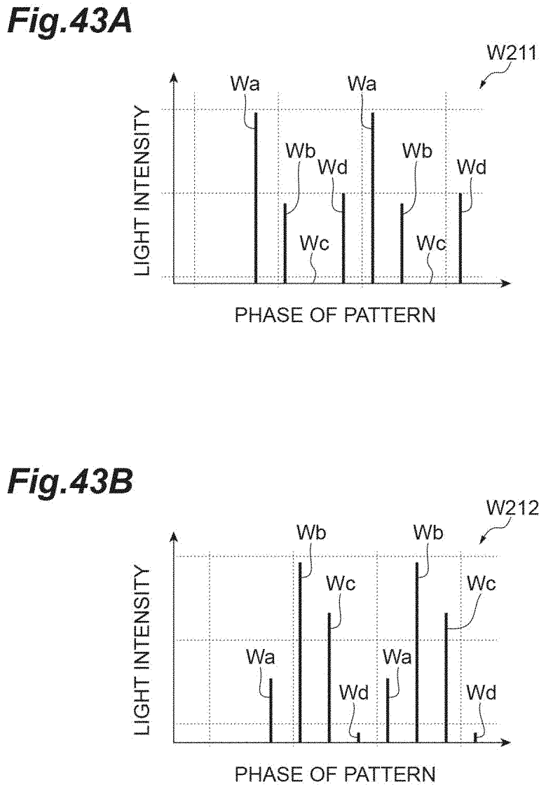

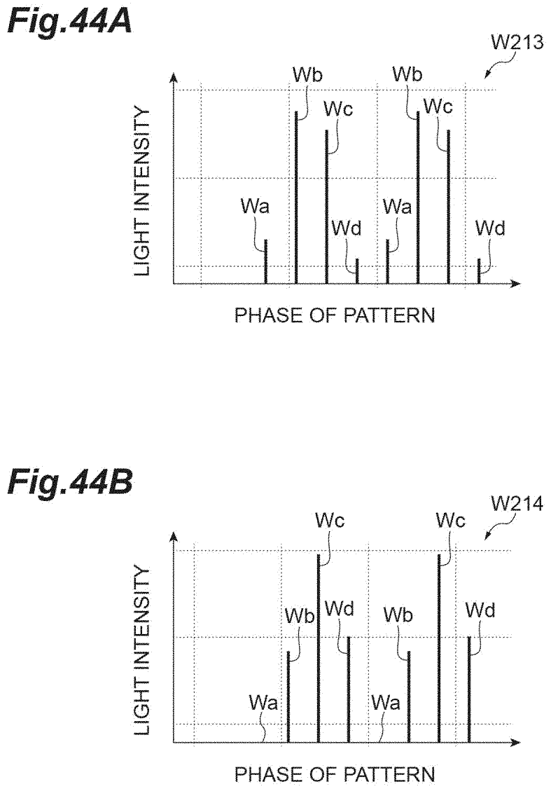

Here, a case where four sinusoidal stripe patterns having phases different from each other are used will be described. FIG. 43A is a diagram illustrating a first stripe pattern W211, FIG. 43B is a diagram illustrating a second stripe pattern W212, FIG. 44A is a diagram illustrating a third stripe pattern W213, and FIG. 44B is a diagram illustrating a fourth stripe pattern W214. As shown in FIG. 43A, the first stripe pattern W211 is a sinusoidal stripe pattern in which the light intensity of the first stripe element Wa is highest and the light intensity of the third stripe element Wc is lowest. Subsequently, as shown in FIG. 43B, the second stripe pattern W212 is a sinusoidal stripe pattern in which the light intensity of the second stripe element Wb is highest and the light intensity of the fourth stripe element Wd is lowest. That is, from the first stripe pattern W211 to the second stripe pattern W212, a phase shift occurs in which the peak of the light intensity moves in the direction of phase advance. Subsequently, as shown in FIG. 44A, in the third stripe pattern W213, the light intensity of the third stripe element Wc is approximately equal to the light intensity of the second stripe element Wb. Additionally, the light intensity of the fourth stripe element Wd in the third stripe pattern W213 is higher than the light intensity of the fourth stripe element Wd in the second stripe pattern W212. That is, from the second stripe pattern W212 to the third stripe pattern W213, a phase shift occurs. Subsequently, as shown in FIG. 44B, the fourth stripe pattern W214 is a sinusoidal stripe pattern in which the light intensity of the third stripe element We is highest and the light intensity of the first stripe element Wa is lowest. That is, from the third stripe pattern W213 to the fourth stripe pattern W214, a phase shift occurs. As described above, the phase continuously shifted from the first stripe pattern W211 to the fourth stripe pattern W214. This makes it possible to measure the three-dimensional shape of the object to be measured SA. Although four sinusoidal stripe patterns are shown here as an example of the phase shift, the phase shift may be equally spaced in the case of measurement using the phase shift method.

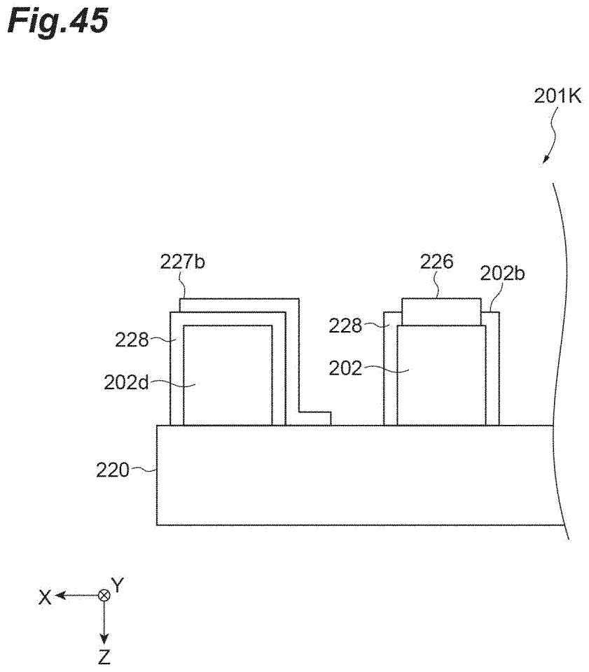

FIG. 45 is a partial cross-sectional view of a light source device 201K according to a modification example. In the light source device 201K, the semiconductor region 202d and the plurality of S-iPMSELs 202 are formed on the semiconductor substrate 220. The periphery of the semiconductor region 202d and the periphery of each S-iPMSEL 202 are covered with the insulating film 228. A wiring electrode 227b is formed from the upper surface of the semiconductor region 202d to the lateral side of the semiconductor region 202d with the insulating film 228 interposed therebetween. The wiring electrode 227b is further in contact with the surface of the semiconductor substrate 220 continuously from the lateral side of the semiconductor region 202d. The second electrode 226 is formed on the second surface 202b side of each S-iPMSEL 202. The height of the wiring electrode 227b formed on the upper surface of the semiconductor region 202d in the Z-axis direction and the height of the second electrode 226 in the Z-axis direction coincide with each other. Thereby, both the N electrode (the wiring electrode 227b) and the P electrode (the second electrode 226) can be disposed on the same surface, which makes the configuration appropriate for surface mounting. Further, the use of the wiring electrode 227b eliminates the need for wire bonding which is required when the first electrode 227 is used.

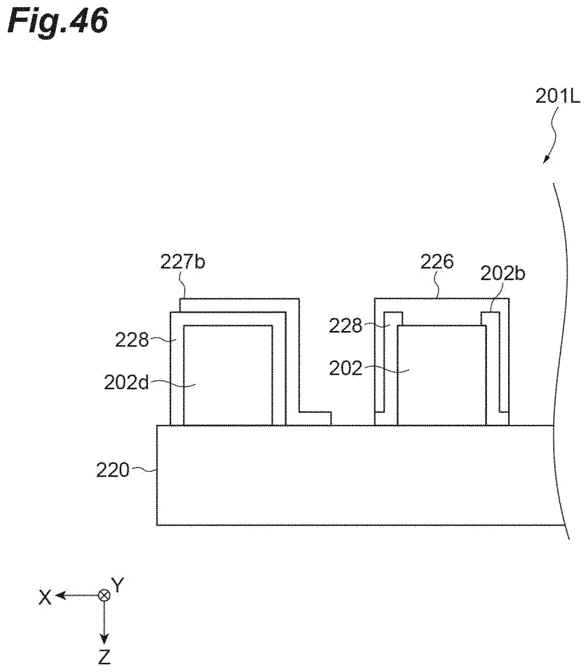

FIG. 46 is a partial cross-sectional view of a light source device 201L according to another modification example. Only differences from the light source device 201K will be described below. The lateral side of each S-iPMSEL 202 is covered with the second electrode 226 with the insulating film 228 interposed therebetween. The second electrode 226 is formed on the second surface 202b side of each S-iPMSEL 202. That is, each S-iPMSEL 202 is shielded by the second electrode 226 over its entire circumference. Thereby, the laser beam generated in each S-iPMSEL 202 interferes with each adjacent S-iPMSEL 202, and thus it is possible to prevent the laser mode from being disturbed and to realize stable laser oscillation. In a case where the interference of the laser beam is actively used, the outer circumference of the S-iPMSEL 202 does not need to be shielded by electrodes as in the light source device 201K.

### Fifth Embodiment

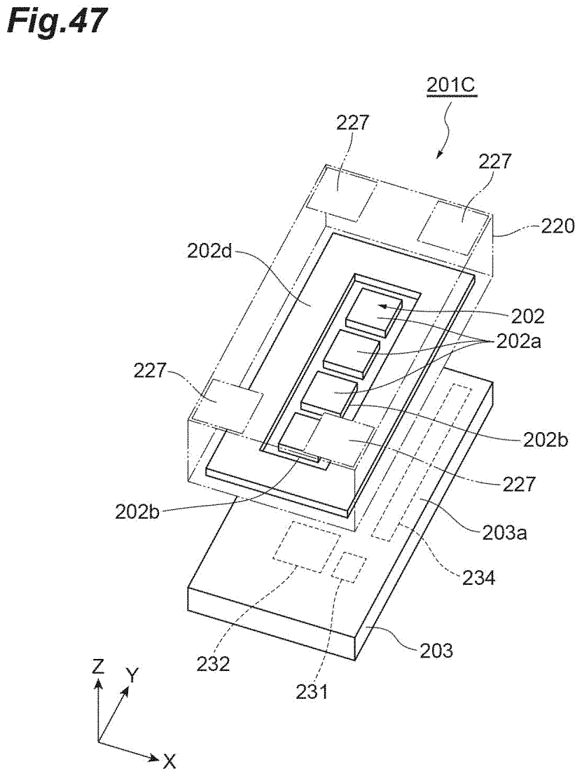

FIG. 47 is an exploded perspective view illustrating a configuration of a light source device 201C according to a fifth embodiment of the present disclosure. The three-dimensional measurement device 101B shown in FIG. 21 may include the light source device 201C of the present embodiment instead of the light source device 150. That is, the light source device 201C of the present embodiment is used for three-dimensional shape measurement using the phase shift method. As shown in FIG. 47, the light source device 201C includes the plurality of S-iPMSELs 202 (first light source units), the driving circuit 203, the semiconductor substrate 220, the semiconductor region 202d, and the first electrode 227. In the present embodiment, the plurality of S-iPMSELs 202 are arranged one dimensionally in a row with the Y-axis direction as a column direction. In the shown example, four S-iPMSELs are arranged side by side in the Y-axis direction. In addition, similarly to the above embodiment, the plurality of S-iPMSELs 202 are monolithically formed on the semiconductor substrate 220. The plurality of S-iPMSELs 202 are arranged side by side in a direction intersecting each optical axis direction so that the optical axis directions, in other words, the thickness directions of the S-iPMSELs 202 are aligned. In the present embodiment, the optical axis direction of each S-iPMSEL 202 coincides with the Z-axis direction, and the plurality of S-iPMSELs 202 are arranged side by side in the Y-axis direction orthogonal to the Z-axis direction. The configurations of the plurality of other S-iPMSELs 202 and the configurations of the driving circuit 203, the semiconductor substrate 220, the semiconductor region 202d, and the first electrode 227 are the same as that of the light source device 201 of the above-described embodiment, and thus the detailed description thereof will be omitted.

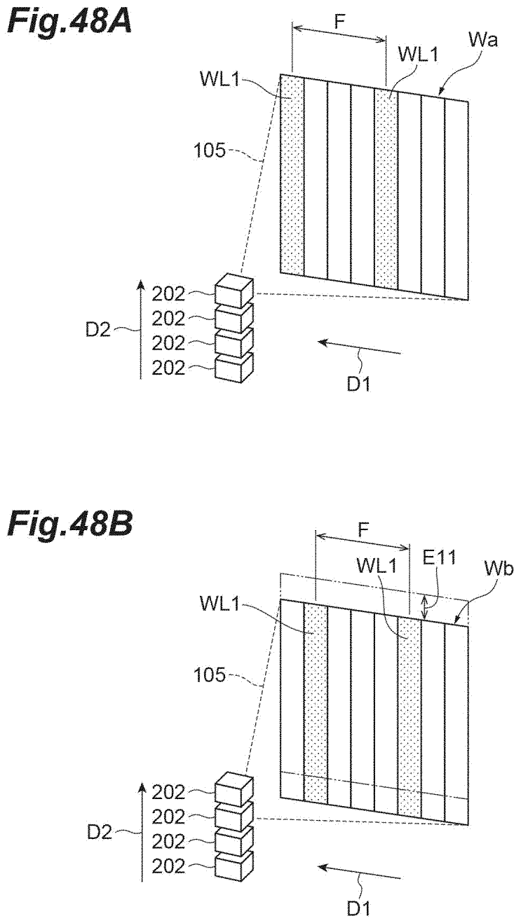

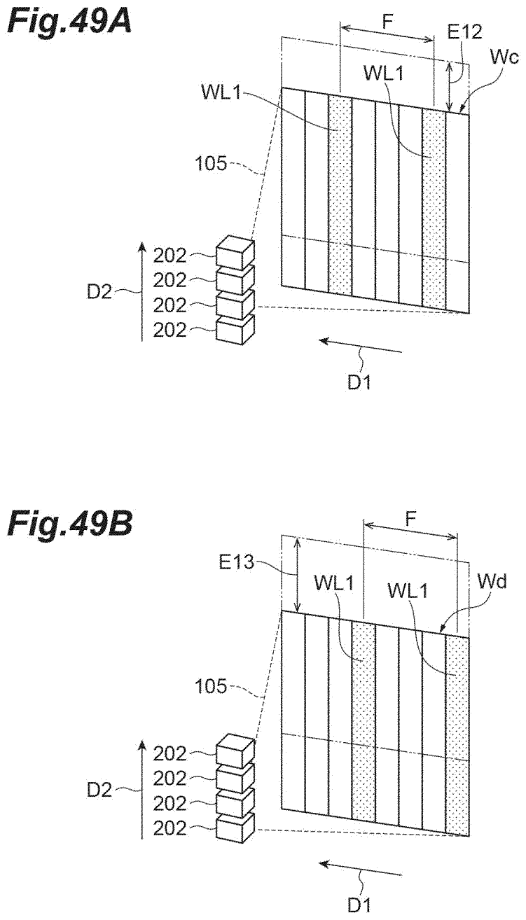

FIGS. 48A, 48B, 49A, and 49B are diagrams schematically illustrating states in which the measurement light 105 including each of stripe elements Wa to Wd is projected onto a common projection region from each of four S-iPMSELs 202. The stripe elements Wa to Wd are first patterns in the present embodiment. Each of the stripe elements Wa to Wd, a plurality of bright lines (indicated by halftone dots in the drawing) WL1 are periodically lined up in a direction D1 (first direction) intersecting the extending direction of the bright lines WL1. Intervals F between the plurality of bright lines WL1 of the stripe elements Wa to Wd are equal to each other in the stripe elements Wa to Wd (in other words, between the plurality of S-iPMSELs 202). In addition, the positions of the plurality of bright lines WL1 in the direction D1 with the position of the optical axis of each S-iPMSEL 202 as a reference are different from each other among the plurality of S-iPMSELs 202. In the examples shown in FIGS. 48A, 48B, 49A, and 49B, the bright lines WL1 of the stripe elements Wa to Wd are shifted from each other by π/2 (rad), that is, ¼ period. In a case where the number of S-iPMSELs 202 is n, the shift amount of the bright lines WL1 among the plurality of S-iPMSELs 202 is 1/n of the interval(period) between the bright lines WL1. The plurality of S-iPMSELs 202 are lined up in a direction D2 (second direction) orthogonal to the direction D1. That is, the direction D2 coincides with the Y-axis direction shown in FIG. 47.

As shown in FIG. 48A, the measurement light 105 is first projected from the S-iPMSEL 202 (the first S-iPMSEL) located at one end in the direction D2. Thereby, the stripe element Wa is projected onto the common projection region. Next, as shown in FIG. 48B, the measurement light 105 is projected from the S-iPMSEL 202 (the second S-iPMSEL) located next to the first S-iPMSEL in the direction D2. Thereby, the stripe element Wb is projected onto the common projection region. In this case, a positional shift E11 in the direction D2 occurs between the stripe elements Wa and Wb which are output from these S-iPMSELs 202 in accordance with the array pitch (optical axis interval) between the first S-iPMSEL and the second S-iPMSEL. The magnitude of the positional shift E11 is equal to the optical axis interval between the first S-iPMSEL and the second S-iPMSEL. On the other hand, the position of the bright line WL1 of the stripe element Wb in the direction D1 is a predetermined position, that is, a position shifted by ¼ period from the bright line WL1 of the stripe element Wa, and no positional shift from the predetermined position occurs. Subsequently, as shown in FIG. 49A, the measurement light 105 is projected from the S-iPMSEL 202 (the third S-iPMSEL) located next to the second S-iPMSEL in the direction D2. Thereby, the stripe element Wc is projected onto the common projection region. In this case, a positional shift E12 in the direction D2 occurs between the stripe elements Wa and We in accordance with the array pitch (optical axis interval) between the first S-iPMSEL to the third S-iPMSEL. The magnitude of the positional shift E12 is equal to the sum of the optical axis intervals of the first S-iPMSEL to the third S-iPMSEL. On the other hand, the position of the bright line WL1 of the stripe element We in the direction D1 is a predetermined position, that is, a position shifted by ½ period from the bright line WL1 of the stripe element Wa, and no positional shift from the predetermined position occurs. Subsequently, as shown in FIG. 49B, the measurement light 105 is projected from the S-iPMSEL 202 (the fourth S-iPMSEL) located next to the third S-iPMSEL in the direction D2. Thereby, the stripe element Wd is projected onto the common projection region. In this case, a positional shift E13 in the direction D2 occurs between the stripe elements Wa and Wd in accordance with the array pitch (optical axis interval) between the first S-iPMSEL to the fourth S-iPMSEL. The magnitude of the positional shift E13 is equal to the sum of the optical axis intervals of the first S-iPMSEL to the fourth S-iPMSEL. On the other hand, the position of the bright line WL1 of the stripe element Wd in the direction D1 is a predetermined position, that is, a position shifted by ¾ period from the bright line WL1 of the stripe element Wa, no positional shift from the predetermined position occurs.

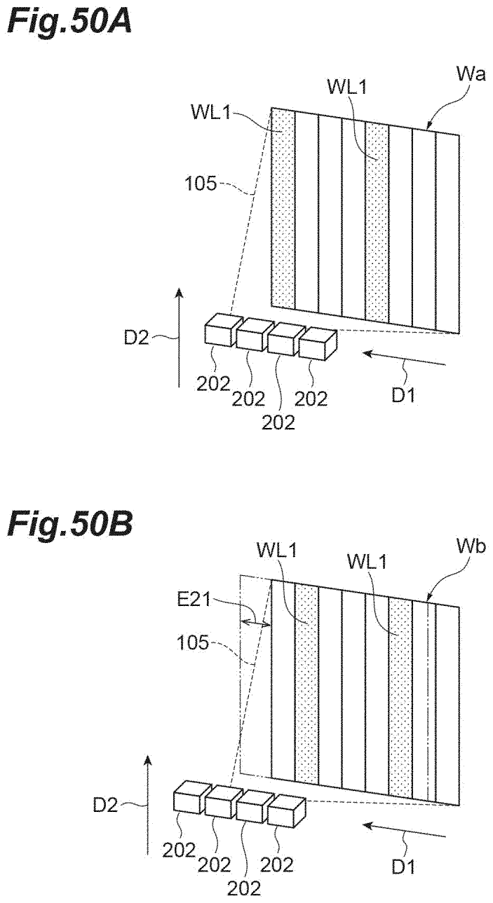

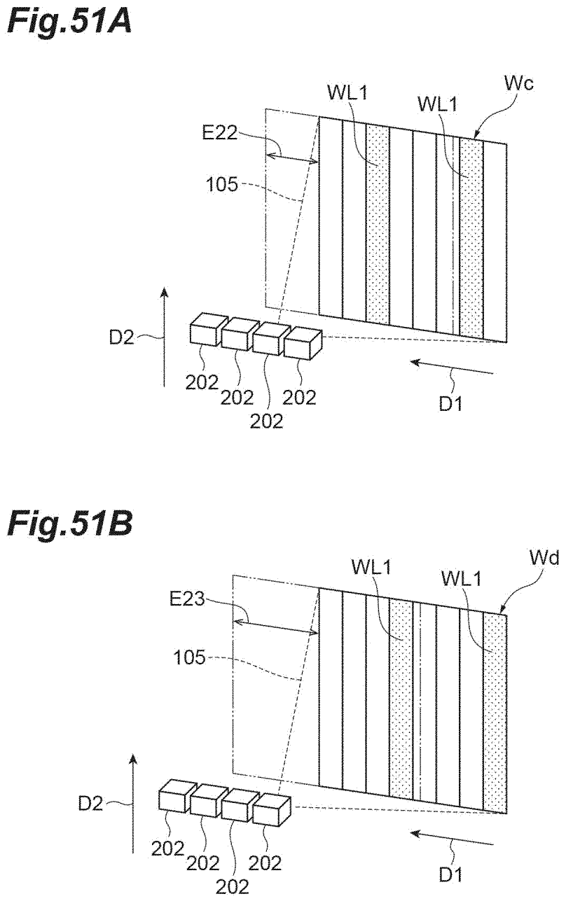

Here, as a comparative example of the present embodiment, a case where the plurality of S-iPMSELs 202 are lined up in the direction D1 will be described. FIGS. 50A, 50B, 51A, and 51B are diagrams schematically illustrating states in which the measurement light 105 including each of the stripe elements Wa to Wd is projected onto the common projection region from each of the four S-iPMSELs 202 in such a comparative example. As shown in FIG. 50A, the measurement light 105 is first projected from the S-iPMSEL 202 (the first S-iPMSEL) located at one end in the direction D1. Thereby, the stripe element Wa is projected onto the common projection region. Next, as shown in FIG. 50B, the measurement light 105 is projected from the S-iPMSEL 202 (the second S-iPMSEL) located next to the first S-iPMSEL in the direction D1. Thereby, the stripe element Wb is projected onto the common projection region. In this case, a positional shift E21 in the direction D1 occurs between the stripe elements Wa and Wb which are output from these S-iPMSELs 202 in accordance with the array pitch (optical axis interval) between the first S-iPMSEL and the second S-iPMSEL. The magnitude of the positional shift E21 is equal to the optical axis interval between the first S-iPMSEL and the second S-iPMSEL. The positional shift E21 causes a positional shift from a predetermined position of the bright line WL1 of the stripe element Wb in the direction D1, that is, a position shifted by ¼ period from the bright line WL1 of the stripe element Wa, to occur in the bright line WL1 of the stripe element Wb. Subsequently, as shown in FIG. 51A, the measurement light 105 is projected from the S-iPMSEL 202 (the third S-iPMSEL) located next to the second S-iPMSEL in the direction D1. Thereby, the stripe element Wc is projected onto the common projection region. In this case, a positional shift E22 in the direction D1 occurs between the stripe elements Wa and We in accordance with the array pitch (optical axis interval) between the first S-iPMSEL to the third S-iPMSEL. The magnitude of the positional shift E22 is equal to the sum of the optical axis intervals of the first S-iPMSEL to the third S-iPMSEL. The positional shift E22 causes a positional shift from a predetermined position of the bright line WL1 of the stripe element We in the direction D1, that is, a position shifted by ½ period from the bright line WL1 of the stripe element Wa, to occur in the bright line WL1 of the stripe element Wc. Subsequently, as shown in FIG. 51B, the measurement light 105 is projected from the S-iPMSEL 202 (the fourth S-iPMSEL) located next to the third S-iPMSEL in the direction D1. Thereby, the stripe element Wd is projected onto the common projection region. In this case, a positional shift E23 in the direction D1 occurs between the stripe elements Wa and Wd in accordance with the array pitch (optical axis interval) between the first S-iPMSEL to the fourth S-iPMSEL. The magnitude of the positional shift E23 is equal to the sum of the optical axis intervals of the first S-iPMSEL to the fourth S-iPMSEL. The positional shift E23 causes a positional shift from a predetermined position of the bright line WL1 of the stripe element Wd in the direction D1, that is, a position shifted by ¾ period from the bright line WL1 of the stripe element Wa, to occur in the bright line WL1 of the stripe element Wd.

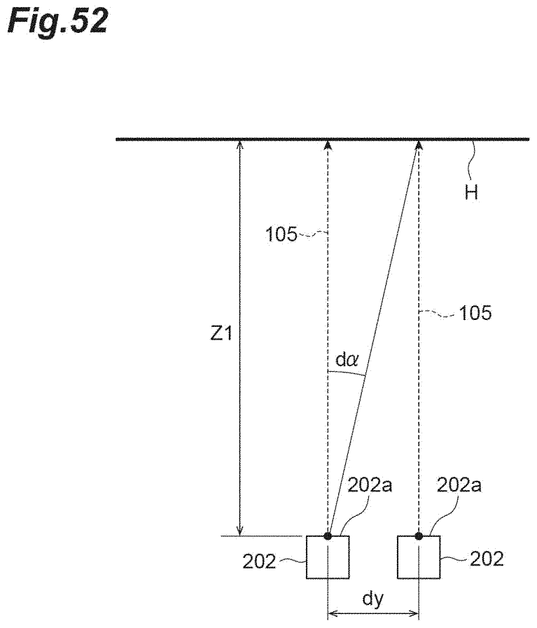

FIG. 52 is a diagram illustrating a problem caused by a positional shift in the bright line WL1 in the above comparative example. FIG. 52 shows two S-iPMSELs 202 adjacent to each other to represent the plurality of S-iPMSELs 202. The drawing shows an array pitch dy between two S-iPMSELs 202 adjacent to each other, a distance Z1 from the first surface 202a of these S-iPMSELs 202 to a projection plane H, and a deviation da of the central angle of the stripe element between the two S-iPMSELs 202 adjacent to each other. The deviation da of the central angle is represented geometrically by the following Expression (41) using the array pitch dy and the distance Z1.

$$d α = {tan}^{- 1} ( \frac{dy}{Z 1} ) \qquad ( 41 )$$

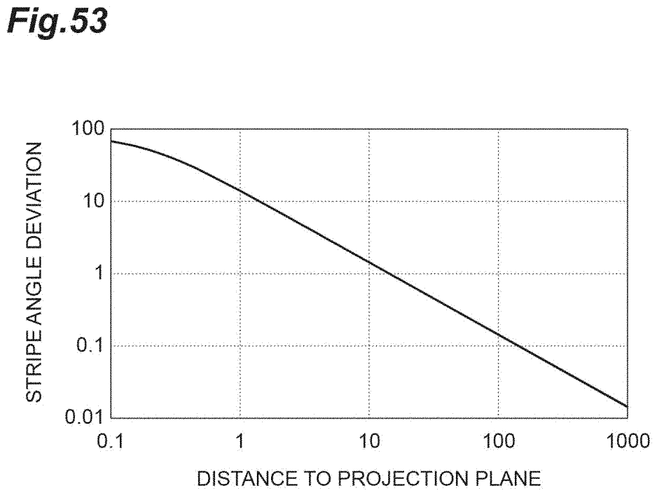

FIG. 53 is a graph illustrating a relationship between the distance Z1 and the deviation da of the central angle when the array pitch dy is set to 0.25 mm in Expression (41). In FIG. 53, the horizontal axis represents the distance Z1 (mm), and the vertical axis represents the deviation da (degrees) of the central angle. In addition, the representative values of the deviation da of the central angle with respect to the distance Z1 are listed below.

Z1=1 mm→dα=14.0°

Z1=5 mm→dα=2.86°

Z1=10 mm→dα=1.43°

Z1=50 mm→dα=0.286°

Z1=100 mm→dα=0.143°

Z1=500 mm→dα=0.0286°

Z1=1 m→dα=0.0143°

As is clear from FIG. 53 and the above list, the deviation da of the central angle increases as the distance Z1 becomes smaller. For example, in a case where the distance Z1 is 50 mm, the deviation da of the central angle is 0.286° near the center of the stripe element (near the optical axis), but in a case where the typical stripe period is 10, the deviation error is 28.6%. This numerical value is equivalent to the amount of one shift of the stripe element, for example, the amount of shift from the position of the stripe element Wa to the position of the stripe element Wb. In this way, as the deviation da of the central angle becomes larger, the error when the stripe pattern W201 is formed increases, and the measurement error in the three-dimensional shape measurement increases. The distance Z1 has to be reduced depending on the application of the light source device 201C such as, for example, the acquisition of a stereoscopic image inside the oral cavity in dentistry, so it is desirable to reduce the above measurement error.

Regarding the above problem, in a case where the plurality of S-iPMSELs 202 are lined up in the direction D2 orthogonal to the direction D1 as in the present embodiment (see FIGS. 48A, 48B, 49A, and 49B), the array direction of the plurality of S-iPMSELs 202 is orthogonal to the line-up direction of the bright lines WL of the stripe elements Wa to Wd. Thus, even when the positional shifts E11 to E13 occur among the plurality of stripe elements Wa to Wd, the positional shifts E11 to E13 do not influence the formation of the stripe pattern W201. Therefore, it is possible to reduce the measurement error in the three-dimensional shape measurement more than in the above comparative example.

In the light source device 201C of the present embodiment, the intervals F between the bright lines WL1 of the stripe elements Wa to Wd are equal to each other among the plurality of S-iPMSELs 202, and the positions of the bright lines WL1 in the direction D1 with the optical axis of each S-iPMSEL 202 as a reference are different from each other among the plurality of S-iPMSELs 202. By projecting each of such stripe elements Wa to Wd onto the common projection region from each of the plurality of S-iPMSELs 202, it is possible to suitably perform the three-dimensional shape measurement using the phase shift method.

As in the present embodiment, the light source device 201C may include the plurality of S-iPMSELs 202 as a plurality of first light source units. In that case, it is possible to reduce the size of the light source that outputs the measurement light 105 including the stripe elements Wa to Wd, and to reduce the size of the light source device 201C. The first light source unit is not limited to the S-iPMSEL 202. The first light source unit may be any other element such as, for example, an element in which a semiconductor laser and a diffraction grating element (DOE) are combined insofar as it can project the measurement light 105 including the stripe elements Wa to Wd in which the plurality of bright lines WL1 are periodically lined up in the direction D1.

As in the present embodiment, the plurality of S-iPMSELs 202 may be monolithically formed with each other. In that case, the plurality of S-iPMSELs 202 can be formed in a single element to facilitate the assembly of the light source device 201C.

As in the present embodiment, the number of S-iPMSELs 202 may be n, and the amount of shift of the bright lines WL1 between the plurality of S-iPMSELs 202 may be 1/n of the interval F between the bright lines WL1. In that case, it is possible to perform three-dimensional shape measurement using the phase shift method by forming the stripe pattern W201 shown in FIG. 39.

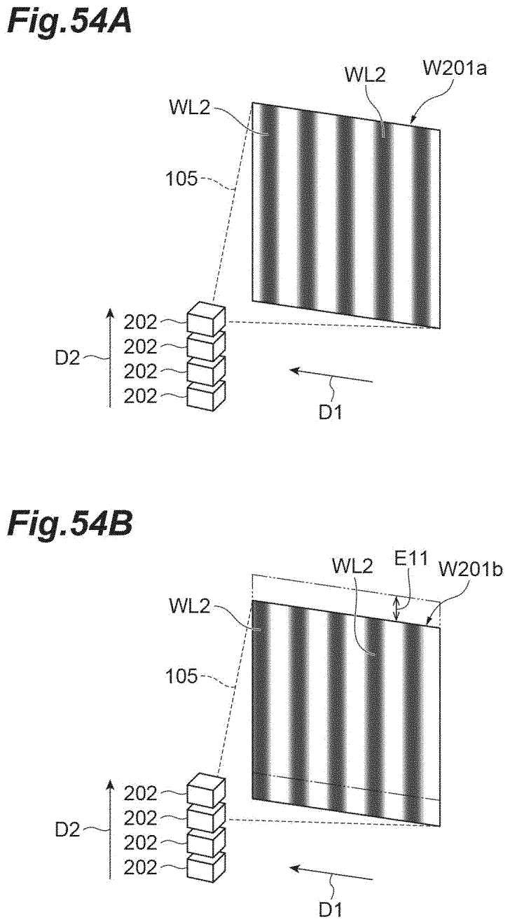

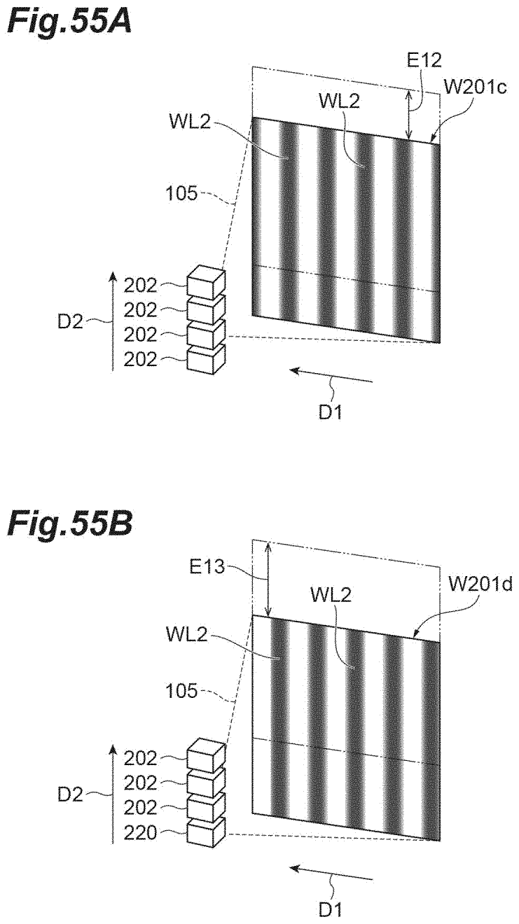

FIGS. 54A, 54B, 55A, and 55B are diagrams illustrating a modification example of the fifth embodiment, and schematically show states in which the measurement light 105 including each of stripe patterns W201a to W201d is projected onto the common projection region from each of the four S-iPMSELs 202. The stripe patterns W201a to W201d are first patterns in the present modification example. In these drawings, the light intensities of the stripe patterns W201a to W201d are indicated by color gradation, with higher light intensities being darker and lower light intensities being lighter. In each of the stripe patterns W201a to W201d, a plurality of bright lines WL2 are periodically lined up in the direction D1 intersecting the extending direction of the bright lines WL2. Each of the stripe patterns W201a to W201d is preferably a pattern in which the light intensity varies sinusoidally in the direction D1, for example, as shown in FIG. 39, but may not be sinusoidal like a top hat type. That is, in the present modification example, while the phase of the stripe pattern of each S-iPMSEL 202 is shifted for each S-iPMSEL 202, the stripe pattern is projected onto an object to be measured from each S-iPMSEL 202, and image capture is performed each time the stripe pattern is projected from each S-iPMSEL 202, to thereby perform the three-dimensional shape measurement using the phase shift method. Except for the pattern which is output from the S-iPMSEL 202, the configuration of the light source device is the same as that of the fifth embodiment.

Intervals F2 between the plurality of bright lines WL2 of the stripe patterns W201a to W201d, that is, the periods of the bright lines WL2, are equal to each other in the stripe patterns W201a to W201d (in other words, among the plurality of S-iPMSELs 202). The positions, that is, phases, of the plurality of bright lines WL2 in the direction D1 with the position of the optical axis of each S-iPMSEL 202 as a reference are different from each other among the plurality of S-iPMSELs 202. In the examples shown in FIG. 54A, FIG. 54B, FIG. 55A, and FIG. 55B, the bright lines WL2 of the stripe patterns W201a to W201d are shifted from each other by π/2 (rad), that is, ¼ period. In a case where the number of S-iPMSELs 202 is n, the shift amount of the bright lines WL2 between the plurality of S-iPMSELs 202 is 1/n of the interval (period) between the bright lines WL2. The phase modulation layer 225A of each S-iPMSEL 202 has a phase distribution for outputting the stripe patterns W201a to W201d as described above. The plurality of S-iPMSELs 202 are lined up in the direction D2 orthogonal to the direction D1 as in the fifth embodiment. That is, the direction D2 coincides with the Y-axis direction shown in FIG. 47.

As shown in FIG. 54A, the measurement light 105 is first projected from the S-iPMSEL 202 (the first S-iPMSEL) located at one end in the direction D2. Thereby, the stripe pattern W201a is projected onto the common projection region. Next, as shown in FIG. 54B, the measurement light 105 is projected from the S-iPMSEL 202 (the second S-iPMSEL) located next to the first S-iPMSEL in the direction D2. Thereby, the stripe pattern W201b is projected onto the common projection region. In this case, the positional shift E11 in the direction D2 occurs between the stripe patterns W201a and W201b which are output from these S-iPMSELs 202 in accordance with the array pitch (optical axis interval) between the first S-iPMSEL and the second S-iPMSEL. On the other hand, the position of the bright line WL2 of the stripe pattern W201b in the direction D1 is a predetermined position, that is, a position shifted by ¼ period from the bright line WL2 of the stripe pattern W201a, and no positional shift from the predetermined position occurs. Subsequently, as shown in FIG. 55A, the measurement light 105 is projected from the S-iPMSEL 202 (the third S-iPMSEL) located next to the second S-iPMSEL in the direction D2. Thereby, the stripe pattern W201c is projected onto the common projection region. In this case, the positional shift E12 in the direction D2 occurs between the stripe patterns W201a and W201c in accordance with the array pitch (optical axis interval) between the first S-iPMSEL to the third S-iPMSEL. On the other hand, the position of the bright line WL2 of the stripe pattern W201c in the direction D1 is a predetermined position, that is, a position shifted by ½ period from the bright line WL2 of the stripe pattern W201a, and no positional shift from the predetermined position occurs. Subsequently, as shown in FIG. 55B, the measurement light 105 is projected from the S-iPMSEL 202 (the fourth S-iPMSEL) located next to the third S-iPMSEL in the direction D2. Thereby, the stripe pattern W201d is projected onto the common projection region. In this case, the positional shift E13 in the direction D2 occurs between the stripe patterns W201a and W201d in accordance with the array pitch (optical axis interval) between the first S-iPMSEL to the fourth S-iPMSEL. On the other hand, the position of the bright line WL2 of the stripe pattern W201d in the direction D1 is a predetermined position, that is, a position shifted by ¾ period from the bright line WL2 of the stripe pattern W201a, and no positional shift from the predetermined position occurs.

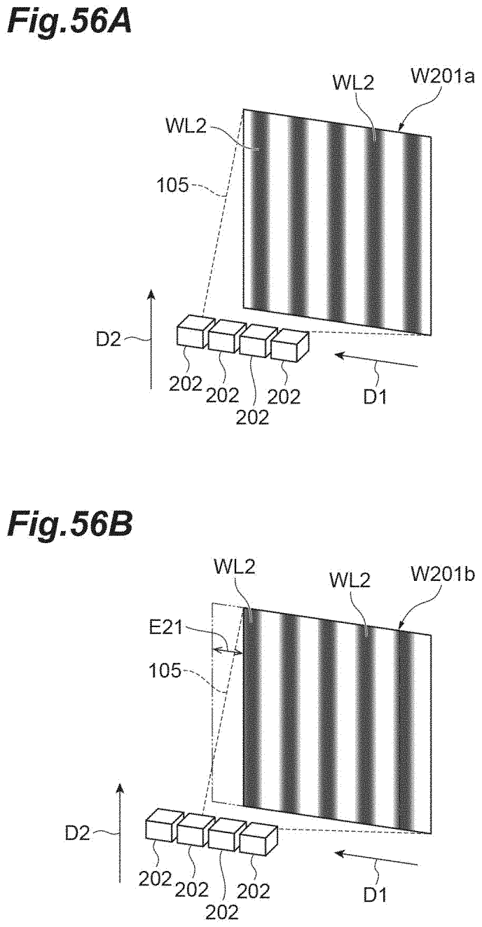

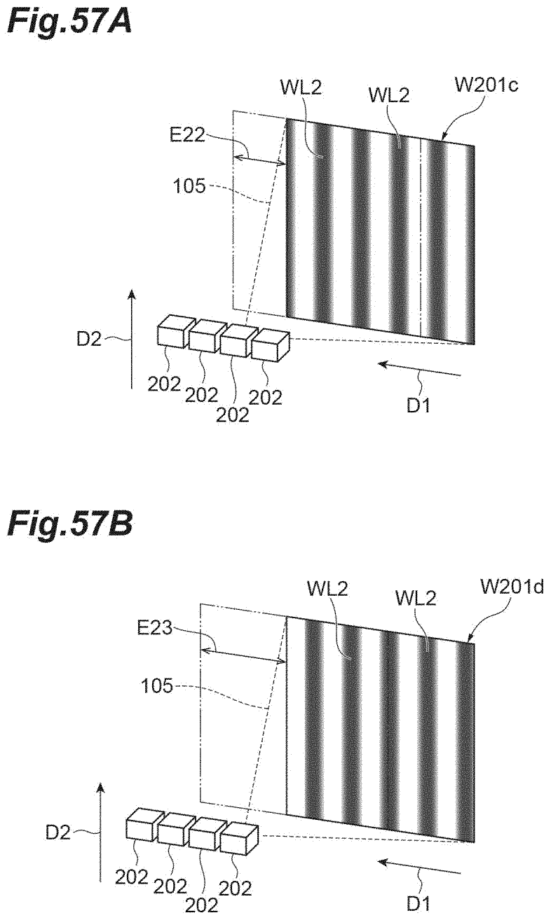

Here, as a comparative example of the present modification example, a case where the plurality of S-iPMSELs 202 are lined up in the direction D1 will be described. FIGS. 56A, 56B, 57A, and 57B are diagrams schematically illustrating states in which the measurement light 105 including each of the stripe patterns W201a to W201d is projected onto the common projection region from four S-iPMSELs 202 in such a comparative example. As shown in FIG. 56A, the measurement light 105 is first projected from the S-iPMSEL 202 (the first S-iPMSEL) located at one end in the direction D1. Thereby, the stripe pattern W201a is projected onto the common projection region. Next, as shown in FIG. 56B, the measurement light 105 is projected from the S-iPMSEL 202 (the second S-iPMSEL) located next to the first S-iPMSEL in the direction D1. Thereby, the stripe pattern W201b is projected onto the common projection region. In this case, the positional shift E21 in the direction D1 occurs between the stripe patterns W201a and W201b which are output from these S-iPMSELs 202 in accordance with the array pitch (optical axis interval) between the first S-iPMSEL and the second S-iPMSEL. The positional shift E21 causes a positional shift from a predetermined position of the bright line WL2 of the stripe pattern W201b in the direction D1, that is, a position shifted by ¼ period from the bright line WL2 of the stripe pattern W201a, to occur in the bright line WL2 of the stripe pattern W201b. Subsequently, as shown in FIG. 57A, the measurement light 105 is projected from the S-iPMSEL 202 (the third S-iPMSEL) located next to the second S-iPMSEL in the direction D1. Thereby, the stripe pattern W201c is projected onto the common projection region. In this case, the positional shift E22 in the direction D1 occurs between the stripe patterns W201a and W1c in accordance with the array pitch (optical axis interval) between the first S-iPMSEL to the third S-iPMSEL. The positional shift E22 causes a positional shift from a predetermined position of the bright line WL2 of the stripe pattern W201c in the direction D1, that is, a position shifted by ½ period from the bright line WL2 of the stripe pattern W201a, to occur in the bright line WL2 of the stripe pattern W201c. Subsequently, as shown in FIG. 57B, the measurement light 105 is projected from the S-iPMSEL 202 (the fourth S-iPMSEL) located next to the third S-iPMSEL in the direction D1. Thereby, the stripe pattern W201d is projected onto the common projection region. In this case, the positional shift E23 in the direction D1 occurs between the stripe patterns W201a and W201d in accordance with the array pitch (optical axis interval) between the first S-iPMSEL to the fourth S-iPMSEL. The positional shift E23 causes a positional shift from a predetermined position of the bright line WL2 of the stripe pattern W201d in the direction D1, that is, a position shifted by ¾ period from the bright line WL2 of the stripe pattern W201a, to occur in the bright line WL2 of the stripe pattern W201d. In the comparative example, due to the positional shift of the bright line WL2, the accuracy of phase shift of the stripe patterns W201b to W201d is lowered, and the measurement error increases.

In contrast to the above problem, in a case where the plurality of S-iPMSELs 202 are lined up in the direction D2 orthogonal to the direction D1 as in the present modification example (see FIGS. 54A, 54B, 55A, and 55B), the array direction of the plurality of S-iPMSELs 202 is orthogonal to the line-up direction of the bright lines WL2 of the stripe patterns W201a to W201d. Thus, even when the positional shifts E11 to E13 occur between the plurality of stripe patterns W201a to W201d, the positional shifts E11 to E13 do not influence the accuracy of phase shift of the stripe patterns W201b to W201d. Therefore, it is possible to reduce the measurement error in the three-dimensional shape measurement more than in the above comparative example.

Additionally, in the present modification example, the intervals (periods) between the bright lines WL2 of the stripe patterns W201a to W201d are equal to each other among the plurality of S-iPMSELs 202, and the positions (phases) between the bright lines WL2 in the direction D1 with the optical axis of each S-iPMSEL 202 as a reference are different from each other among the plurality of S-iPMSELs 202. It is possible to perform the three-dimensional shape measurement using the phase shift method by projecting each of such stripe patterns W201a to W201d onto the common projection region from each of the plurality of S-iPMSELs 202.

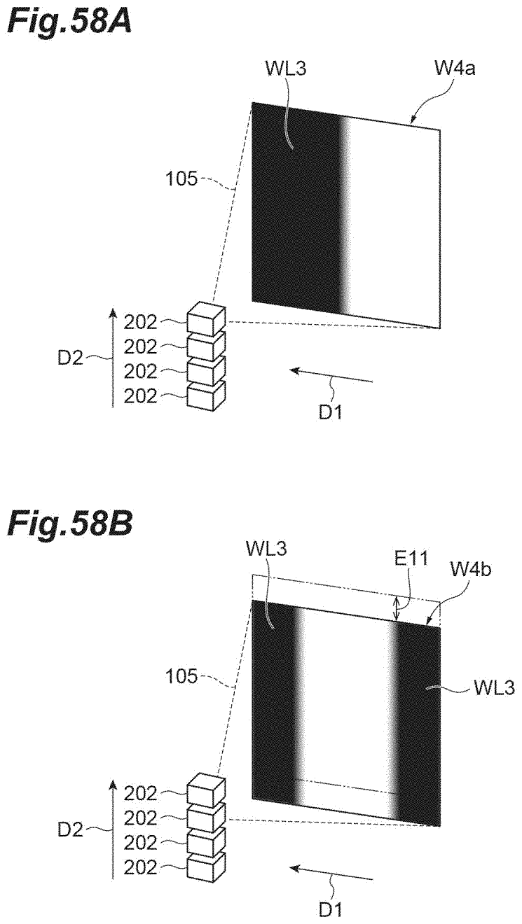

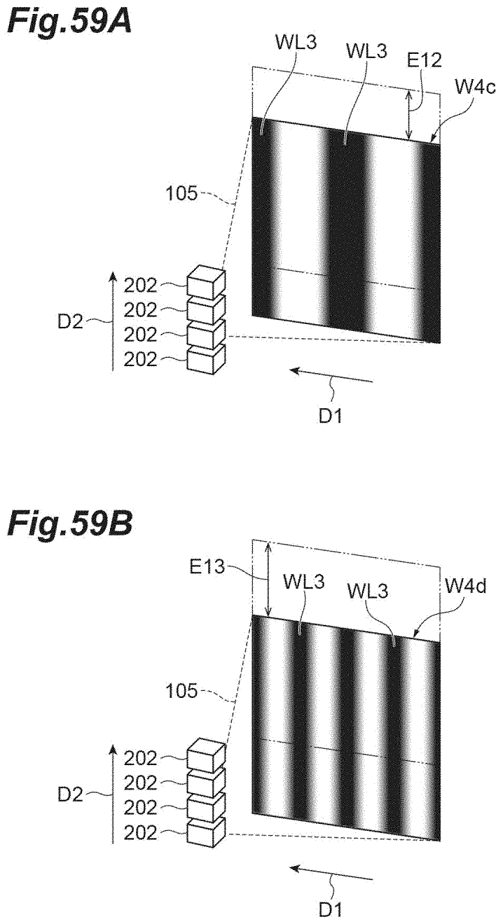

FIGS. 58A, 58B, 59A, and 59B are diagrams illustrating another modification example of the fifth embodiment, and schematically show states in which the measurement light 105 including each of the gray code patterns W4a to W4d is projected onto the common projection region from each of four S-iPMSELs 202. The gray code patterns W4a to W4d are stripe patterns and first patterns in the present modification example. In these drawings, the light intensities of the gray code patterns W4a to W4d are indicated by color gradation, with lower light intensities being lighter (white) and higher light intensity being darker (black). In each of the gray code patterns W4a to W4d, a plurality of bright lines WL3 are lined up in the direction D1 intersecting the extending direction of the bright lines WL3. The width and position of the bright lines WL3 represent the gray code. In the present modification example, while the gray code is changed for each S-iPMSEL 202, the gray code pattern is projected onto an object to be measured from each S-iPMSEL 202, and image capture is performed each time the gray code pattern is projected from each S-iPMSEL 202, to thereby perform the three-dimensional shape measurement. Except for the pattern which is output from the S-iPMSEL 202, the configuration of the light source device is the same as that of the fifth embodiment.

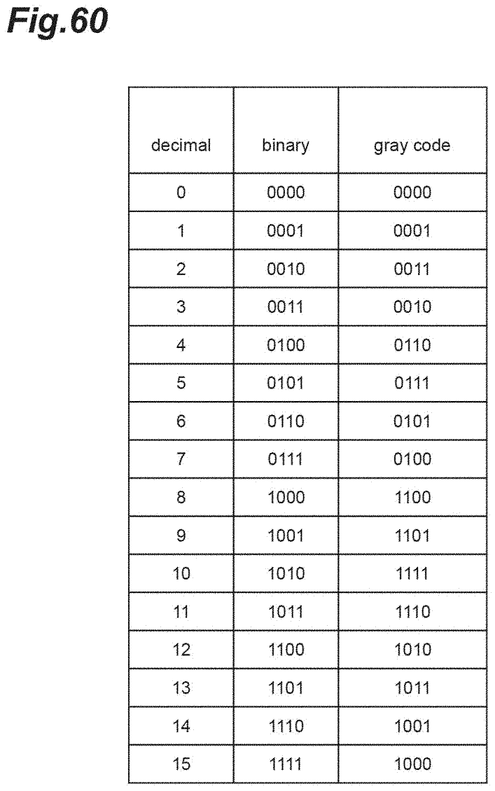

The gray code is one method of representing binary numbers. FIG. 60 is a diagram illustrating mutual conversion between a decimal number, a binary code which is another representation method of a binary number, and a gray code. The gray code has the property that only one bit changes whenever the number is incremented or decremented by one. Since only one bit changes, malfunction is not likely to occur, and the gray code is often used in a digital circuit or the like. An example of a combination of stripe patterns including a 4-bit gray code is shown in FIG. 22 described above. The drawing shows the brightness and darkness of each of a plurality of bits lined up in the direction D1. FIG. 22 shows the gray code patterns W4a to W4d including four different gray codes as an example. Conversion from the binary code to the gray code follows the rules below. First, the most significant bit of the gray code, 1, is assumed to be the same as the binary code. Thereafter, two adjacent bits are referred to in order from the high-order bit, and if 1 or 0 is consecutive, the corresponding bit of the gray code is set to 0, and if not consecutive, the corresponding bit of the gray code is set to 1. Alternatively, conversion from the binary code to the gray code may follow the rules below. First, a target binary code is prepared. The binary code is then shifted one bit to the right to obtain a binary code with 0 added to the head. The exclusive logical sum of the binary code and the original binary code is then obtained. The arithmetic result is a gray code.

The gray code patterns W4a to W4d are constituted by stripe-like patterns set to have gray code values different from each other. The three-dimensional shape of the object to be measured SA can be measured by performing image capture with the image capture unit 103 while sequentially switching among such four gray code patterns W4a to W4d.

In order to avoid misrecognition due to the color of the surface of the object to be measured SA, a stripe pattern including another gray code obtained by inverting each bit value of the gray code of the gray code patterns W4a to W4d shown in FIG. 22 may be used together. In that case, four more S-iPMSELs 202 for outputting a stripe pattern including another gray code may be provided.

The plurality of S-iPMSELs 202 are lined up in the direction D2 orthogonal to the direction D1 as in the fifth embodiment. That is, the direction D2 coincides with the Y-axis direction shown in FIG. 47.

The operation of sequentially switching four gray code patterns will be described using the gray code patterns W4a to W4d in FIG. 22 as an example. As shown in FIG. 58A, the measurement light 105 is first projected from the S-iPMSEL 202 (the first S-iPMSEL) located at one end in the direction D2. Thereby, gray code pattern W4a is projected onto the common projection region. Next, as shown in FIG. 58B, the measurement light 105 is projected from the S-iPMSEL 202 (the second S-iPMSEL) located next to the first S-iPMSEL in the direction D2. Thereby, the gray code pattern W4b is projected onto the common projection region. In this case, the positional shift E11 in the direction D2 occurs between the gray code patterns W4a and W4b which are output from these S-iPMSELs 202 in accordance with the array pitch (optical axis interval) between the first S-iPMSEL and the second S-iPMSEL. On the other hand, the position of the bright line WL3 of the gray code pattern W4b in the direction D1 does not shift from the predetermined position. Subsequently, as shown in FIG. 59A, the measurement light 105 is projected from the S-iPMSEL 202 (the third S-iPMSEL) located next to the second S-iPMSEL in the direction D2. Thereby, the gray code pattern W4c is projected onto the common projection region. In this case, the positional shift E12 in the direction D2 occurs between the gray code patterns W4a and W4c in accordance with the array pitch (optical axis interval) between the first S-iPMSEL to the third S-iPMSEL. On the other hand, the position of the bright line WL3 of the gray code pattern W4c in the direction D1 does not shift from the predetermined position. Subsequently, as shown in FIG. 59B, the measurement light 105 is projected from the S-iPMSEL 202 (the fourth S-iPMSEL) located next to the third S-iPMSEL in the direction D2. Thereby, the gray code pattern W4d is projected onto the common projection region. In this case, the positional shift E13 in the direction D2 occurs between the gray code patterns W4a and W4d in accordance with the array pitch (optical axis interval) between the first S-iPMSEL to the fourth S-iPMSEL. On the other hand, the position of the bright line WL3 of the gray code pattern W4d in the direction D1 does not shift from the predetermined position.

In a case where the plurality of S-iPMSELs 202 are lined up in the direction D2 orthogonal to the direction D1 as in the present modification example (see FIGS. 58A, 58B, 59A, and 59B), the array direction of the plurality of S-iPMSELs 202 is orthogonal to the line-up direction of the bright lines WL3 of the gray code patterns W4a to W4d. Thus, even when the positional shifts E11 to E13 occur between the plurality of gray code patterns W4a to W4d, the positional shifts E11 to E13 do not influence the calculation of the three-dimensional shape. Therefore, it is possible to reduce the measurement error in the three-dimensional shape measurement.

### Sixth Embodiment

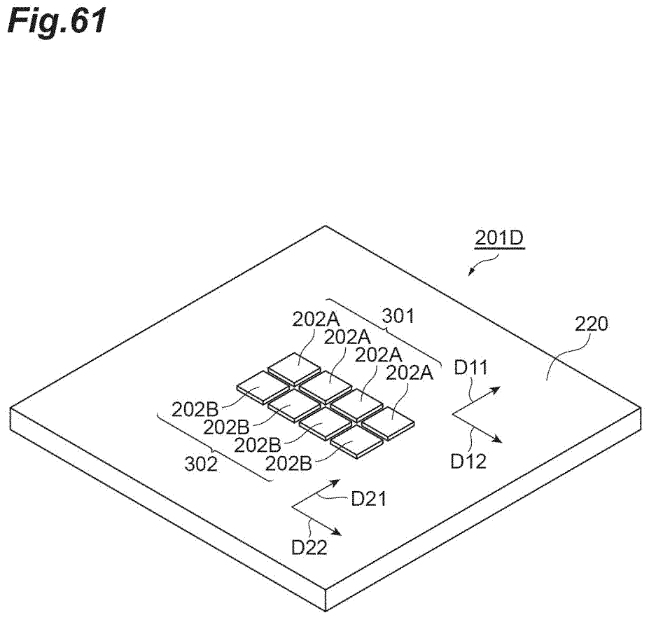

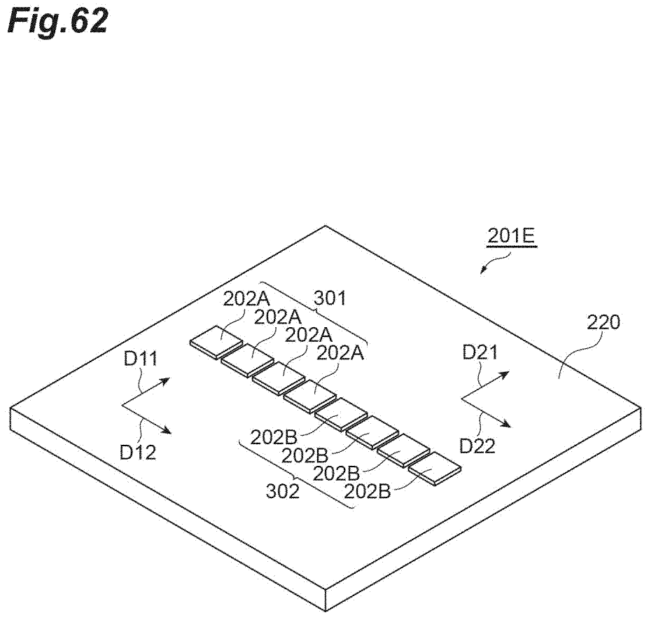

FIG. 61 is a perspective view illustrating a configuration of a light source device 201D according to a sixth embodiment of the present disclosure. FIG. 62 is a perspective view illustrating a configuration of a light source device 201E according to a modification example of the sixth embodiment. The light source device 201D shown in FIG. 61 and the light source device 201E shown in FIG. 62 include light source groups 301 and 302. The light source group 301 includes a plurality of (four in the shown example)S-iPMSELs 202A (first light source units) which are arranged side by side in a direction intersecting each optical axis direction so that the optical axis directions are aligned. The light source group 302 includes a plurality of(four in the shown example)S-iPMSELs 202B (second light source units) which are arranged side by side in a direction intersecting each optical axis direction so that the optical axis directions are aligned. The plurality of S-iPMSELs 202A and the plurality of S-iPMSELs 202B are monolithically formed on the common semiconductor substrate 220. The internal structures of the S-iPMSELs 202A and 202B are the same as that of the S-iPMSEL 202 of the first embodiment described above.

Each of the plurality of S-iPMSELs 202A projects light including each of the above-described stripe elements Wa to Wd (see FIGS. 48A, 48B, 49A, and 49B) or each of the stripe patterns W201a to W201d (see FIGS. 54A, 54B, 55A, and 55B) onto the common projection region. The stripe elements Wa to Wd or the stripe patterns W201a to W201d which are projected from the plurality of S-iPMSELs 202A are the first patterns in the present embodiment. Each of the plurality of S-iPMSELs 202B projects light including each of the stripe elements Wa to Wd or each of the stripe patterns W201a to W201d onto the common projection region. The stripe elements Wa to Wd or the stripe patterns W201a to W201d which are projected from the plurality of S-iPMSELs 202B are the second patterns in the present embodiment. Similarly to the plurality of S-iPMSELs 202 in the fifth embodiment or its modification example, the plurality of S-iPMSELs 202A are lined up in the direction D12 (equivalent to the above direction D2) orthogonal to the direction D11 (equivalent to the above direction D1) which is the line-up direction of the bright lines of the stripe elements Wa to Wd or the stripe patterns W201a to W201d. The plurality of S-iPMSELs 202B are lined up in the direction D22 (fourth direction equivalent to the above direction D2) orthogonal to the direction D21 (third direction equivalent to the above direction D1) which is the line-up direction of the bright lines of the stripe elements Wa to Wd or the stripe patterns W201a to W201d. In the shown example, the directions D21 and D22 coincide with the directions D11 and D12, respectively, but the directions D21 and D22 may be different from the directions D11 and D12, respectively.

The period of the stripe pattern W201 (see FIG. 39) formed by the stripe elements Wa to Wd or the period of the stripe patterns W201a to W201d output from the light source group 302 is different from the period of the stripe pattern W201 formed by the stripe elements Wa to Wd or the period of the stripe patterns W201a to W201d output from the light source group 301. In the light source device 201D shown in FIG. 61, the light source group 301 and the light source group 302 are arranged side by side in a direction intersecting the directions D12 and D22 which are line-up directions. In the light source device 201E shown in FIG. 62, the light source group 301 and the light source group 302 are arranged side by side in the directions D12 and D22 which are line-up directions.

The intervals (periods) between the bright lines of the stripe elements Wa to Wd or the stripe patterns W201a to W201d are equal to each other among the plurality of S-iPMSELs 202A. The positions (phases) of the bright lines in the direction D11 with the optical axis of each S-iPMSEL 202A as a reference are different from each other among the plurality of S-iPMSELs 202A. Similarly, intervals (periods) between the bright lines of the stripe elements Wa to Wd or the stripe patterns W201a to W201d are equal to each other among the plurality of S-iPMSELs 202B. The positions (phases) between the bright lines in the direction D21 with the optical axis of each S-iPMSEL 202B as a reference are different from each other among the plurality of S-iPMSELs 202B. It is possible to perform the three-dimensional shape measurement using the phase shift method by projecting such stripe elements Wa to Wd or stripe patterns W201a to W201d onto the common projection region from the plurality of S-iPMSELs 202A or 202B.

In the light source devices 201D and 201E of the present embodiment, the three-dimensional shape measurement using the phase shift method can be performed at least twice with two light source groups, that is, the light source group 301 including the plurality of S-iPMSELs 202A and the light source group 302 including the plurality of S-iPMSELs 202B, thereby increasing the accuracy of measurement.

Additionally, in the light source devices 201D and 201E of the present embodiment, the plurality of S-iPMSELs 202A are lined up in the direction D12 orthogonal to the direction D11 which is the line-up direction of the bright lines, and the plurality of S-iPMSELs 202B are lined up in the direction D22 orthogonal to the direction D21 which is the line-up direction of the bright lines. In this case, even when the positions of the S-iPMSELs 202A (or 202B) are shifted from each other by the amount of the array pitch, the direction of the shift is orthogonal to the line-up direction of the bright lines. Therefore, even when the positional shift of the stripe elements Wa to Wd or the stripe patterns W201a to W201d occurs in the plurality of S-iPMSELs 202A (or 202B), the positional shift does not influence the accuracy of phase shift or the like. Thus, according to the light source devices 201D and 201E of the present embodiment, it is possible to reduce the measurement error in the three-dimensional shape measurement using the phase shift method.

As described above, the intervals (periods) between the bright lines of the stripe pattern W201 formed by the stripe elements Wa to Wd or the stripe patterns W201a to W201d output from the light source group 302 may be different from the intervals (periods) between the bright lines of the stripe pattern W201 formed by the stripe elements Wa to Wd or the stripe patterns W201a to W201d output from the light source group 301. In that case, since the three-dimensional shape measurement using the phase shift method can be performed using two types of stripe patterns with intervals between bright lines different from each other, it is possible to further improve the accuracy of measurement.

### Modification Example

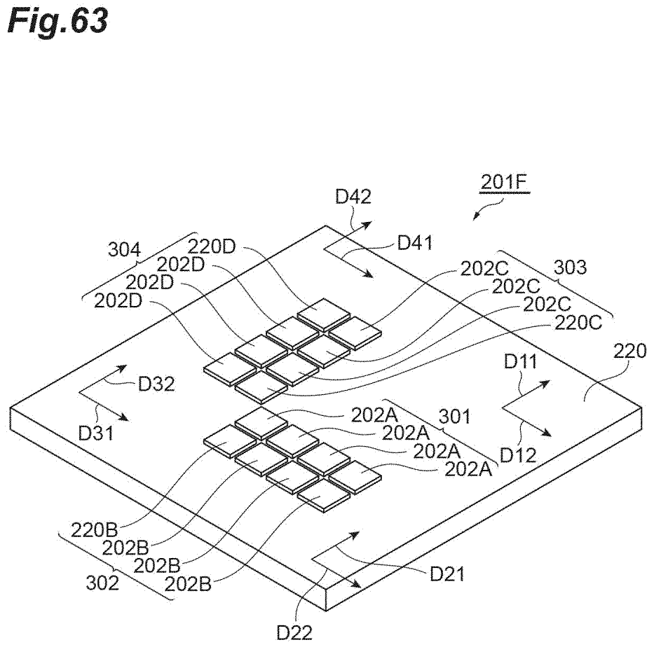

FIG. 63 is a perspective view illustrating a configuration of a light source device 201F according to a modification example of the sixth embodiment. The light source device 201F shown in FIG. 63 further includes light source groups 303 and 304 in addition to the light source groups 301 and 302 of the sixth embodiment. The light source group 303 includes a plurality of(four in the shown example)S-iPMSELs 202C (second light source units) arranged side by side in a direction intersecting each optical axis direction so that the optical axis directions are aligned. The light source group 304 includes a plurality of (four in the shown example)S-iPMSELs 202D (second light source units) arranged side by side in a direction intersecting each optical axis direction so that the optical axis directions are aligned. The plurality of S-iPMSELs 202C and the plurality of S-iPMSELs 202D are monolithically formed on the common semiconductor substrate 220 together with the plurality of S-iPMSELs 202A and the plurality of S-iPMSELs 202B. The internal structures of the S-iPMSELs 202C and 202D are the same as that of the S-iPMSEL 202 of the first embodiment described above.

Each of the plurality of S-iPMSELs 202C projects light including each of the above-described stripe elements Wa to Wd (see FIGS. 48A, 48B, 49A, and 49B) or each of the stripe patterns W201a to W201d (see FIGS. 54A, 54B, 55A, and 55B) onto the common projection region. The stripe elements Wa to Wd or the stripe patterns W201a to W201d which are projected from the plurality of S-iPMSELs 202C are the second patterns in the present modification example. Each of the plurality of S-iPMSELs 202D projects light including each of the stripe elements Wa to Wd or each of the stripe patterns W201a to W201d onto the common projection region. The stripe elements Wa to Wd or the stripe patterns W201a to W201d which are projected from the plurality of S-iPMSELs 202D are also the second patterns in the present modification example. The plurality of S-iPMSELs 202C are lined up in direction D32 (fourth direction equivalent to the above direction D2) orthogonal to a direction D31 (third direction equivalent to the above direction D1) which is the line-up direction of the bright lines of the stripe elements Wa to Wd or the stripe patterns W201a to W201d. The plurality of S-iPMSELs 202D are lined up in a direction D42 (fourth direction equivalent to the above direction D2) orthogonal to a direction D41 (third direction equivalent to the above direction D1) which is the line-up direction of the bright lines of the stripe elements Wa to Wd or the stripe patterns W201a to W201d. In the shown example, the directions D41 and D42 coincide with the directions D31 and D32, but the directions D41 and D42 may be different from the directions D31 and D32. The direction D31 intersects the direction D11, and the direction D32 intersects the direction D12. In the shown example, the direction D31 is orthogonal to the direction D11, and the direction D32 is orthogonal to the direction D12. The direction D31 may be inclined with respect to the direction D11, and the direction D32 may be inclined with respect to the direction D12.

The period of the stripe pattern W201 (see FIG. 39) formed by the stripe elements Wa to Wd or the period of the stripe patterns W20I a to W201d output from the light source group 303 is different from the period of the stripe pattern W201 formed by the stripe elements Wa to Wd or the period of the stripe patterns W201a to W201d output from the light source group 304. In the light source device 201F shown in FIG. 63, the light source group 303 and the light source group 304 are arranged side by side in a direction intersecting the directions D32 and D42 which are line-up directions, but the light source group 303 and the light source group 304 may be arranged side by side in the directions D32 and D42 which are line-up directions.

The intervals (periods) between the bright lines of the stripe elements Wa to Wd or the stripe patterns W201a to W201d are equal to each other among the plurality of S-iPMSELs 202C. The positions (phases) of the bright lines in the direction D31 with the optical axis of each S-iPMSEL 202C as a reference are different from each other among the plurality of S-iPMSELs 202C. The intervals (periods) between the bright lines of the stripe elements Wa to Wd or the stripe patterns W201a to W201d are equal to each other among the plurality of S-iPMSELs 202D. The positions (phases) of the bright lines in the direction D41 with the optical axis of each S-iPMSEL 202D as a reference are different from each other among the plurality of S-iPMSELs 202D. It is possible to suitably perform the three-dimensional shape measurement using the phase shift method by projecting such stripe elements Wa to Wd or stripe patterns W201a to W201d onto the common projection region from the plurality of S-iPMSELs 202C or 202D.

In the light source device 201F of the present modification example, the three-dimensional shape measurement using the phase shift method can be performed at least four times with four light source groups, that is, the light source group 301 including the plurality of S-iPMSELs 202A, the light source group 302 including the plurality of S-iPMSELs 202B, the light source group 303 including the plurality of S-iPMSELs 202C, and the light source group 304 including the plurality of S-iPMSELs 202D, thereby increasing the accuracy of measurement. Additionally, in the light source device 201F of the present modification example, the plurality of S-iPMSELs 202C are lined up in the direction D32 orthogonal to the direction D31 which is the line-up direction of the bright lines, and the plurality of S-iPMSELs 202D are lined up in the direction D42 orthogonal to the direction D41 which is the line-up direction of the bright line. In this case, even when the positions of the S-iPMSELs 202C (or 202D) are shifted from each other by the amount of the array pitch, the direction of the shift is orthogonal to the line-up direction of the bright lines. Therefore, even when the positional shift of the stripe elements Wa to Wd or the stripe patterns W201a to W201d occurs in the plurality of S-iPMSELs 202C (or 202D), the positional shift does not influence the accuracy of phase shift or the like. Thus, according to the light source device 201F of the present modification example, it is possible to reduce the measurement error in the three-dimensional shape measurement using the phase shift method.

As in the present modification example, the intervals (periods) between the bright lines of the stripe pattern W201 formed by the stripe elements Wa to Wd or the stripe patterns W201a to W201d output from the light source group 304 may be different from the intervals (periods) between the bright lines of the stripe pattern W201 formed by the stripe elements Wa to Wd or the stripe patterns W201a to W201d output from the light source group 303. In that case, since the three-dimensional shape measurement using the phase shift method can be performed using two types of stripe patterns with intervals between bright lines different from each other, it is possible to further improve the accuracy of measurement.

As in the present modification example, the direction D31 which is the line-up direction of the bright lines output from the plurality of S-iPMSELs 202C and the direction D41 which is line-up direction of the bright lines output from the plurality of S-iPMSELs 202D may intersect the direction D11 which is the line-up direction of the bright lines output from the plurality of S-iPMSELs 202A and the direction D21 which is the line-up direction of the bright lines output from the plurality of S-iPMSELs 202B. In that case, since the three-dimensional shape measurement using the phase shift method can be performed using two or more types of stripe patterns in which the line-up directions of the bright lines are different from each other, it is possible to further improve the accuracy of measurement.

### Seventh Embodiment

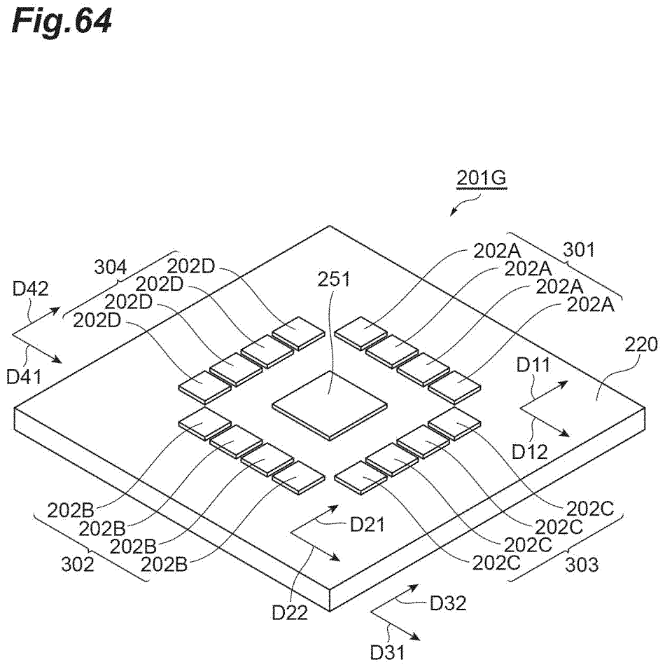

FIG. 64 is a perspective view illustrating a configuration of a light receiving and emitting module 201G according to a seventh embodiment of the present disclosure. The light receiving and emitting module 201G shown in FIG. 64 further includes an image capture element 251 in addition to the configuration of the light source device 201F shown in FIG. 63. In addition, the light receiving and emitting module 201G of the present modification example is different from the light source device 201F in that the light source groups 301 to 304 are arranged so as to surround the image capture element 251. Specifically, the light source groups 301 and 302 are arranged side by side in the directions D11 and D21, and the image capture element 251 is disposed therebetween. The light source group 303 and 304 are arranged side by side in the directions D31 and D41, and the image capture element 251 is disposed therebetween. The configuration of each of the light source groups 301 to 304 is the same as in the sixth embodiment and its modification example.

The image capture element 251 is provided on a substrate common to the S-iPMSELs 202A to 202D. In an example, the image capture element 251 is monolithically formed on the semiconductor substrate 220 together with the S-iPMSELs 202A to 202D. The image capture element 251 is provided instead of the image capture unit 103 shown in FIG. 21. The image capture element 251 is sensitive to the measurement light 105 which is emitted from the S-iPMSELs 202A to 202D. The image capture element 251 captures an image of the stripe elements Wa to Wd or the stripe patterns W201a to W201d in an object to be measured (projection region) irradiated with the measurement light 105, generates image data indicating results of image capture, and outputs the image data to the measurement unit 104 (see FIG. 21).

According to the light receiving and emitting module 201G of the present embodiment, the same operational effects as those of the light source device 201D can be achieved by including the configuration of the light source device 201D. Additionally, according to the light receiving and emitting module 201G of the present embodiment, the same operational effects as those of the light source device 201F can be achieved by including the configuration of the light source device 201F.

### Modification Example

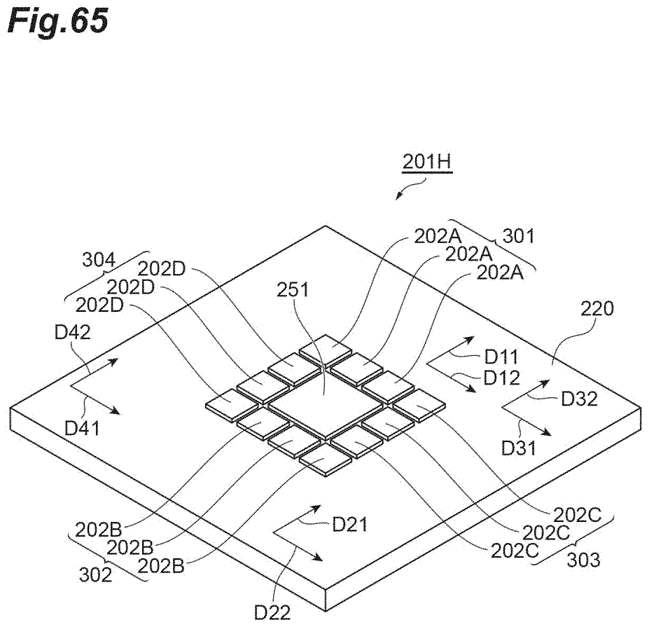

FIG. 65 is a perspective view illustrating a configuration of a light receiving and emitting module 201H according to a modification example of the seventh embodiment. Differences from the seventh embodiment in the present modification example are that the number of S-iPMSELs included in the light source groups 301 to 304 is three, and that one of the plurality of S-iPMSELs included in each of the light source groups 301 to 304 is included in an array of another adjacent light source group.

Specifically, one S-iPMSEL 202A located at the first end in the line-up direction among three S-iPMSELs 202A constituting the light source group 301 is located at the second end side of three S-iPMSELs 202D constituting the light source group 304, and is lined up with these S-iPMSELs 202D in a row. Similarly, one S-iPMSEL 202D located at the first end in the line-up direction among three S-iPMSELs 202D constituting the light source group 304 is located at the second end side of three S-iPMSELs 202B constituting the light source group 302, and is lined up with these S-iPMSELs 202B in a row. One S-iPMSEL 202B located at the first end in the line-up direction among three S-iPMSELs 202B constituting the light source group 302 is located at the second end side of three S-iPMSELs 202C constituting the light source group 303, and is lined up with these S-iPMSELs 202C in a row. One S-iPMSEL 202C located at the first end in the line-up direction among three S-iPMSELs 202C constituting the light source group 303 is located at the second end side of three S-iPMSELs 202A constituting the light source group 301, and is lined up with these S-iPMSELs 202A in a row.

According to the configuration of the present modification example, it is possible to contribute to a reduction in the size of the light receiving and emitting module by densely arranging the light source groups 301 to 304.

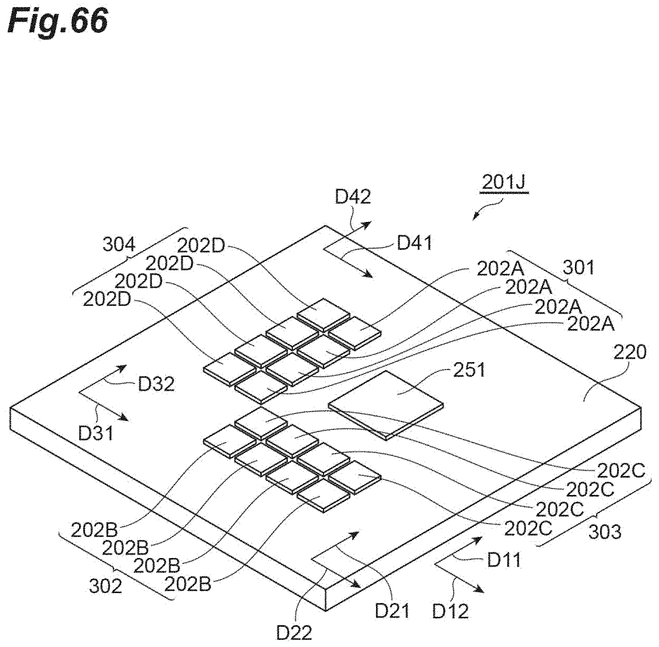

FIG. 66 is a perspective view illustrating a configuration of a light receiving and emitting module 201J according to another modification example of the seventh embodiment. A difference from the seventh embodiment in the present modification example is the arrangement of the light source groups 301 to 304. That is, in the present modification example, the light source groups 301 to 304 do not surround the image capture element 251 and are arranged in the same way as the light source device 201F shown in FIG. 63. The image capture element 251 is disposed away from the light source groups 301 to 304. With such a configuration, it is also possible to achieve the same effects as those of the seventh embodiment.

What is claimed is:

1. A three-dimensional measurement device comprising:
a plurality of light source units, each of the plurality of light source units being configured to irradiate an object to be measured with measurement light having each of a plurality of predetermined patterns;
an image capture unit configured to capture an image of the object to be measured which is irradiated with the measurement light; and
a measurement unit configured to measure a three-dimensional shape of the object to be measured based on results of image capture performed by the image capture unit,
wherein the predetermined patterns of the measurement light include respective stripe patterns, and the stripe patterns radiated from the plurality of light source units have respective patterns different from each other,
the plurality of light source units are arrayed in a direction parallel to stripes in the stripe patterns, and
the measurement unit measures the three-dimensional shape of the object to be measured based on a three-dimensional shape measurement method using the stripe patterns.

2. The three-dimensional measurement device according to claim 1, wherein each of the plurality of light source units comprises an S-iPMSEL oscillating at an M-point.

3. The three-dimensional measurement device according to claim 1, wherein the predetermined patterns of the measurement light are superimposed patterns, and each of the stripe patterns which are periodic and a random dot pattern are superimposed in each of the superimposed patterns, and
the measurement unit measures the three-dimensional shape of the object to be measured based on a phase shift method using the superimposed patterns.

4. The three-dimensional measurement device according to claim 1, wherein the stripe patterns which are radiated from the plurality of light source units are gray code patterns, and the gray code patterns include respective gray codes different from each other, and
the measurement unit measures the three-dimensional shape of the object to be measured based on a triangulation method using the gray code patterns.

5. The three-dimensional measurement device according to claim 1, wherein the stripe patterns which are radiated from the plurality of light source units are periodic stripe patterns, and the periodic stripe patterns have respective phase shifts different from each other, and
the measurement unit measures the three-dimensional shape of the object to be measured based on a phase shift method using the stripe patterns.

6. The three-dimensional measurement device according to claim 5, wherein the stripe patterns are sinusoidal stripe patterns.

7. The three-dimensional measurement device according to claim 5, wherein number of phase shift of the stripe patterns is N, and phases of the stripe patterns which are radiated from the plurality of light source units are sequentially shifted by 2π/N.

8. A light source device used in a three-dimensional measurement device configured to measure a three-dimensional shape of an object to be measured based on a three-dimensional shape measurement method using stripe patterns, the light source device comprising:
a plurality of light source units, each of the plurality of light source units being configured to irradiate an object to be measured with measurement light having each of a plurality of predetermined patterns,
wherein the predetermined patterns of the measurement light include the stripe patterns, respectively, and the stripe patterns radiated from the plurality of light source units have respective patterns different from each other, and
the plurality of light source units are arrayed in a direction parallel to stripes in the stripe patterns.

9. Alight source device used in a three-dimensional shape measurement method, the light source device comprising:
a plurality of first light source units having optical axis directions coinciding with each other, the plurality of first light source units being arranged side by side in a direction intersecting the optical axis directions,
wherein each of the plurality of first light source units projects light onto a common projection region, the light including a first pattern having a plurality of bright lines that are lined up in a first direction intersecting an extending direction of the plurality of bright lines in the first pattern, and
the plurality of first light source units are lined up in a second direction orthogonal to the first direction.

10. The light source device according to claim 9, wherein intervals between the plurality of bright lines are equal among the plurality of first light source units, and
positions of the plurality of bright lines of the first pattern in the first direction with reference to the optical axis of each of the plurality of first light source units are different among the plurality of first light source units.

11. The light source device according to claim 9, wherein the plurality of first light source units comprise S-iPMSELs oscillating at an M-point, respectively.

12. The light source device according to claim 11, wherein the S-iPMSELs are monolithically formed with each other.

13. The light source device according to claim 10, wherein number of the first light source units is n, and a shift amount of the plurality of bright lines between the plurality of first light source units is 1/n of an interval between the plurality of bright lines.

14. The light source device according to claim 9, further comprising a plurality of second light source units having optical axis directions coinciding with each other, the plurality of second light source units being arranged side by side in a direction intersecting the optical axis directions,
wherein each of the plurality of second light source units projects light onto a common projection region, the light including a second pattern having a plurality of bright lines that are lined up in a third direction intersecting an extending direction of the plurality of bright lines in the second pattern, and
the plurality of second light source units are lined up in a fourth direction orthogonal to the third direction.

15. The light source device according to claim 14, wherein the plurality of second light source units comprise S-iPMSELs oscillating at an M-point, respectively.

16. The light source device according to claim 14, wherein intervals between the plurality of bright lines are equal among the plurality of second light source units, and
positions of the plurality of bright lines of the second pattern in the third direction with reference to the optical axis of each of the plurality of second light source units are different among the plurality of second light source units.

17. The light source device according to claim 14, wherein an interval between the plurality of bright lines of the second pattern is different from an interval between the plurality of bright lines of the first pattern.

18. The light source device according to claim 14, wherein the third direction intersects the first direction.

19. A light receiving and emitting module used for three-dimensional shape measurement, the light receiving and emitting module comprising:
the light source device according to claim 9; and
an image capture element configured to capture an image of the first pattern projected onto the common projection region to generate image data,
wherein the light source device and the image capture element are provided on a common substrate.
